(19) United States
(12) Patent Application Publication
(10) Pub. No.: US 2026/0190177 A1
(43) Pub. Date: Jul. 2, 2026

(54) Method and Apparatus for Receiving Configurations for Artificial Intelligence and Machine Learning Functionalities in a Wireless Communication System

(71) Applicant: ASUS Technology Licensing Inc., Taipei City (TW)

(72) Inventors: Cheng-Hsiu Chen, Taipei City (TW); Meng-Hui Ou, Taipei City (TW); Li-Chih Tseng, Taipei City (TW); Chun-Wei Huang, Taipei City (TW)

(21) Appl. No.: 19/436,089

(22) Filed: Dec. 30, 2025

Related U.S. Application Data
(60) Provisional application No. 63/739,946, filed on Dec. 30, 2024.

(51) Int. Cl. H04W 76/27; H04L 5/00

(52) U.S. Cl. CPC H04W 76/27; H04L 5/0057

(57) ABSTRACT

A method and apparatus are disclosed. In an example from the perspective of a User Equipment (UE), the UE receives, from a network (NW), a first prediction configuration in a first Radio Resource Control (RRC) reconfiguration message. The UE does not apply the first prediction configuration in response to determining the first prediction configuration is not applicable. The UE reports, to the NW and in response to the first RRC reconfiguration message, a second RRC reconfiguration complete message including an indication that the first prediction configuration is not applicable. The UE reports, to the NW and in response to the first prediction configuration becoming applicable, a third message including an indication that the first prediction configuration is applicable.

### CROSS-REFERENCE TO RELATED APPLICATIONS

The present application claims the benefit of U.S. Provisional Patent Application Ser. No. 63/739,946 filed on Dec. 30, 2024, the entire disclosure of which is incorporated herein in its entirety by reference.

### FIELD

This disclosure generally relates to wireless communication networks, and more particularly, to a method and apparatus for receiving configurations for artificial intelligence and machine learning functionalities in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

In accordance with the present disclosure, one or more devices and/or methods are provided. In an example from the perspective of a User Equipment (UE), the UE receives, from a network (NW), a first prediction configuration in a first Radio Resource Control (RRC) reconfiguration message. The UE does not apply the first prediction configuration in response to determining the first prediction configuration is not applicable. The UE reports, to the NW and in response to the first RRC reconfiguration message, a second RRC reconfiguration complete message including an indication that the first prediction configuration is not applicable. The UE reports, to the NW and in response to the first prediction configuration becoming applicable, a third message including an indication that the first prediction configuration is applicable.

### BRIEF DESCRIPTION OF THE DRAWINGS

FIG. 1 shows a diagram of a wireless communication system according to one exemplary embodiment.

FIG. 2 is a block diagram of a transmitter system (also known as access network) and a receiver system (also known as user equipment or UE) according to one exemplary embodiment.

FIG. 3 is a functional block diagram of a communication system according to one exemplary embodiment.

FIG. 4 is a functional block diagram of the program code of FIG. 3 according to one exemplary embodiment.

FIG. 5 illustrates a scenario associated with a successful Radio Resource Control (RRC) reconfiguration process, according to one exemplary embodiment.

FIG. 6 illustrates a scenario associated with a failed RRC reconfiguration process, according to one exemplary embodiment.

FIG. 7 illustrates a scenario associated with providing UE Assistance Information (UAI), according to one exemplary embodiment.

FIG. 8 illustrates a scenario associated with applicable functionality reporting, according to one exemplary embodiment.

FIG. 9 illustrates an example representation of a first configuration, according to one exemplary embodiment.

FIG. 10 illustrates an example representation of an applicability report, according to one exemplary embodiment.

FIG. 11 is a flow chart according to one exemplary embodiment.

FIG. 12 is a flow chart according to one exemplary embodiment.

FIG. 13 is a flow chart according to one exemplary embodiment.

FIG. 14 is a flow chart according to one exemplary embodiment.

FIG. 15 is a flow chart according to one exemplary embodiment.

FIG. 16 is a flow chart according to one exemplary embodiment.

FIG. 17 is a flow chart according to one exemplary embodiment.

FIG. 18 is a flow chart according to one exemplary embodiment.

FIG. 19 is a flow chart according to one exemplary embodiment.

FIG. 20 is a flow chart according to one exemplary embodiment.

FIG. 21 is a flow chart according to one exemplary embodiment.

FIG. 22 is a flow chart according to one exemplary embodiment.

### DETAILED DESCRIPTION

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3^{rd} Generation Partnership Project (3GPP) LTE (Long Term Evolution) wireless access, 3GPP LTE-A or LTE-Advanced (Long Term Evolution Advanced), 3GPP2 UMB (Ultra Mobile Broadband), WiMax, 3GPP NR (New Radio) wireless access for 5G, or some other modulation techniques.

In particular, the exemplary wireless communication systems and devices described below may be designed to support one or more standards such as the standard offered by a consortium named “3rd Generation Partnership Project” referred to herein as 3GPP, including: RP-240082, “Revised SID on AIML for mobility in NR”; RP-240774, “Revised WID for NR_AIML_air”; 3GPP TR 38.843 V18.0.0 (2023 December) 3GPP, TSG RAN, Study on Artificial Intelligence (AI)/Machine Learning (ML) for NR air interface (Release 18); 3GPP TS 38.331 V18.1.0 (2024 March) 3GPP, TSG RAN, NR, Radio Resource Control (RRC) protocol specification (Release 18); Report for RAN2 #127bis; Report for RAN1 #119. The standards and documents listed above are hereby expressly incorporated by reference in their entirety.

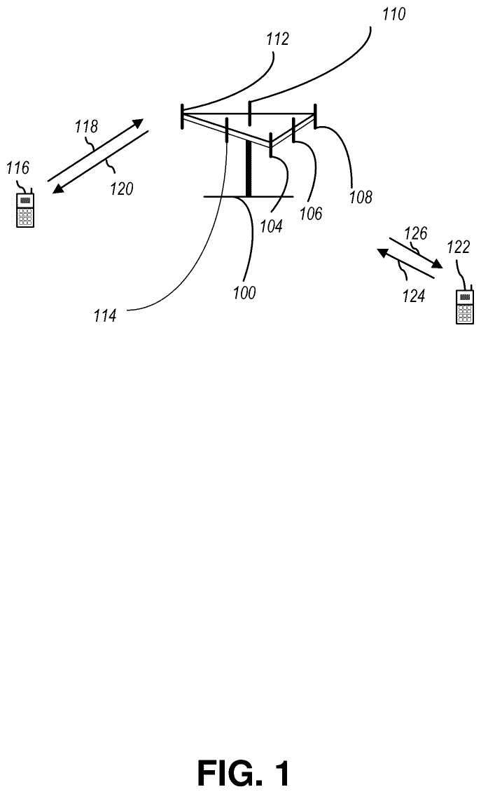

FIG. 1 presents a multiple access wireless communication system in accordance with one or more embodiments of the disclosure. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal 116 (AT) is in communication with antennas 112 and 114, where antennas 112 and 114 transmit information to access terminal 116 over forward link 120 and receive information from access terminal 116 over reverse link 118. AT 122 is in communication with antennas 106 and 108, where antennas 106 and 108 transmit information to AT 122 over forward link 126 and receive information from AT 122 over reverse link 124. In a frequency-division duplexing (FDD) system, communication links 118, 120, 124 and 126 may use different frequencies for communication. For example, forward link 120 may use a different frequency than that used by reverse link 118.

Each group of antennas and/or the area in which they are designed to communicate is often referred to as a sector of the access network. In the embodiment, antenna groups each may be designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage may normally cause less interference to access terminals in neighboring cells than an access network transmitting through a single antenna to its access terminals.

An access network (AN) may be a fixed station or base station used for communicating with the terminals and may also be referred to as an access point, a Node B, a base station, an enhanced base station, an eNodeB (eNB), a Next Generation NodeB (gNB), or some other terminology. An access terminal (AT) may also be called user equipment (UE), a wireless communication device, terminal, access terminal or some other terminology.

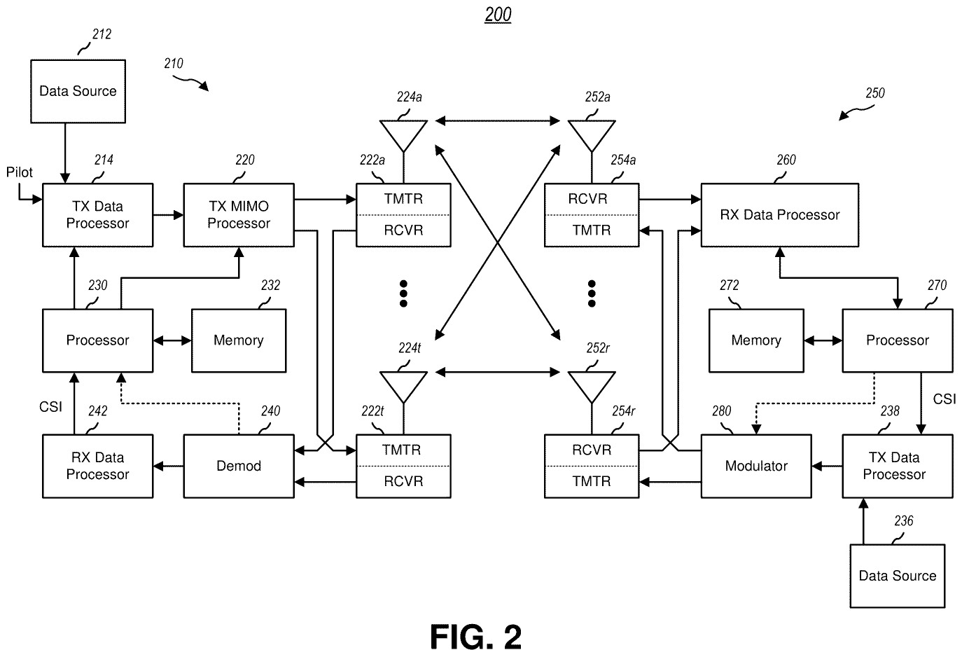

FIG. 2 presents an embodiment of a transmitter system 210 (also known as the access network) and a receiver system 250 (also known as access terminal (AT) or user equipment (UE)) in a multiple-input and multiple-output (MIMO) system 200. At the transmitter system 210, traffic data for a number of data streams may be provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using orthogonal frequency-division multiplexing (OFDM) techniques. The pilot data may typically be a known data pattern that is processed in a known manner and may be used at the receiver system to estimate the channel response. The multiplexed pilot and coded data for each data stream may then be modulated (i.e., symbol mapped) based on a particular modulation scheme (e.g., binary phase shift keying (BPSK), quadrature phase shift keying (QPSK), M-ary phase shift keying (M-PSK), or M-ary quadrature amplitude modulation (M-QAM)) selected for that data stream to provide modulation symbols. The data rate, coding, and/or modulation for each data stream may be determined by instructions performed by processor 230.

The modulation symbols for data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 may apply beamforming weights to the symbols of the data streams and to the antenna from which the symbol is being transmitted.

Each transmitter 222 receives and processes a respective symbol stream to provide one or more analog signals, and further conditions (e.g., amplifies, filters, and/or upconverts) the analog signals to provide a modulated signal suitable for transmission over the MIMO channel. N_{T} modulated signals from transmitters 222a through 222t may then be transmitted from N_{T} antennas 224a through 224t, respectively.

At receiver system 250, the transmitted modulated signals are received by NR antennas 252a through 252r and the received signal from each antenna 252 may be provided to a respective receiver (RCVR) 254a through 254r. Each receiver 254 may condition (e.g., filters, amplifies, and downconverts) a respective received signal, digitize the conditioned signal to provide samples, and/or further process the samples to provide a corresponding “received” symbol stream.

An RX data processor 260 then receives and/or processes the NR received symbol streams from NR receivers 254 based on a particular receiver processing technique to provide N_{T} “detected” symbol streams. The RX data processor 260 may then demodulate, deinterleave, and/or decode each detected symbol stream to recover the traffic data for the data stream. The processing by RX data processor 260 may be complementary to that performed by TX MIMO processor 220 and TX data processor 214 at transmitter system 210.

A processor 270 may periodically determine which pre-coding matrix to use (discussed below). Processor 270 formulates a reverse link message comprising a matrix index portion and a rank value portion.

The reverse link message may comprise various types of information regarding the communication link and/or the received data stream. The reverse link message may then be processed by a TX data processor 238, which may also receive traffic data for a number of data streams from a data source 236, modulated by a modulator 280, conditioned by transmitters 254a through 254r, and/or transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 may then determine which pre-coding matrix to use for determining the beamforming weights and may then process the extracted message.

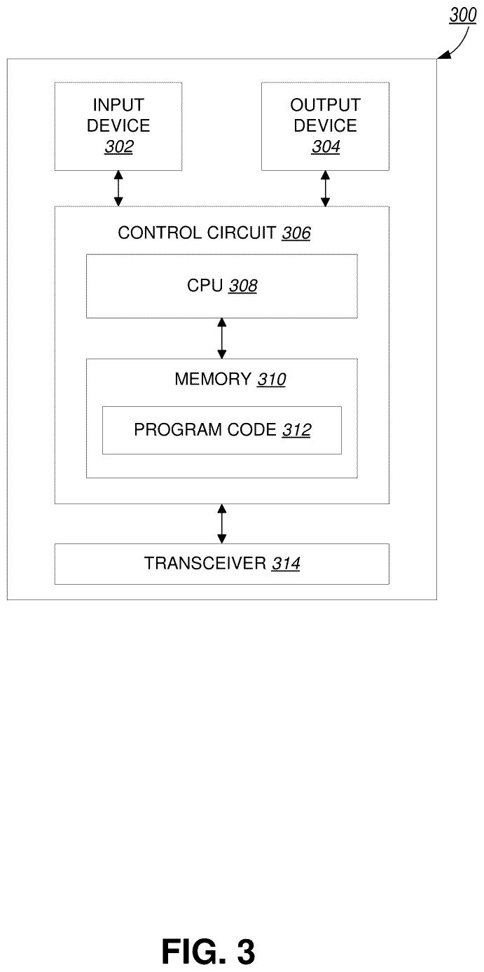

FIG. 3 presents an alternative simplified functional block diagram of a communication device according to one embodiment of the disclosed subject matter. As shown in FIG. 3, the communication device 300 in a wireless communication system can be utilized for realizing the UEs (or ATs) 116 and 122 in FIG. 1 or the base station (or AN) 100 in FIG. 1, and the wireless communications system may be the LTE system or the NR system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly. The communication device 300 in a wireless communication system can also be utilized for realizing the AN 100 in FIG. 1.

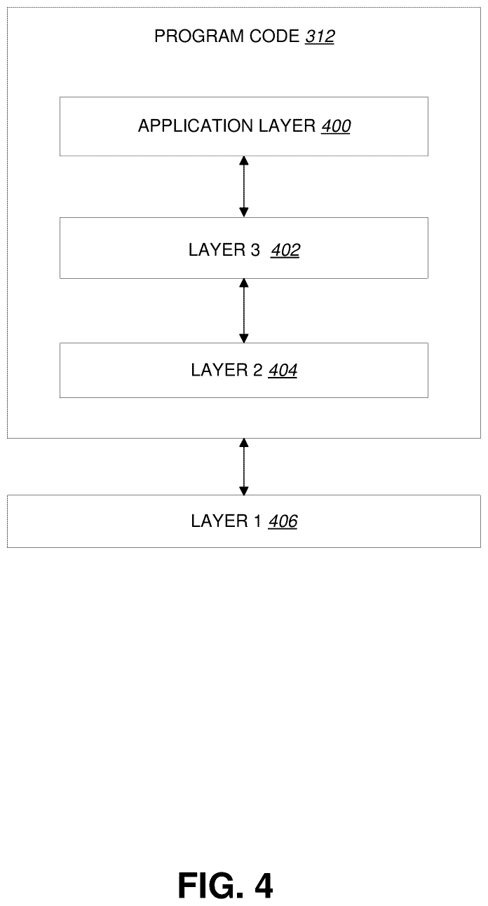

FIG. 4 is a simplified block diagram of the program code 312 shown in FIG. 3 in accordance with one embodiment of the disclosed subject matter. In this embodiment, the program code 312 includes an application layer 400, a Layer 3 portion 402, and a Layer 2 portion 404, and is coupled to a Layer 1 portion 406. The Layer 3 portion 402 may perform radio resource control. The Layer 2 portion 404 may perform link control. The Layer 1 portion 406 may perform and/or implement physical connections.

In Study Item Description (SID) RP-240082, one or more objectives of Artificial Intelligence (AI)/Machine Learning (ML) Mobility are specified. One or more parts of RP-240082 are quoted below:

### 3 Justification

With existing L3 handover mechanism, handover is triggered and executed based on reported historical measurement result and/or measurement event(s) i.e., it is kind of reactive scheme by its nature. It may work well among macro cells when UE's mobility is low for existing services. But it could be problematic when either UE's mobility is high or among micro cells of high density or both for existing services or future services e.g. XR, where such reactive scheme may result in more unintended event e.g., handover failure, radio link failure, Ping-Pong phenomenon, throughput loss or too early/late handover etc. To improve handover robustness conditional handover is introduced in Rel-16. And to reduce interruption time of frequent handover among small cells LTM HO is introduced in Rel-18. However, these two mechanisms are not sufficient because they are still reactive scheme by design. On the other hand, mechanism based on AI/ML algorithm has the potential to enable proactive scheme.

In Rel-18 SID called FS_NR_AIML_air was studied extensively on physical layer centric use cases including spatial and temporal beam prediction. Temporal prediction within serving cell is mainly to predict the best or top-K beam(s) or beam pair(s) in time domain in order to improve UE throughput. While predict the best or top-K beam(s) or beam pair(s) among a set of beams by measuring a smaller set of beams could help reduce RS signalling overhead, measurement efforts and UE power consumption etc. By extended L1 beam measurement from serving cell to neighbouring cell, majority of the RAN1 work can be reused. Since L3 measurement is based on filtering of L1 measurement, the study of AI/ML for air can be leveraged for mobility purpose e.g., temporal prediction can also be used to predict beam(s)/cell(s) becoming worse so that unintended event like radio link failure or short-stay handover can be avoided.

Mobility enhancement was also studied in RAN3 in Rel-17 in SID called FS_NR_ENDC_data_collect and is now specified in Rel-18 WID NR_AIML_NGRAN-Core. In these RAN3 items the study and normative work on mobility enhancement is based on information available in network side e.g. handover and stay of time in history among cells to predict UE's trajectory in single hop and hence potential candidates. In Rel-19 RAN3 will further work on UE's trajectory for multiple hops. The predicted UE's trajectory could be helpful for study on AI/ML mobility over air interface to some extent.

Based on progress made in RAN1 and RAN3 so far and assumption on UE's trajectory it is feasible to predict RRM measurement and/or event and hence candidate target cell in UE side. In network side new assistant information, if necessary, and statistics information based on measurement report from UE and/or neighbouring nodes can be also used for smart prediction. If some prediction information could be known by network, handover and/or RRM performance can be improved by proactive measures to either make a better decision or avoid unintended event.

### 4 Objective

4.1 Objective of SI or Core part WI or Testing part WI

The study will focus on mobility enhancement in RRC_CONNECTED mode over air interface by following existing mobility framework, i.e., handover decision is always made in network side. Mobility use cases focus on standalone NR PCell change. UE-side and network-side AI/ML model can be both considered, respectively.

Study and evaluate potential benefits and gains of AI/ML aided mobility for network triggered L3-based handover, considering the following aspects:
AI/ML based RRM measurement and event prediction,
   Cell-level measurement prediction including intra and inter-frequency (UE sided and NW sided model) [RAN2]
      Inter-cell Beam-level measurement prediction for L3 Mobility (UE sided and NW sided model) [RAN2]
   HO failure/RLF prediction (UE sided model) [RAN2]
   Measurement events prediction (UE sided model) [RAN2]
Study the need/benefits of any other UE assistance information for the network side model [RAN2]
The evaluation of the AI/ML aided mobility benefits should consider HO performance KPIs (e.g., Ping-pong HO, HOF/RLF, Time of stay, Handover interruption, prediction accuracy, and measurement reduction) etc.) and complexity tradeoffs [RAN2]
   NOTE: Simulation assumption and methodology can leverage TR 38.901, 38.843 and 36.839. And leave the detail discussion to RAN2
Potential AI mobility specific enhancement should be based on the Rel19 AI/ML-air interface WID general framework (e.g. LCM, performance monitoring etc) [RAN2]
   NOTE: This would only be treated after sufficient progress is made in the Rel-19 AI/ML air interface WID
Potential specification impacts of AI/ML aided mobility [RAN2]
   . . .

In Work Item Description (WID) RP-240774, one or more objectives of AI/ML for NR air interface are discussed. One or more parts of RP-240774 are quoted below:

### 3 Justification

The application of AI/ML techniques to NR air interface has been studied in FS_NR_AIML_Air. In this work item, we provide the normative support for the general framework for AI/ML for air interface, as well as, enable the recommended use cases in the preceding study. In addition, a number of study objectives in this project will tackle some outstanding issues identified during the study in an attempt to deepen the understanding in view of future normative work.

### 4 Objective

4.1 Objective of SI or Core part WI or Testing part WI

Provide specification support for the following aspects:
AI/ML general framework for one-sided AI/ML models within the realm of what has been studied in the FS_NR_AIML_Air project [RAN2]:
   Signalling and protocol aspects of Life Cycle Management (LCM) enabling functionality and model (if justified) selection, activation, deactivation, switching, fallback
      Identification related signalling is part of the above objective
   Necessary signalling/mechanism(s) for LCM to facilitate model training, inference, performance monitoring, data collection (except for the purpose of CN/OAM/OTT collection of UE-sided model training data) for both UE-sided and NW-sided models
   Signalling mechanism of applicable functionalities/models
Beam management-DL Tx beam prediction for both UE-sided model and NW-sided model, encompassing [RAN1/RAN2]:
   Spatial-domain DL Tx beam prediction for Set A of beams based on measurement results of Set B of beams (“BM-Case1”)
   Temporal DL Tx beam prediction for Set A of beams based on the historic measurement results of Set B of beams (“BM-Case2”)
   Specify necessary signalling/mechanism(s) to facilitate LCM operations specific to the Beam Management use cases, if any
   Enabling method(s) to ensure consistency between training and inference regarding NW-side additional conditions (if identified) for inference at UE
   NOTE: Strive for common framework design to support both BM-Case1 and BM-Case2
Positioning accuracy enhancements, encompassing [RAN1/RAN2/RAN3]:
   Direct AI/ML positioning:
      (1^{st} priority) Case 1: UE-based positioning with UE-side model, direct AI/ML positioning
      (2^{nd} priority) Case 2b: UE-assisted/LMF-based positioning with LMF-side model, direct AI/ML positioning
      (1^{st} priority) Case 3b: NG-RAN node assisted positioning with LMF-side model, direct AI/ML positioning
   AI/ML assisted positioning
      (2^{nd} priority) Case 2a: UE-assisted/LMF-based positioning with UE-side model, AI/ML assisted positioning
      (1^{st} priority) Case 3a: NG-RAN node assisted positioning with gNB-side model, AI/ML assisted positioning
   Specify necessary measurements, signalling/mechanism(s) to facilitate LCM operations specific to the Positioning accuracy enhancements use cases, if any
   Investigate and specify the necessary signalling of necessary measurement enhancements (if any)
   Enabling method(s) to ensure consistency between training and inference regarding NW-side additional conditions (if identified) for inference at UE for relevant positioning sub use cases
      . . .

Study objectives with corresponding checkpoints in RAN #105 (September '24):
CSI feedback enhancement [RAN1]:
   For CSI compression (two-sided model), further study ways to:
      Improve trade-off between performance and complexity/overhead
      e.g., considering extending the spatial/frequency compression to spatial/temporal/frequency compression, cell/site specific models, CSI compression plus prediction (compared to Rel-18 non-AI/ML based approach), etc.
   Alleviate/resolve issues related to inter-vendor training collaboration.
   while addressing other aspects requiring further study/conclusion as captured in the conclusions section of the TR 38.843.
   For CSI prediction (UE-sided model), further study performance gain over Rel-18 non-AI/ML based approach and associated complexity, while addressing other aspects requiring further study/conclusion as captured in the conclusions section of the TR 38.843 (e.g., cell/site specific model could be considered to improve performance gain).
Necessity and details of model Identification concept and procedure in the context of LCM [RAN2/RAN1] CN/OAM/OTT collection of UE-sided model training data [RAN2/RAN1]:
   For the FS_NR_AIML_Air study use cases, identify the corresponding contents of UE data collection
   Analyse the UE data collection mechanisms identified during the FS_NR_AIML_Air (TR 38.843 section 7.2.1.3.2) study along with the implications and limitations of each of the methods
Model transfer/delivery [RAN2/RAN1]:
   Determine whether there is a need to consider standardised solutions for transferring/delivering AI/ML model(s) considering at least the solutions identified during the FS_NR_AIML_Air study
      . . .
NOTE: offline training is assumed for the purpose of this project.
NOTE: the outcome of the study objectives should be captured in TR 38.843 for future reference.
NOTE: Coordination with SA/SA WGs of the ongoing study/work as it may relate to their required work.

In 3GPP TR 38.843 V18.0.0 (2023 December), a general framework and operations for LCM is discussed. One or more parts of 3GPP TR 38.843 V18.0.0 (2023 December) are quoted below:

### 4 General AI/ML Framework

The purpose of this clause is to identify common notation and terminology for AI/ML related functions, procedures and interfaces.

### 4.1 Description of AI/ML Stages

In this clause, the defining stages of AI/ML related algorithms and associated complexity are characterized, namely:
Model generation, e.g., model training (including input/output, pre-/post-process, online/offline as applicable), model validation, model testing, as applicable
Inference operation, e.g., input/output, pre-/post-process, as applicable

In addition, the treatment of dataset(s) for training, validation, testing, and inference is documented.

### 4.2 Life Cycle Management

In this clause, the life cycle management (LCM) of AI/ML model (e.g., model training, model deployment, model inference, model monitoring, model updating) and AI/ML functionality are characterized.

The following aspects, including the definition of components (if needed) and necessity, are studied in LCM:
Data collection
   Note: This also includes associated assistance information, if applicable.
Model training
Functionality/model identification
Model delivery/transfer
Model inference operation
Functionality/model selection, activation, deactivation, switching, and fallback operation.
   Including: Decision by the network (either network initiated or UE-initiated and requested to the network), decision by the UE (event-triggered as configured by the network, UE's decision reported to the network, or UE-autonomous either with UE's decision reported to the network or without it)
Functionality/model monitoring
Model update
   UE capability

### 4.2.1 LCM Flavours

The LCM procedure is studied for the case that an AI/ML model has a model ID with associated information and/or for the case that a given functionality is provided by some AI/ML operations. Note: Applicability of functionality-based LCM and model-ID-based LCM is a separate discussion.

From RAN1 perspective, an AI/ML model identified by a model ID may be logical, and how it maps to physical AI/ML model(s) may be up to implementation. When distinction is necessary for discussion purposes, companies may use the term a logical AI/ML model to refer to a model that is identified and assigned a model ID, and physical AI/ML model(s) to refer to an actual implementation of such a model.

For UE-side models and UE-part of two-sided models:
For AI/ML functionality identification
Legacy 3GPP framework of feature is taken as a starting point.
UE indicates supported functionalities/functionality for a given sub-use-case.
   UE capability reporting is taken as starting point.
For AI/ML model identification
   Models are identified by model ID at the Network. UE indicates supported AI/ML models.

In functionality-based LCM, network indicates activation/deactivation/fallback/switching of AI/ML functionality via 3GPP signalling (e.g., RRC, MAC-CE, DCI). Models may not be identified at the Network, and UE may perform model-level LCM. Whether and how much awareness/interaction NW should have about model-level LCM requires further study. For functionality identification, there may be either one or more than one Functionalities defined within an AI/ML-enabled feature, whereby AI/ML-enabled Feature refers to a Feature where AI/ML may be used. Note: UE may have one AI/ML model for the functionality, or UE may have multiple AI/ML models for the functionality.

For AI/ML functionality identification and functionality-based LCM of UE-side models and/or UE-part of two-sided models, functionality refers to an AI/ML-enabled Feature/FG enabled by configuration(s), where configuration(s) is (are) supported based on conditions indicated by UE capability. Correspondingly, functionality-based LCM operates based on, at least, one configuration of AI/ML-enabled Feature/FG or specific configurations of an AI/ML-enabled Feature/FG.

After functionality identification, necessity, mechanisms, for UE to report updates on applicable functionality(es) among functionality(es) are studied, where the applicable functionalities may be a subset of all functionalities. Applicable functionalities can be reported by the UE.

In model-ID-based LCM, models are identified at the Network, and Network/UE may activate/deactivate/select/switch individual AI/ML models via model ID.

For AI/ML model identification and model-ID-based LCM of UE-side models and/or UE-part of two-sided models, model-ID-based LCM operates based on identified models, where a model may be associated with specific configurations/conditions associated with UE capability of an AI/ML-enabled Feature/FG and additional conditions (e.g., scenarios, sites, and datasets) as determined/identified between UE-side and NW-side.

After model identification, necessity, mechanisms, for UE to report updates on applicable UE part/UE-side model(s), are studied, where the applicable models may be a subset of all identified models. Applicable models can be reported by the UE.

How to handle the impact of UE's internal conditions such as memory, battery, and other hardware limitations on functionality/model operations and AI/ML-enabled Feature is to be studied. Note: it does not preclude any existing solutions.

For functionality/model-ID based LCM, once functionalities/models are identified, the same or similar procedures may be used for their activation, deactivation, switching, fallback, and monitoring.

Model ID, if needed, can be used in a Functionality (defined in functionality-based LCM) for LCM operations.

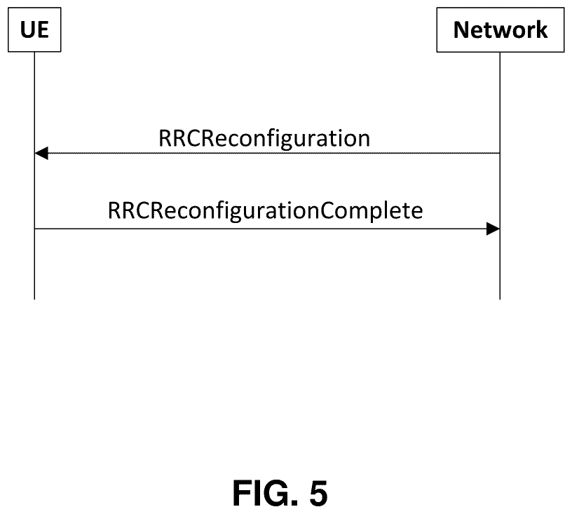

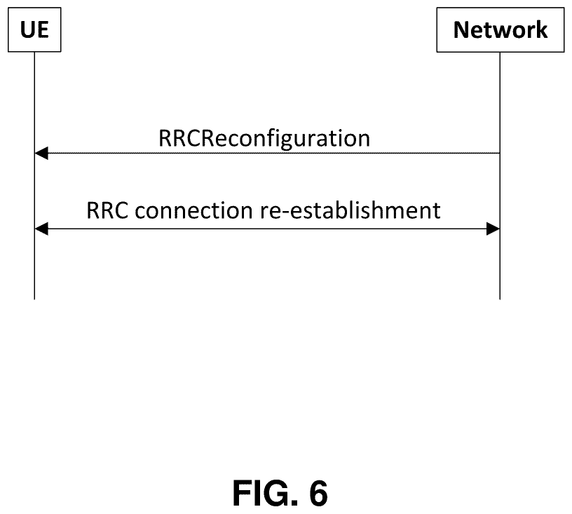

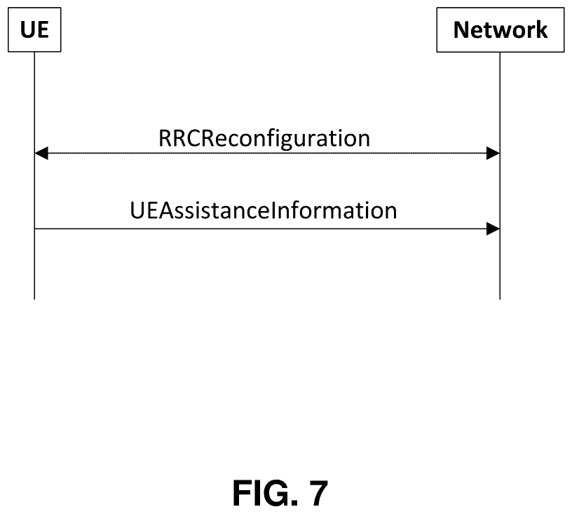

In 3GPP TS 38.331 V18.1.0 (2024 March), a procedure for RRCReconfiguration is discussed. Notably, FIG. 5.3.5.1-1: of Section 5.3.5.1 of 3GPP TS 38.331 V18.1.0 (2024 March), entitled “RRC reconfiguration, successful”, is reproduced herein as FIG. 5. FIG. 5.3.5.1-2: of Section 5.3.5.1 of 3GPP TS 38.331 V18.1.0 (2024 March), entitled “RRC reconfiguration, failure”, is reproduced herein as FIG. 6. FIG. 5.7.4.1-1: of Section 5.7.4.1 of 3GPP TS 38.331 V18.1.0 (2024 March), entitled “UE Assistance Information”, is reproduced herein as FIG. 7. One or more parts of 3GPP TS 38.331 V18.1.0 (2024-03) are quoted below:

### 5.3.5 RRC Ceconfiguration

### 5.3.5.1 General

### FIG. 5.3.5.1-1: RRC Reconfiguration, Successful

### FIG. 5.3.5.1-2: RRC Reconfiguration, Failure

The purpose of this procedure is to modify an RRC connection, e.g. to establish/modify/release RBs/BH RLC channels/Uu Relay RLC channels/PC5 Relay RLC channels, to perform reconfiguration with sync, to setup/modify/release measurements, to add/modify/release SCells and cell groups, to add/modify/release conditional reconfiguration configuration, to add/modify/release LTM configuration, and to add/modify/release MP configuration. As part of the procedure, NAS dedicated information may be transferred from the Network to the UE.

RRC reconfiguration to perform reconfiguration with sync includes, but is not limited to, the following cases:
reconfiguration with sync and security key refresh, involving RA to the PCell/PSCell, MAC reset, refresh of security and re-establishment of RLC and PDCP triggered by explicit indicators;
reconfiguration with sync but without security key refresh, involving RA to the PCell/PSCell, MAC reset and RLC re-establishment and PDCP data recovery (for AM DRB or AM MRB) triggered by explicit indicators;
reconfiguration with sync for DAPS and security key refresh, involving RA to the target PCell, establishment of target MAC, and
   for non-DAPS bearer: refresh of security and re-establishment of RLC and PDCP triggered by explicit indicators;
   for DAPS bearer: establishment of RLC for the target PCell, refresh of security and reconfiguration of PDCP to add the ciphering function, the integrity protection function and ROHC function of the target PCell;
   for SRB: refresh of security and establishment of RLC and PDCP for the target PCell;
reconfiguration with sync for DAPS but without security key refresh, involving RA to the target PCell, establishment of target MAC, and
   for non-DAPS bearer: RLC re-establishment and PDCP data recovery (for AM DRB or AM MRB) triggered by explicit indicators.
   for DAPS bearer: establishment of RLC for target PCell, reconfiguration of PDCP to add the ciphering function, the integrity protection function and ROHC function of the target PCell;
   for SRB: establishment of RLC and PDCP for the target PCell.
reconfiguration with sync for direct-to-indirect path switch or indirect-to-indirect path switch, not involving RA at target side, involving re-establishment of PDCP/PDCP data recovery (for AM DRB) triggered by explicit indicators;
reconfiguration with sync for LTM cell switch (without security key refresh), and
   involving or not involving RA to the target LTM candidate SpCell according to a network indication;
   MAC reset;
   depending on a network indication, involving or not involving re-establishment of RLC and PDCP data recovery (for AM DRB).

In (NG) EN-DC and NR-DC, SRB3 can be used for measurement configuration and reporting, for UE assistance (re-)configuration and reporting for power savings, for IP address (re-)configuration and reporting for IAB-nodes, to (re-)configure MAC, RLC, BAP, physical layer and RLF timers and constants of the SCG configuration, to reconfigure PDCP for DRBs associated with the S-K_{gNB} or SRB3, to reconfigure SDAP for DRBs associated with S-K_{gNB} in NGEN-DC and NR-DC, to add/modify/release conditional PSCell change configuration or subsequent CPAC configuration, and to add/modify/release the LTM configuration associated with the SCG (only in NR-DC), provided that the (re-)configuration does not require any MN involvement, and to transmit RRC messages between the MN and the UE during fast MCG link recovery. In (NG) EN-DC and NR-DC, only measConfig, radioBearerConfig, conditionalReconfiguration, Itm-Config (only in NR-DC), bap-Config, iab-IP-AddressConfigurationList, otherConfig, appLayerMeasConfig and/or secondaryCellGroup are included in RRCReconfiguration received via SRB3, except when RRCReconfiguration is received within DLInformationTransferMRDC.

When a clause of 5.3.5 is executed due to an LTM cell switch execution (i.e., as specified in 5.3.5.18.6) or due to a conditional reconfiguration execution for subsequent CPAC (i.e., as specified in 5.3.5.13.8), every appearance of “the received” before RRCReconfiguration message, before a field name, or before an IE name, refers to the RRCReconfiguration message that the UE applies, as specified in 5.3.5.18.6, 5.3.5.13.8, or the field or IE in that RRCReconfiguration message.

### 5.3.5.3 Reception of an RRCReconfiguration by the UE

The UE shall perform the following actions upon reception of the RRCReconfiguration, upon execution of the conditional reconfiguration (CHO, CPA, CPC, or subsequent CPAC), or upon execution of an LTM cell switch:

. . .
1> if the RRCReconfiguration includes the masterCellGroup:
   2> perform the cell group configuration for the received masterCellGroup according to 5.3.5.5;
      . . .
1> if the RRCReconfiguration includes the secondaryCellGroup:
   2> perform the cell group configuration for the SCG according to 5.3.5.5;
1> if the RRCReconfiguration includes the mrdc-SecondaryCellGroupConfig:
   2> if the mrdc-SecondaryCellGroupConfig is set to setup:
      3> if the mrdc-SecondaryCellGroupConfig includes mrdc-ReleaseAndAdd:
         4> perform MR-DC release as specified in clause 5.3.5.10;
      3> if the received mrdc-SecondaryCellGroup is set to nr-SCG:
         4> perform the RRC reconfiguration according to 5.3.5.3 for the RRCReconfiguration message included in nr-SCG;
      3> if the received mrdc-SecondaryCellGroup is set to eutra-SCG:
         4> perform the RRC connection reconfiguration as specified in TS 36.331 [10], clause 5.3.5.3 for the RRCConnectionReconfiguration message included in eutra-SCG;
   2> else (mrdc-SecondaryCellGroupConfig is set to release):
      3> perform MR-DC release as specified in clause 5.3.5.10;
         . . .
1> if the RRCReconfiguration message includes the otherConfig:
   2> perform the other configuration procedure as specified in 5.3.5.9;
      . . .
1> set the content of the RRCReconfigurationComplete message as follows:
   . . .
1> else (RRCReconfiguration was received via SRB1):
. . .
   2> submit the RRCReconfigurationComplete message via SRB1 to lower layers for transmission using the new configuration;
      . . .

### 5.3.5.5 Cell Group Configuration

### 5.3.5.5.1 General

The network configures the UE with Master Cell Group (MCG), and zero or one Secondary Cell Group (SCG). In (NG) EN-DC, the MCG is configured as specified in TS 36.331 [10], and for NE-DC, the SCG is configured as specified in TS 36.331 [10]. The network provides the configuration parameters for a cell group in the CellGroupConfig IE.

The UE performs the following actions based on a received CellGroupConfig IE:

. . .
1> if the CellGroupConfig contains the spCellConfig:
   2> configure the SpCell as specified in 5.3.5.5.7;
1> if the CellGroupConfig contains the sCellToAddModList:
   2> perform SCell addition/modification as specified in 5.3.5.5.9;
      . . .

### 5.3.5.5.7 SpCell Configuration

The UE shall:

. . .
1> else
. . .
   2> if the SpCellConfig contains spCellConfigDedicated:
      3> configure the SpCell in accordance with the spCellConfigDedicated;

### 5.3.5.5.9 SCell Addition/Modification

The UE shall:
1> for each sCellIndex value included in the sCellToAddModList that is not part of the current UE configuration (SCell addition):
   2> add the SCell, corresponding to the sCellIndex, in accordance with the sCellConfigCommon and sCellConfigDedicated;
   2> if the sCellState is included:
      3> configure lower layers to consider the SCell to be in activated state;
   2> else:
      3> configure lower layers to consider the SCell to be in deactivated state;
         . . .
1> for each sCellIndex value included in the sCellToAddModList that is part of the current UE configuration (SCell modification):
   2> modify the SCell configuration in accordance with the sCellConfigDedicated;
   2> if the sCellToAddModList was received in an RRCReconfiguration message including reconfigurationWithSync, or received in an RRCResume message, or received in an RRCReconfiguration message including reconfigurationWithSync embedded in an RRCResume message or embedded in an RRCReconfiguration message or embedded in an E-UTRA RRCConnectionReconfiguration message or embedded in an E-UTRA RRCConnectionResume message, or received in an RRCReconfiguration message embedded in an RRCReconfiguration message or embedded in an E-UTRA RRCConnectionReconfiguration message activating deactivated SCG:
      3> if the sCellState is included:
         4> configure lower layers to consider the SCell to be in activated state;
      3> else:
         4> configure lower layers to consider the SCell to be in deactivated state.

### 5.3.5.9 Other Configuration

The UE shall:
1> if the received otherConfig includes the delayBudgetReportingConfig:
   2> if delayBudgetReportingConfig is set to setup:
      3> consider itself to be configured to send delay budget reports in accordance with 5.7.4;
   2> else:
      3> consider itself not to be configured to send delay budget reports and stop timer T342, if running.
         . . .

### 5.7.4 UE Assistance Information

### 5.7.4.1 General

### FIG. 5.7.4.1-1: UE Assistance Information

The purpose of this procedure is for the UE to inform the network of:
its delay budget report carrying desired increment/decrement in the connected mode DRX cycle length; or
   . . .

### 5.7.4.2 Initiation

A UE capable of providing delay budget report in RRC_CONNECTED may initiate the procedure in several cases, including upon being configured to provide delay budget report and upon change of delay budget preference.

. . .

Upon initiating the procedure, the UE shall:
1> if configured to provide delay budget report:
   2> if the UE did not transmit a UEAssistanceInformation message with delayBudgetReport since it was configured to provide delay budget report; or
   2> if the current delay budget is different from the one indicated in the last transmission of the UEAssistanceInformation message including delayBudgetReport and timer T342 is not running:
      3> start or restart timer T342 with the timer value set to the delayBudgetReportingProhibitTimer;
      3> initiate transmission of the UEAssistanceInformation message in accordance with 5.7.4.3 to provide a delay budget report;

### 5.7.4.3 Actions Related to Transmission of UEAssistanceInformation Message

The UE shall set the contents of the UEAssistanceInformation message as follows:
1> if transmission of the UEAssistanceInformation message is initiated to provide a delay budget report according to 5.7.4.2 or 5.3.5.3;
   2> set delayBudgetReport to type1 according to a desired value;
      . . .

The UE shall:

. . .
1> else:
   2> submit the UEAssistanceInformation message to lower layers for transmission.
      . . .

### 6.2.2 Message Definitions

### RRCReconfiguration

The RRCReconfiguration message is the command to modify an RRC connection. It may convey information for measurement configuration, mobility control, radio resource configuration (including RBs, MAC main configuration and physical channel configuration) and AS security configuration.
Signalling radio bearer: SRB1 or SRB3
RLC-SAP: AM
Logical channel: DCCH
Direction: Network to UE

RRCReconfiguration message

-- ASN1START
-- TAG-RRCRECONFIGURATION-START

| | |
|---|---|
| RRCReconfiguration ::= | SEQUENCE { |
| rrc-TransactionIdentifier | RRC-TransactionIdentifier, |
| criticalExtensions | CHOICE { |
| rrcReconfiguration | RRCReconfiguration-IEs, |
| criticalExtensionsFuture | SEQUENCE { } |

}
}

| | |
|---|---|
| RRCReconfiguration-IEs ::= | SEQUENCE { |
| radioBearerConfig | RadioBearerConfig |

OPTIONAL, -- Need M

| | |
|---|---|
| secondaryCellGroup | OCTET STRING (CONTAINING |
| CellGroupConfig) | OPTIONAL, -- Cond SCG |
| measConfig | MeasConfig |

OPTIONAL, -- Need M

| | |
|---|---|
| lateNonCriticalExtension | OCTET STRING |

OPTIONAL,

| | |
|---|---|
| nonCriticalExtension | RRCReconfiguration-v1530-IEs |

OPTIONAL
}

| | |
|---|---|
| RRCReconfiguration-v1530-IEs ::= | SEQUENCE { |
| masterCellGroup | OCTET STRING (CONTAINING |
| CellGroupConfig) | OPTIONAL, -- Need M |
| fullConfig | ENUMERATED {true} |

OPTIONAL, -- Cond FullConfig

| | |
|---|---|
| dedicatedNAS-MessageList | SEQUENCE (SIZE(1..maxDRB)) OF |
| DedicatedNAS-Message | OPTIONAL, -- Cond nonHO |
| masterKeyUpdate | MasterKeyUpdate |

OPTIONAL, -- Cond MasterKeyChange

| | |
|---|---|
| dedicatedSIB1-Delivery | OCTET STRING (CONTAINING SIB1) |

OPTIONAL, -- Need N

| | |
|---|---|
| dedicatedSystemInformationDelivery | OCTET STRING (CONTAINING |
| SystemInformation) | OPTIONAL, -- Need N |
| otherConfig | OtherConfig |

OPTIONAL, -- Need M

| | |
|---|---|
| nonCriticalExtension | RRCReconfiguration-v1540-IEs |

OPTIONAL
}

| | |
|---|---|
| RRCReconfiguration-v1540-IEs ::= | SEQUENCE { |
| otherConfig-v1540 | OtherConfig-v1540 |

OPTIONAL, -- Need M

| | |
|---|---|
| nonCriticalExtension | RRCReconfiguration-v1560-IEs |

OPTIONAL
}

| | |
|---|---|
| RRCReconfiguration-v1560-IEs ::= | SEQUENCE { |
| mrdc-SecondaryCellGroupConfig | SetupRelease { MRDC- |
| SecondaryCellGroupConfig } | OPTIONAL, -- Need M |
| radioBearerConfig2 | OCTET STRING (CONTAINING |
| RadioBearerConfig) | OPTIONAL, -- Need M |
| sk-Counter | SK-Counter |

OPTIONAL, -- Need N

| | |
|---|---|
| nonCriticalExtension | RRCReconfiguration-v1610-IEs |

OPTIONAL
}
...

### RRCReconfigurationComplete

The RRCReconfigurationComplete message is used to confirm the successful completion of an RRC connection reconfiguration.
Signalling radio bearer: SRB1 or SRB3
RLC-SAP: AM
Logical channel: DCCH
Direction: UE to Network

RRCReconfigurationComplete message

| | |
|---|---|
| RRCReconfigurationComplete ::= | SEQUENCE { |
| rrc-TransactionIdentifier | RRC-TransactionIdentifier, |
| criticalExtensions | CHOICE { |

rrcReconfigurationComplete
RRCReconfigurationComplete-IEs,

| | |
|---|---|
| criticalExtensionsFuture | SEQUENCE { } |

}
}

| | |
|---|---|
| RRCReconfigurationComplete-IEs ::= | SEQUENCE { |
| lateNonCriticalExtension | OCTET STRING |

OPTIONAL,

| | |
|---|---|
| nonCriticalExtension | RRCReconfigurationComplete- |
| v1530-IEs | OPTIONAL |

}

| | |
|---|---|
| RRCReconfigurationComplete-v1530-IEs ::= | SEQUENCE { |
| uplinkTxDirectCurrentList | UplinkTxDirectCurrentList |

OPTIONAL,

| | |
|---|---|
| nonCriticalExtension | RRCReconfigurationComplete- |
| v1560-IEs | OPTIONAL |

}

| | |
|---|---|
| RRCReconfigurationComplete-v1560-IEs ::= | SEQUENCE { |
| scg-Response | CHOICE { |
| nr-SCG-Response | OCTET STRING (CONTAINING |

RRCReconfigurationComplete),

| | |
|---|---|
| eutra-SCG-Response | OCTET STRING |

}
OPTIONAL,

| | |
|---|---|
| nonCriticalExtension | RRCReconfigurationComplete- |
| v1610-IEs | OPTIONAL |

}
...

### UEAssistanceInformation

The UEAssistanceInformation message is used for the indication of UE assistance information to the network.
Signalling radio bearer: SRB1, SRB3
RLC-SAP: AM
Logical channel: DCCH
Direction: UE to Network

UEAssistanceInformation message

| | |
|---|---|
| UEAssistanceInformation ::= | SEQUENCE { |
| criticalExtensions | CHOICE { |
| ueAssistanceInformation | UEAssistanceInformation-IEs, |
| criticalExtensionsFuture | SEQUENCE { } |

}
}

| | |
|---|---|
| UEAssistanceInformation-IEs ::= | SEQUENCE { |
| delayBudgetReport | DelayBudgetReport |

OPTIONAL,

| | |
|---|---|
| lateNonCriticalExtension | OCTET STRING |

OPTIONAL,

| | |
|---|---|
| nonCriticalExtension | UEAssistanceInformation-v1540-IEs |

OPTIONAL
}

| | |
|---|---|
| DelayBudgetReport::= | CHOICE { |
| type1 | ENUMERATED { |
| | msMinus1280, msMinus640, |

msMinus320, msMinus160,msMinus80, msMinus60, msMinus40,

msMinus20, ms0, ms20,ms40, ms60,

ms80, ms160, ms320, ms640, ms1280},
...
}
...

### 6.3.2 Radio Resource Control Information Elements

. . .

### CellGroupConfig

The CellGroupConfig IE is used to configure a master cell group (MCG) or secondary cell group (SCG). A cell group comprises of one MAC entity, a set of logical channels with associated RLC entities and of a primary cell (SpCell) and one or more secondary cells (SCells). For an NCR-MT, the CellGroupConfig IE is also used to provide the configuration of side control information for the NCR-Fwd access link.
Configuration of one Cell-Group:

| CellGroupConfig ::= | SEQUENCE { | | |
|---|---|---|---|
| cellGroupId | | CellGroupId, | |
| rlc-BearerToAddModList | | SEQUENCE (SIZE (1..maxLC-ID)) | |
| OF RLC-BearerConfig | OPTIONAL, -- Need N | | |
| rlc-BearerToReleaseList | | SEQUENCE (SIZE (1..maxLC-ID)) | |
| OF LogicalChannelIdentity | OPTIONAL, -- Need N | | |
| mac-CellGroupConfig | | MAC-CellGroupConfig | |
| OPTIONAL, -- Need M | | | |
| physicalCellGroupConfig | | PhysicalCellGroupConfig | |
| OPTIONAL, -- Need M | | | |
| spCellConfig | | SpCellConfig | |
| OPTIONAL, -- Need M | | | |
| sCellToAddModList | | SEQUENCE (SIZE | |
| (1..maxNrofSCells)) OF SCellConfig | | | OPTIONAL, -- Need |
| N | | | |
| sCellToReleaseList | | SEQUENCE (SIZE | |
| (1..maxNrofSCells)) OF SCellIndex | | | OPTIONAL, -- Need |
| N | | | |
| ..., | | | |
| } | | | |
| ... | | | |

Serving cell specific MAC and PHY parameters for a SpCell:

| SpCellConfig ::= | | SEQUENCE { |
|---|---|---|
| servCellIndex | | ServCellIndex |
| OPTIONAL, -- Cond SCG | | |
| reconfigurationWithSync | | ReconfigurationWithSync |
| OPTIONAL, -- Cond ReconfWithSync | | |
| rlf-TimersAndConstants | | SetupRelease { RLF- |
| TimersAndConstants } | | OPTIONAL, -- Need M |
| rlmInSyncOutOfSyncThreshold | | ENUMERATED {n1} |
| OPTIONAL, -- Need S | | |
| spCellConfigDedicated | | ServingCellConfig |
| OPTIONAL, -- Need M | | |
| ..., | | |
| } | | |
| ... | | |
| SCellConfig ::= | SEQUENCE { | |
| sCellIndex | | SCellIndex, |
| sCellConfigCommon | | ServingCellConfigCommon |
| OPTIONAL, -- Cond SCellAdd | | |
| sCellConfigDedicated | | ServingCellConfig |
| OPTIONAL, -- Cond SCellAddMod | | |
| ..., | | |
| smtc | | SSB-MTC |
| OPTIONAL -- Need S | | |
| ]], | | |
| [[ | | |
| sCellState-r16 | ENUMERATED {activated} | |
| OPTIONAL, -- Cond SCellAddSync | | |
| secondaryDRX-GroupConfig-r16 | ENUMERATED {true} | |
| OPTIONAL -- Need S | | |
| ]], | | |
| [[ | | |
| preConfGapStatus-r17 | BIT STRING (SIZE (maxNrofGapId-r17)) | |
| OPTIONAL, -- Cond PreConfigMG | | |
| goodServingCellEvaluationBFD-r17 | GoodServingCellEvaluation-r17 | |
| OPTIONAL, -- Need R | | |
| sCellSIB20-r17 | SetupRelease { SCellSIB20-r17 } | |
| OPTIONAL -- Need M | | |
| ]], | | |
| [[ | | |
| plmn-IdentityInfoList-r17 | SetupRelease {PLMN-IdentityInfoList} | |
| OPTIONAL, -- Cond SCellSIB20-Opt | | |
| npn-IdentityInfoList-r17 | SetupRelease {NPN-IdentityInfoList-r16} | |
| OPTIONAL -- Cond SCellSIB20-Opt | | |
| ]] | | |
| } | | |
| ... | | |

### CSI-MeasConfig

The IE CSI-MeasConfig is used to configure CSI-RS (reference signals) belonging to the serving cell in which CSI-MeasConfig is included, channel state information reports to be transmitted on PUCCH on the serving cell in which CSI-MeasConfig is included and channel state information reports on PUSCH triggered by DCI received on the serving cell in which CSI-MeasConfig is included. See also TS 38.214 [19], clause 5.2.

CSI-MeasConfig information element

| CSI-MeasConfig ::= | SEQUENCE { | | |
|---|---|---|---|
| nzp-CSI-RS-ResourceToAddModList | | | SEQUENCE (SIZE (1..maxNrofNZP-CSI-RS- |
| Resources)) OF NZP-CSI-RS-Resource | | OPTIONAL, -- Need N | |
| nzp-CSI-RS-ResourceToReleaseList | | | SEQUENCE (SIZE (1..maxNrofNZP-CSI-RS- |

| | |
|---|---|
| Resources)) OF NZP-CSI-RS-ResourceId | OPTIONAL, -- Need N |

| | |
|---|---|
| nzp-CSI-RS-ResourceSetToAddModList | SEQUENCE (SIZE (1..maxNrofNZP-CSI-RS- |

ResourceSets)) OF NZP-CSI-RS-ResourceSet

OPTIONAL, -- Need N

| | |
|---|---|
| nzp-CSI-RS-ResourceSetToReleaseList | SEQUENCE (SIZE (1..maxNrofNZP-CSI-RS- |

ResourceSets)) OF NZP-CSI-RS-ResourceSetId

| OPTIONAL, -- Need N | | |
|---|---|---|
| csi-IM-ResourceToAddModList | SEQUENCE (SIZE (1..maxNrofCSI-IM- | |
| Resources)) OF CSI-IM-Resource | | OPTIONAL, -- Need N |
| csi-IM-ResourceToReleaseList | SEQUENCE (SIZE (1..maxNrofCSI-IM- | |
| Resources)) OF CSI-IM-ResourceId | | OPTIONAL, -- Need N |
| csi-IM-ResourceSetToAddModList | SEQUENCE (SIZE (1..maxNrofCSI-IM- | |
| ResourceSets)) OF CSI-IM-ResourceSet | | OPTIONAL, -- Need N |

| | |
|---|---|
| csi-IM-ResourceSetToReleaseList | SEQUENCE (SIZE (1..maxNrofCSI-IM- |

| | |
|---|---|
| ResourceSets)) OF CSI-IM-ResourceSetId | OPTIONAL, -- Need N |

| csi-SSB-ResourceSetToAddModList | SEQUENCE (SIZE (1..maxNrofCSI-SSB- |
|---|---|
| ResourceSets)) OF CSI-SSB-ResourceSet | OPTIONAL, -- Need N |
| csi-SSB-ResourceSetToReleaseList | SEQUENCE (SIZE (1..maxNrofCSI-SSB- |
| ResourceSets)) OF CSI-SSB-ResourceSetId | OPTIONAL, -- Need N |
| csi-ResourceConfigToAddModList | SEQUENCE (SIZE (1..maxNrofCSI- |

ResourceConfigurations)) OF CSI-ResourceConfig

OPTIONAL, -- Need N

| | |
|---|---|
| csi-ResourceConfigToReleaseList | SEQUENCE (SIZE (1..maxNrofCSI- |

ResourceConfigurations)) OF CSI-ResourceConfigId

OPTIONAL, -- Need N

| | |
|---|---|
| csi-ReportConfigToAddModList | SEQUENCE (SIZE (1..maxNrofCSI- |

ReportConfigurations)) OF CSI-ReportConfig OPTIONAL, -- Need N

| | |
|---|---|
| csi-ReportConfigToReleaseList | SEQUENCE (SIZE (1..maxNrofCSI- |

ReportConfigurations)) OF CSI-ReportConfigId

| OPTIONAL, -- Need N | | |
|---|---|---|
| reportTriggerSize | INTEGER (0..6) | |
| OPTIONAL, -- Need M | | |
| aperiodicTriggerStateList | SetupRelease { CSI- | |
| AperiodicTriggerStateList } | | OPTIONAL, -- Need M |

semiPersistentOnPUSCH-TriggerStateList SetupRelease { CSI-

| SemiPersistentOnPUSCH-TriggerStateList } | OPTIONAL, -- Need M |
|---|---|
| ..., | |
| } | |
| ... | |

### CSI-ReportConfig

The IE CSI-ReportConfig is used to configure a periodic or semi-persistent report sent on PUCCH on the cell in which the CSI-ReportConfig is included, or to configure a semi-persistent or aperiodic report sent on PUSCH triggered by DCI received on the cell in which the CSI-ReportConfig is included (in this case, the cell on which the report is sent is determined by the received DCI). See TS 38.214 [19], clause 5.2.1.

CSI-ReportConfig information element

| CSI-ReportConfig ::= | SEQUENCE { | | | | |
|---|---|---|---|---|---|
| reportConfigId | | | CSI-ReportConfigId, | | |
| carrier | | | ServCellIndex | | |
| OPTIONAL, -- Need S | | | | | |
| resourcesForChannelMeasurement | | | CSI-ResourceConfigId, | | |
| csi-IM-ResourcesForInterference | | | CSI-ResourceConfigId | | |
| OPTIONAL, -- Need R | | | | | |
| nzp-CSI-RS-ResourcesForInterference | | | CSI-ResourceConfigId | | |
| OPTIONAL, -- Need R | | | | | |
| reportConfigType | | | CHOICE { | | |
| periodic | | | | SEQUENCE { | |
| reportSlotConfig | | | | | CSI- |
| ReportPeriodicityAndOffset, | | | | | |
| pucch-CSI-ResourceList | | | | | SEQUENCE (SIZE |
| (1..maxNrofBWPs)) OF PUCCH-CSI-Resource | | | | | |
| }, | | | | | |
| semiPersistentOnPUCCH | | | | SEQUENCE { | |
| reportSlotConfig | | | | | CSI- |
| ReportPeriodicityAndOffset, | | | | | |
| pucch-CSI-ResourceList | | | | | SEQUENCE (SIZE |
| (1..maxNrofBWPs)) OF PUCCH-CSI-Resource | | | | | |
| }, | | | | | |
| semiPersistentOnPUSCH | | | | SEQUENCE { | |
| reportSlotConfig | | | | | ENUMERATED {sl5, sl10, |
| sl20, sl40, sl80, sl160, sl320), | | | | | |
| reportSlotOffsetList | | | | SEQUENCE (SIZE (1.. | |
| maxNrofUL-Allocations)) OF INTEGER (0..32), | | | | | |
| p0alpha | | | | | P0-PUSCH-AlphaSetId |
| }, | | | | | |
| aperiodic | | | | SEQUENCE { | |
| reportSlotOffsetList | | | | SEQUENCE (SIZE (1..maxNrofUL- | |
| Allocations)) OF INTEGER(0..32) | | | | | |
| } | | | | | |
| }, | | | | | |
| reportQuantity | | | CHOICE { | | |
| none | | | | NULL, | |
| cri-RI-PMI-CQI | | | | NULL, | |
| cri-RI-il | | | | NULL, | |
| cri-RI-il-CQI | | | | SEQUENCE { | |
| pdsch-BundleSizeForCSI | | | | | ENUMERATED {n2, n4} |
| OPTIONAL -- Need S | | | | | |
| }, | | | | | |
| cri-RI-CQI | | | | NULL, | |
| cri-RSRP | | | | NULL, | |
| ssb-Index-RSRP | | | | NULL, | |
| cri-RI-LI-PMI-CQI | | | | NULL | |
| }, | | | | | |
| reportFreqConfiguration | | | SEQUENCE { | | |
| cqi-FormatIndicator | | | | ENUMERATED { widebandCQI, | |
| subbandCQI } | | OPTIONAL, -- Need R | | | |
| pmi-Format Indicator | | | | ENUMERATED { widebandPMI, | |
| subbandPMI } | | OPTIONAL, -- Need R | | | |
| csi-ReportingBand | | | | CHOICE { | |
| subbands3 | | | | | BIT STRING(SIZE(3)), |
| subbands4 | | | | | BIT STRING(SIZE(4)), |
| subbands5 | | | | | BIT STRING(SIZE(5)), |
| subbands6 | | | | | BIT STRING(SIZE(6)), |
| subbands7 | | | | | BIT STRING(SIZE(7)), |
| subbands8 | | | | | BIT STRING(SIZE(8)), |
| subbands9 | | | | | BIT STRING(SIZE(9)), |
| subbands10 | | | | | BIT STRING(SIZE(10)), |
| subbands11 | | | | | BIT STRING(SIZE(11)), |
| subbands12 | | | | | BIT STRING(SIZE(12)), |
| subbands13 | | | | | BIT STRING(SIZE(13)), |
| subbands14 | | | | | BIT STRING(SIZE(14)), |
| subbands15 | | | | | BIT STRING(SIZE(15)), |
| subbands16 | | | | | BIT STRING(SIZE(16)), |
| subbands17 | | | | | BIT STRING(SIZE(17)), |
| subbands18 | | | | | BIT STRING(SIZE(18)), |
| ..., | | | | | |
| subbands19-v1530 | | | | | BIT STRING(SIZE(19)) |
| } OPTIONAL -- Need S | | | | | |
| } | | | | | |
| OPTIONAL, -- Need R | | | | | |
| timeRestriction ForChannelMeasurements | | | | | ENUMERATED {configured, |
| notConfigured}, | | | | | |
| timeRestrictionForInterferenceMeasurements | | | | | ENUMERATED {configured, |
| notConfigured}, | | | | | |
| codebookConfig | | | | | CodebookConfig |
| OPTIONAL, -- Need R | | | | | |
| dummy | | | | | ENUMERATED {n1, n2} |
| OPTIONAL, -- Need R | | | | | |
| groupBasedBeamReporting | | | | CHOICE { | |
| enabled | | | | | NULL, |
| disabled | | | | | SEQUENCE { |
| nrofReportedRS | | | | | ENUMERATED {n1, n2, n3, |
| n4} | OPTIONAL -- Need S | | | | |
| } | | | | | |
| }, | | | | | |

| cqi-Table | ENUMERATED {table1, table2, table3, table4- | |
|---|---|---|
| r17} | | OPTIONAL, -- Need R |

| | |
|---|---|
| subbandSize | ENUMERATED {value1, value2}, |
| non-PMI-PortIndication | SEQUENCE (SIZE (1..maxNrofNZP-CSI-RS- |

ResourcesPerConfig}) OF PortIndexFor8Ranks OPTIONAL, -- Need R

| ..., | | | |
|---|---|---|---|
| } | | | |
| CSI-ReportPeriodicityAndOffset ::= CHOICE { | | | |
| slots4 | | INTEGER(0..3), | |
| slots5 | | INTEGER(0..4), | |
| slots8 | | INTEGER(0..7), | |
| slots10 | | INTEGER(0..9), | |
| slots16 | | INTEGER(0..15), | |
| slots20 | | INTEGER(0..19), | |
| slots40 | | INTEGER(0..39), | |
| slots80 | | INTEGER(0..79), | |
| slots160 | | INTEGER(0..159), | |
| slots320 | | INTEGER(0..319), | |
| } | | | |
| PortIndexFor8Ranks ::= | CHOICE { | | |
| portIndex8 | | SEQUENCE{ | |
| rank1-8 | | | PortIndex8 |
| OPTIONAL, -- Need R | | | |
| rank2-8 | | | SEQUENCE(SIZE(2)) OF PortIndex8 |
| OPTIONAL, -- Need R | | | |
| rank3-8 | | | SEQUENCE(SIZE(3)) OF PortIndex8 |
| OPTIONAL, -- Need R | | | |
| rank4-8 | | | SEQUENCE(SIZE(4)) OF PortIndex8 |
| OPTIONAL, -- Need R | | | |
| rank5-8 | | | SEQUENCE(SIZE(5)) OF PortIndex8 |
| OPTIONAL, -- Need R | | | |
| rank6-8 | | | SEQUENCE(SIZE(6)) OF PortIndex8 |
| OPTIONAL, -- Need R | | | |
| rank7-8 | | | SEQUENCE(SIZE(7)) OF PortIndex8 |
| OPTIONAL, -- Need R | | | |
| rank8-8 | | | SEQUENCE(SIZE(8)) OF PortIndex8 |
| OPTIONAL -- Need R | | | |
| }, | | | |
| portIndex4 | | SEQUENCE{ | |
| rank1-4 | | | PortIndex4 |
| OPTIONAL, -- Need R | | | |
| rank2-4 | | | SEQUENCE(SIZE(2)) OF PortIndex4 |
| OPTIONAL, -- Need R | | | |
| rank3-4 | | | SEQUENCE(SIZE(3)) OF PortIndex4 |
| OPTIONAL, -- Need R | | | |
| rank4-4 | | | SEQUENCE(SIZE(4)) OF PortIndex4 |
| OPTIONAL -- Need R | | | |
| }, | | | |
| portIndex2 | | SEQUENCE{ | |
| rank1-2 | | | PortIndex2 |
| OPTIONAL, -- Need R | | | |
| rank2-2 | | | SEQUENCE(SIZE(2)) OF PortIndex2 |
| OPTIONAL -- Need R | | | |
| }, | | | |
| portIndex1 | | NULL | |
| } | | | |
| PortIndex8::= | INTEGER (0..7) | | |
| PortIndex4::= | INTEGER (0..3) | | |
| PortIndex2::= | INTEGER (0..1) | | |
| ... | | | |

### MeasConfig

The IE MeasConfig specifies measurements to be performed by the UE, and covers intra-frequency, inter-frequency and inter-RAT mobility as well as configuration of measurement gaps.

MeasConfig information element

| MeasConfig ::= | SEQUENCE { | | |
|---|---|---|---|
| measObjectToRemoveList | | MeasObjectToRemoveList | |
| OPTIONAL, -- Need N | | | |
| measObjectToAddModList | | MeasObjectToAddModList | |
| OPTIONAL, -- Need N | | | |
| reportConfigToRemoveList | | ReportConfigToRemoveList | |
| OPTIONAL, -- Need N | | | |
| reportConfigToAddModList | | ReportConfigToAddModList | |
| OPTIONAL, -- Need N | | | |
| measIdToRemoveList | | MeasIdToRemoveList | |
| OPTIONAL, -- Need N | | | |
| meas IdToAddModList | | MeasIdToAddModList | |
| OPTIONAL, -- Need N | | | |
| s-MeasureConfig | | CHOICE { | |
| ssb-RSRP | | | RSRP-Range, |
| csi-RSRP | | | RSRP-Range |
| } | | | |
| OPTIONAL, -- Need M | | | |
| quantityConfig | | QuantityConfig | |
| OPTIONAL, -- Need M | | | |
| measGapConfig | | MeasGapConfig | |
| OPTIONAL, -- Need M | | | |
| measGapSharingConfig | | MeasGapSharingConfig | |
| OPTIONAL, -- Need M | | | |
| ..., | | | |
| [[ | | | |
| interFrequencyConfig-NoGap-r16 | | ENUMERATED {true} | |
| OPTIONAL -- Need R | | | |
| ]], | | | |
| [[ | | | |
| effectiveMeasWindowConfig-r18 | | SetupRelease {MeasWindowConfig-r18} | |
| OPTIONAL -- Need M | | | |
| ]] | | | |
| } | | | |
| MeasObjectToRemoveList ::= | | SEQUENCE (SIZE (1..maxNrofObjectId)) | |
| OF MeasObjectId | | | |
| Meas IdToRemoveList ::= | | SEQUENCE (SIZE (1..maxNrofMeasId)) OF | |
| MeasId | | | |
| ReportConfigToRemoveList ::= | | SEQUENCE (SIZE | |
| (1..maxReportConfigId)) OF ReportConfigId | | | |
| ... | | | |

### MeasId

The IE MeasId is used to identify a measurement configuration, i.e., linking of a measurement object and a reporting configuration.

MeasId information element

| | |
|---|---|
| MeasId ::= | INTEGER (1..maxNrofMeasId) |

...

### MeasIdToAddModList

The IE MeasIdToAddModList concerns a list of measurement identities to add or modify, with for each entry the measId, the associated measObjectId and the associated reportConfigId.

MeasldToAddModList information element

| | |
|---|---|
| MeasIdToAddModList ::= | SEQUENCE (SIZE (1..maxNrofMeasId)) OF |
| Meas IdToAddMod | |
| Meas IdToAddMod ::= | SEQUENCE { |
| measId | MeasId, |
| measObjectId | MeasObjectId, |
| reportConfigId | ReportConfigId |
| } | |
| ... | |

### MeasObjectId

The IE MeasObjectId used to identify a measurement object configuration.

MeasObjectId information element

| | |
|---|---|
| MeasObjectId ::= | INTEGER (1..maxNrofObjectId) |

...

### MeasObjectNR

The IE MeasObjectNR specifies information applicable for SS/PBCH block(s) intra/inter-frequency measurements and/or CSI-RS intra/inter-frequency measurements.

MeasObjectNR information element

-- ASN1START
-- TAG-MEASOBJECTNR-START

| MeasObjectNR ::= | | SEQUENCE { | | |
|---|---|---|---|---|
| ssbFrequency | | | ARFCN-ValueNR | |
| OPTIONAL, -- Cond SSBorAssociatedSSB | | | | |
| ssbSubcarrierSpacing | | | SubcarrierSpacing | |
| OPTIONAL, -- Cond SSBorAssociatedSSB | | | | |
| smtc1 | | | SSB-MTC | |
| OPTIONAL, -- Cond SSBorAssociatedSSB | | | | |
| smtc2 | | | SSB-MTC2 | |
| OPTIONAL, -- Cond IntraFreqConnected | | | | |
| refFreqCSI-RS | | | ARFCN-ValueNR | |
| OPTIONAL, -- CondCSI-RS | | | | |
| referenceSignalConfig | | | ReferenceSignalConfig, | |
| absThreshSS-BlocksConsolidation | | | ThresholdNR | |
| OPTIONAL, -- Need R | | | | |
| absThreshCSI-RS-Consolidation | | | ThresholdNR | |
| OPTIONAL, -- Need R | | | | |
| nrofSS-BlocksToAverage | | | INTEGER (2..maxNrofSS- | |
| BlocksToAverage) | | | | OPTIONAL, -- Need R |
| nrofCSI-RS-ResourcesToAverage | | | INTEGER (2..maxNrofCSI-RS- | |
| ResourcesToAverage) | | OPTIONAL, -- Need R | | |
| quantityConfigIndex | | | INTEGER (1..maxNrofQuantityConfig), | |
| offsetMO | | | Q-OffsetRangeList, | |
| cellsToRemoveList | | | PCI-List | |
| OPTIONAL, -- Need N | | | | |
| cellsToAddModList | | | CellsToAddModList | |
| OPTIONAL, -- Need N | | | | |
| excludedCellsToRemoveList | | | PCI-RangeIndexList | |
| OPTIONAL, -- Need N | | | | |
| excludedCellsToAddModList | | | SEQUENCE (SIZE (1..maxNrofPCI- | |
| Ranges)) OF PCI-RangeElement | OPTIONAL, -- Need N | | | |
| allowedCellsToRemoveList | | | PCI-RangeIndexList | |
| OPTIONAL, -- Need N | | | | |
| allowedCellsToAddModList | | | SEQUENCE (SIZE (1..maxNrofPCI- | |
| Ranges)) OF PCI-RangeElement | OPTIONAL, -- Need N | | | |
| ..., | | | | |
| } | | | | |
| ReferenceSignalConfig::= | | SEQUENCE { | | |
| ssb-ConfigMobility | | | SSB-ConfigMobility | |
| OPTIONAL, -- Need M | | | | |
| csi-rs-ResourceConfigMobility | | | SetupRelease { CSI-RS- | |
| ResourceConfigMobility } | | | | OPTIONAL -- Need M |
| } | | | | |
| SSB-ConfigMobility::= | | SEQUENCE { | | |
| ssb-ToMeasure | | | SetupRelease { SSB-ToMeasure } | |
| OPTIONAL, -- Need M | | | | |
| deriveSSB-IndexFromCell | | | BOOLEAN, | |
| ss-RSSI-Measurement | | | SS-RSSI-Measurement | |
| OPTIONAL, -- Need M | | | | |
| ..., | | | | |
| } | | | | |
| Q-OffsetRangeList ::= | | SEQUENCE { | | |
| rsrpOffsetSSB | | | Q-OffsetRange DEFAULT | |
| dB0, | | | | |
| rsrqOffsetSSB | | | Q-OffsetRange DEFAULT | |
| dB0, | | | | |
| sinrOffsetSSB | | | Q-OffsetRange DEFAULT | |
| dB0, | | | | |
| rsrpOffsetCSI-RS | | | Q-OffsetRange DEFAULT | |
| dB0, | | | | |
| rsrqOffsetCSI-RS | | | Q-OffsetRange DEFAULT | |
| dB0, | | | | |
| sinrOffsetCSI-RS | | | Q-OffsetRange DEFAULT | |
| dB0 | | | | |
| } | | | | |
| ThresholdNR ::= | | SEQUENCE{ | | |
| thresholdRSRP | | | RSRP-Range | |
| OPTIONAL, -- Need R | | | | |
| thresholdRSRQ | | | RSRQ-Range | |
| OPTIONAL, -- Need R | | | | |
| thresholdSINR | | | SINR-Range | |
| OPTIONAL -- Need R | | | | |
| } | | | | |
| CellsToAddModList ::= | | SEQUENCE (SIZE (1..maxNrofCellMeas)) OF | | |
| CellsToAddMod | | | | |
| CellsToAddMod ::= | | SEQUENCE { | | |
| physCellId | | | PhysCellId, | |
| cellIndividualOffset | | | Q-OffsetRangeList | |
| } | | | | |
| ... | | | | |

### MeasObjectToAddModList

The IE MeasObjectToAddModList concerns a list of measurement objects to add or modify.

MeasObjectToAddModList information element

| | |
|---|---|
| MeasObjectToAddModList ::= | SEQUENCE (SIZE |
| (1..maxNrofObjectId)) OF MeasObjectToAddMod | |
| MeasObjectToAddMod ::= | SEQUENCE { |
| measObjectId | MeasObjectId, |
| measObject | CHOICE { |
| measObjectNR | MeasObjectNR, |
| ..., | |
| measObjectEUTRA | MeasObjectEUTRA, |
| measObjectUTRA-FDD-r16 | MeasObjectUTRA-FDD-r16, |
| measObjectNR-SL-r16 | MeasObjectNR-SL-r16, |
| measObjectCLI-r16 | MeasObjectCLI-r16, |
| measObjectRxTxDiff-r17 | MeasObjectRxTxDiff-r17, |
| measObjectRelay-r17 | SL-MeasObject-r16, |
| measObjectNR-SL-r18 | MeasObjectNR-SL-r18 |
| } | |
| } | |
| ... | |

### ReportConfigId

The IE ReportConfigId is used to identify a measurement reporting configuration.

ReportConfigId information element

| | |
|---|---|
| ReportConfigId ::= | INTEGER (1..maxReportConfigId) |

...

### ReportConfigNR

The IE ReportConfigNR specifies criteria for triggering of an NR measurement reporting event or of a CHO, CPA or CPC event or of an L2 U2N relay measurement reporting event. For events labelled AN with N equal to 1, 2 and so on, measurement reporting events and CHO, CPA or CPC events are based on cell measurement results, which can either be derived based on SS/PBCH block or CSI-RS.
Event A1: Serving becomes better than absolute threshold;
Event A2: Serving becomes worse than absolute threshold;
Event A3: Neighbour becomes amount of offset better than PCell/PSCell;
Event A4: Neighbour becomes better than absolute threshold;
Event A5: PCell/PSCell becomes worse than absolute threshold1 AND Neighbour/SCell becomes better than another absolute threshold2;
Event A6: Neighbour becomes amount of offset better than SCell;

ReportConfigNR information element

| | |
|---|---|
| ReportConfigNR ::= | SEQUENCE { |
| reportType | CHOICE { |
| periodical | PeriodicalReportConfig, |
| eventTriggered | EventTriggeredConfig, |
| ..., | |
| reportCGI | ReportCGI, |
| reportSFTD | ReportSFTD-NR, |
| condTriggerConfig-r16 | CondTriggerConfig-r16, |
| cli-Periodical-r16 | CLI- |
| PeriodicalReportConfig-r16, | |
| cli-EventTriggered-r16 | CLI-EventTriggeredConfig- |
| r16, | |
| rxTxPeriodical-r17 | RxTxPeriodical-r17, |
| reportOnScellActivation-r18 | ReportOnScellActivation- |
| r18 | |
| } | |
| } | |
| EventTriggerConfig ::= | SEQUENCE { |
| eventId | CHOICE { |
| eventA1 | SEQUENCE { |
| a1-Threshold | MeasTriggerQuantity, |
| reportOnLeave | BOOLEAN, |
| hysteresis | Hysteresis, |
| timeToTrigger | TimeToTrigger |
| }, | |
| eventA2 | SEQUENCE { |
| a2-Threshold | MeasTriggerQuantity, |
| reportOnLeave | BOOLEAN, |
| hysteresis | Hysteresis, |
| timeToTrigger | TimeToTrigger |
| }, | |
| eventA3 | SEQUENCE { |
| a3-Offset | |
| MeasTriggerQuantityOffset, | |
| reportOnLeave | BOOLEAN, |
| hysteresis | Hysteresis, |
| timeToTrigger | TimeToTrigger, |
| useAllowedCellList | BOOLEAN |
| }, | |
| eventA4 | SEQUENCE { |
| a4-Threshold | MeasTriggerQuantity, |
| reportOnLeave | BOOLEAN, |
| hysteresis | Hysteresis, |
| timeToTrigger | TimeToTrigger, |
| useAllowedCellList | BOOLEAN |
| }, | |
| eventA5 | SEQUENCE { |
| a5-Threshold1 | MeasTriggerQuantity, |
| a5-Threshold2 | MeasTriggerQuantity, |
| reportOnLeave | BOOLEAN, |
| hysteresis | Hysteresis, |
| timeToTrigger | TimeToTrigger, |
| useAllowedCellList | BOOLEAN |
| }, | |
| eventA6 | SEQUENCE { |
| a6-Offset | |
| MeasTriggerQuantityOffset, | |
| reportOnLeave | BOOLEAN, |
| hysteresis | Hysteresis, |
| timeToTrigger | TimeToTrigger, |
| useAllowedCellList | BOOLEAN |
| }, | |
| ..., | |
| }, | |
| rsType | NR-RS-Type, |
| reportInterval | ReportInterval, |
| reportAmount | ENUMERATED {r1, r2, r4, r8, |
| r16, r32, r64, infinity), | |
| reportQuantityCell | MeasReportQuantity, |
| maxReportCells | INTEGER |
| reportQuantityRS-Indexes | MeasReportQuantity |
| OPTIONAL, -- Need R | |
| maxNRofRS-IndexesToReport | INTEGER |
| (1..maxNrofIndexesToReport) | OPTIONAL, -- Need R |
| includeBeamMeasurements | BOOLEAN, |
| reportAddNeighMeas | ENUMERATED {setup} |
| OPTIONAL, -- Need R | |
| ..., | |
| } | |
| PeriodicalReportConfig ::= | SEQUENCE { |
| rsType | NR-RS-Type, |
| reportInterval | Report Interval, |
| reportAmount | ENUMERATED { r1, r2, r4, r8, |
| r16, r32, r64, infinity}, | |
| reportQuantityCell | MeasReportQuantity, |
| maxReportCells | INTEGER (1..maxCellReport), |
| reportQuantityRS-Indexes | MeasReportQuantity |
| OPTIONAL, -- Need R | |
| maxNrofRS-IndexesToReport | INTEGER |
| (1..maxNrofIndexesToReport) | OPTIONAL, -- Need R |
| includeBeamMeasurements | BOOLEAN, |
| useAllowedCellList | BOOLEAN, |
| ..., | |
| } | |
| NR-RS-Type ::= | ENUMERATED {ssb, csi-rs} |
| MeasTriggerQuantity ::= | CHOICE { |
| rsrp | RSRP-Range, |
| rsrq | RSRQ-Range, |
| sinr | SINR-Range |
| } | |
| MeasTriggerQuantityOffset ::= | CHOICE { |
| rsrp | INTEGER (−30..30), |
| rsrq | INTEGER (−30..30), |
| sinr | INTEGER (−30..30) |
| } | |
| MeasReportQuantity ::= | SEQUENCE { |
| rsrp | BOOLEAN, |
| rsrq | BOOLEAN, |
| sinr | BOOLEAN |
| } | |
| ... | |

### ReportConfig ToAddModList

The IE ReportConfigToAddModList concerns a list of reporting configurations to add or modify.

ReportConfigToAddModList information element

| | |
|---|---|
| ReportConfigToAddModList ::= | SEQUENCE (SIZE (1..maxReportConfigId)) OF |
| ReportConfigToAddMod | |
| ReportConfigToAddMod ::= | SEQUENCE { |
| reportConfigId | ReportConfigId, |
| reportConfig | CHOICE { |
| reportConfigNR | ReportConfigNR, |
| ..., | |
| reportConfigInterRAT | ReportConfigInterRAT, |
| reportConfigNR-SL-r16 | ReportConfigNR-SL-r16 |
| } | |
| } | |
| ... | |

### ServingCellConfig

The IE ServingCellConfig is used to configure (add or modify) the UE with a serving cell, which may be the SpCell or an SCell of an MCG or SCG. The parameters herein are mostly UE specific but partly also cell specific (e.g. in additionally configured bandwidth parts). Reconfiguration between a PUCCH and PUCCHless SCell is only supported using an SCell release and add.

ServingCellConfig information element

| | |
|---|---|
| -- ASN1START | |
| -- TAG-SERVINGCELLCONFIG-START | |
| ServingCellConfig ::= | SEQUENCE { |
| tdd-UL-DL-ConfigurationDedicated | TDD-UL-DL-ConfigDedicated |
| OPTIONAL, -- Cond TDD | |
| initialDownlinkBWP | BWP-DownlinkDedicated |
| OPTIONAL, -- Need M | |
| downlinkBWP-ToReleaseList | SEQUENCE (SIZE (1..maxNrofBWPs)) OF |
| BWP-Id | OPTIONAL, -- Need N |
| downlinkBWP-ToAddModList | SEQUENCE (SIZE (1..maxNrofBWPs)) OF |
| BWP-Downlink | OPTIONAL, -- Need N |
| firstActiveDownlinkBWP-Id | BWP-Id |
| OPTIONAL, -- Cond SyncAndCellAdd | |
| bwp-InactivityTimer | ENUMERATED {ms2, ms3, ms4, ms5, ms6, |
| ms8, ms10, ms20, ms30, | |
| | ms40,ms50, ms60, |
| ms80, ms100, ms200, ms300, ms500, | |
| | ms750, ms1280, ms1920, |
| ms2560, spare10, spare9, spare8, | |
| | spare7, spare6, spare5, |
| spare4, spare3, spare2, spare1 } | OPTIONAL, -- Need R |
| defaultDownlinkBWP-Id | BWP-Id |
| OPTIONAL, -- Need S | |
| uplinkConfig | UplinkConfig |
| OPTIONAL, -- Need M | |
| supplementaryUplink | UplinkConfig |
| OPTIONAL, -- Need M | |
| pdcch-ServingCellConfig | SetupRelease { PDCCH- |
| ServingCellConfig } | OPTIONAL, -- Need M |
| pdsch-ServingCellConfig | SetupRelease { PDSCH- |
| ServingCellConfig } | OPTIONAL, -- Need M |
| csi-MeasConfig | SetupRelease { CSI-MeasConfig } |
| OPTIONAL, -- Need M | |
| sCellDeactivationTimer | ENUMERATED {ms20, ms40, ms80, ms160, |
| ms200, ms240, | |
| | ms320, ms400, ms480, |
| ms520, ms640, ms720, | |
| | ms840, ms1280, |
| spare2,spare1} OPTIONAL, - | |
| ... | |

### 6.3.4 Other Information Elements

. . .

### OtherConfig

The IE OtherConfig contains configuration related to miscellaneous other configurations.

OtherConfig information element

| -- ASN1START | |
|---|---|
| -- TAG-OTHERCONFIG-START | |
| OtherConfig ::= | SEQUENCE { |
| delayBudgetReportingConfig | CHOICE{ |
| release | NULL, |
| setup | SEQUENCE{ |
| delayBudgetReportingProhibitTimer ENUMERATED {s0, s0dot4, | |
| s0dot8, s1dot6, s3, s6, s12, s30} | |
| } | |
| } | |
| OPTIONAL -- Need M | |
| } | |
| ... | |

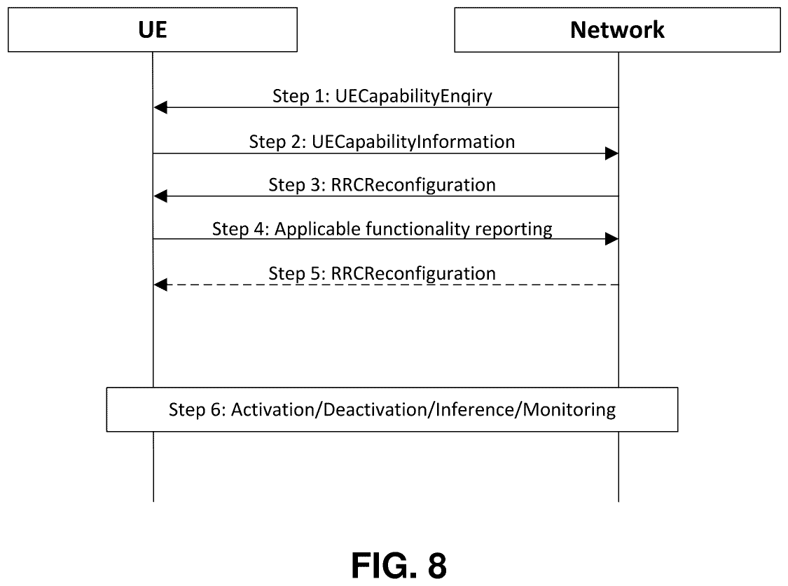

In Report for RAN2 #127bis, a procedure for the reporting of applicable functionalities has been agreed to. Notably, a figure of Report for RAN2 #127bis showing an exemplary scenario associated with applicable functionality reporting is reproduced herein as FIG. 8. One or more parts of Report for RAN2 #127bis are quoted below:

### 8.1.2.2 LCM for UE-Sided Model for Beam Management Use Case

. . .

Agreements on definitions

| | |
|---|---|
| 1. | Supported functionalities refer to functionalities that UE can indicate by using UE capability |
| | information (via RRC/LPP signalling) |
| 2. | Applicable functionalities refers to functionalities that the UE is ready to apply for inference |
| 3. | Activated functionalities refers to functionalities already enabled for performing inference |

Agreements on procedures

| | |
|---|---|
| - | Step 1: Network sends UECapabilityEnqiry message to initiate the procedure to a UE reporting its |
| | AI/ML supported functionalities. |
| - | Step 2: UE sends UECapablityInformation message to network, containing supported |
| | functionalities at the UE side. |
| - | “Step 3”: Following configurations are provided from NW to UE: |
| | 1) UE is allowed to do UAI reporting via OtherConfig. |
| | 2) Network may provide NW-side additional condition. FFS on the RRC signalling and whether it is |

mandatory or optional.

3) FFS on configuration (e.g. inference configuration) of supported functionalities. FFS on the

content of configuration.

| | |
|---|---|
| - | UE decides the applicable functionalities based on NW-side additional conditions (if provided), UE- |
| | side additional conditions (internally known by UE) and model availability in device. FFS whether |
| | other configuration can considered by UE (e.g. inference configuration). FFS how the applicable |
| | functionality is decided if NW-side additional condition is not provided in step 3. |
| - | “Step 4”: UE reports applicable functionality in the following scenarios: |
| | 1) Upon being configured to provide applicable functionality and upon change of applicable |

functionality via UAI

2) As response to NW-side additional condition requesting applicable functionality reporting in step

3, FFS other network configuration (e.g. inference configuration), FFS via UAI or
RRCReconfigurationComplete, etc

| | |
|---|---|
| - | Step 5: |
| | 1) Network configures inference configuration to UE after applicable functionality reporting, if |

inference configuration based on supported functionality is not provided in Step 3 (i.e.
inference configuration is provided in Step 5).

2) If inference configuration based on supported functionality is provided in Step 3, it is up to

network implementation whether to provide an updated configuration or not.

| | |
|---|---|
| - | The applicable functionality may be activated by receiving its inference configuration when it is |
| | provided in Step 5. FFS the initial activation state. FFS on initial state of applicable functionality if |
| | inference configuration of supported functionality is provided in Step 3. FFS on additional L1/L2 |
| | signaling for activation/deactivation. FFS if multiple applicable functionalities can be activated at |
| | the same time. FFS what is the granularity of functionality |
| - | We will write an LS to RAN1 to provide our agreements and ask specific questions that RAN2 |
| | needs to enable progress. |

In Report for RAN1 #119, some agreements on the Lifecycle Management (LCM) for beam management have been made. One or more parts of Report for RAN1 #119 are quoted below:

### R1-2410737 FL Summary #4 for AI/ML in Beam Management Moderator (Samsung)

### From Friday Session

### Conclusion

For the CSI-ReportConfig for inference configuration provided in Step 5,
aperiodic CSI Report and semi-persistent CSI report can be activated/triggered by NW after RRCReconfigurationComplete.
periodic CSI Report is considered as activated after RRCReconfigurationComplete.
Note: UE is not expected to be configured with a CSI-ReportConfig for inference configuration for a non-applicable set of inference parameters or a non-applicable CSI-ReportConfig
   Any specification impact is a separate discussion

### Agreement

Send LS to RAN2 with below information.

RAN1 thanks RAN2 for the LS on applicable functionality reporting for beam management UE-sided model.

In RAN1's discussion of RAN 2 terminologies on beam management,
The concept/terminology “functionality” of Supported functionalities may refer to UE-capability information/parameters i.e., Rel-19 AI/ML-enabled Features/FGs
The concept/terminology “functionality” of Applicable functionalities may refer to CSI-ReportConfig for inference configuration or a set of inference related parameters
The Activated functionalities may be enabled based on CSI framework.

Therefore, the meaning and the granularity of “functionality” for Applicable functionalities, Activated functionalities and Supported functionalities may or may not be the same.

RAN 1 made the following agreements related to the Questions from RAN 2:

Agreement

| | |
|---|---|
| • | In Step 3, following configurations are provided from NW to UE: |

| | |
|---|---|
| ∘ | UE is allowed to do UAI reporting via OtherConfig, |
| ∘ | The applicability report is based on A) and/or B) |

| | |
|---|---|
| □ | It is up to RAN 2 to design the container |
| □ | A) one or more of CSI-ReportConfig for inference configuration (wherein the |
| | associated ID may be configured in CSI framework as working assumption |
| | applied) |

| | |
|---|---|
| □ | Note: CSI report configuration for UE-side model inference can't be |
| | activated immediately upon receiving Step 3 |

| | |
|---|---|
| □ | B) One set or multiple sets of inference related parameters for applicability |
| | report only (not for inference) |

| | |
|---|---|
| □ | It is up to RAN2 to design the container. |
| □ | The set of inference related parameters selected from the IEs in/or the |
| | IEs referred by CSI-ReportConfig as a starting point, e.g., |

| | |
|---|---|
| ∘ | the associated ID |

| | |
|---|---|
| □ | Note: this doesn't imply the associated ID is |
| | mandatory |

| | |
|---|---|
| ∘ | Set A related information |
| ∘ | Set B related information |
| ∘ | Report content related information |
| ∘ | For BM-Case 2, |

| | |
|---|---|
| □ | Time instances related information for measurements |
| □ | Time instances related information for prediction |

| | |
|---|---|
| • | In Step 4, UE reports applicability for all the above A) one or more CSI-ReportConfig and/or B) |
| | set(s) of inference related parameters |

| | |
|---|---|
| ∘ | FFS on whether/what other information along with the applicability is needed |
| ∘ | If A) is configured in Step 3, |

| | |
|---|---|
| □ | Applicable aperiodic CSI Report and semi-persistent CSI report can be |
| | activated/triggered by NW after the applicability reported. |
| □ | Applicable periodic CSI Report is considered as activated only if the |
| | applicability of the corresponding CSI-ReportConfig is reported |
| | in RRCReconfigurationComplete. |

| | |
|---|---|
| • | In Step 5, NW can optionally configure CSI-ReportConfig for inference configuration |
| | in RRCReconfiguration, where the associated ID may be configured in CSI framework as working |
| | assumption applied. |

| | |
|---|---|
| ∘ | Note: Step 5 may be optional if UE has already been configured with CSI-ReportConfig |
| | in Step 3 |

Agreement
For beam management, multiple CSI reports for inference for UE-side model can be
configured/activated/triggered, which is up to UE capability.
Conclusion
For the CSI-ReportConfig for inference configuration provided in Step 5,

| | |
|---|---|
| □ | aperiodic CSI Report and semi-persistent CSI report can be activated/triggered by NW after |
| | RRCReconfigurationComplete. |
| □ | periodic CSI Report is considered as activated after RRCReconfigurationComplete. |
| □ | Note: UE is not expected to be configured with a CSI-ReportConfig for inference configuration |
| | for a non-applicable set of inference parameters or a non-applicable CSI-ReportConfig |

| | |
|---|---|
| ∘ | Any specification impact is a separate discussion |

Artificial Intelligence (AI)/Machine Learning (ML) is introduced in 5th generation (5G)-Advanced to enhance the network.

For the challenging scenarios of high frequencies, rapidly changing conditions and narrow coverages of beams, AI/ML models are introduced in 5G-Advanced to pave the way into 6G, with expectations of AI/ML models exceeding traditional methods in terms of performance.

For the air interface, 3rd Generation Partnership Project (3GPP) Working Group 1 (WG1) identified the following use cases to enhance: Channel State Information (CSI) feedback enhancement, beam management and positioning accuracy enhancement. Beam management is one of the most important use cases. The current beam management procedure comprises the following steps: (1) Beam sweeping, (2) User Equipment (UE) measurement of beams, (3) UE reporting of beams. For example, the next-generation Node B (gNB) first transmits multiple beams of different directions and angles. The UE then measures all the beams that are transmitted and determines the beams with the best measurement results (e.g., Reference Signal Received Power (RSRP) or Signal to Interference plus Noise Ratio (SINR)). The best results are reported through the CSI-Reporting framework. The UE may be configured and/or activated to perform periodic, semi-persistent or aperiodic reporting of the beam results. The configuration and measurement for beams can be large. With AI/ML assistance, the UE may spatially predict beams to reduce the number of measurements performed. The UE may also temporally predict future beams for the challenging problem of fast changing conditions to make beam pair establishment more feasible in the Frequency Range 2 (FR2) scenarios.

For mobility, several aspects of the Layer 3 (L3) measurement framework also have enhancement potential. The current L3 handover mechanism relies on tailored measurement configuration which utilizes measurement objects, report configurations and measurement identities to configure the frequencies and cells for the UE to measure. The UE first measures the configured frequencies and cells, then reports the measurement results to the Network (NW), when the measurement results fulfill the report triggering conditions. The NW may reconfigure the UE to perform handover according to the triggered event type and the measurement results. The mechanism works well but is still limited to a reactive method. With the lower coverage of higher frequency, handover may occur more frequently and thus a more proactive method may be pursued. Currently, for AI/ML mobility enhancements, Radio Resource Management (RRM) measurement prediction, Radio Link Failure (RLF)/Handover Failure (HoF) prediction and measurement event prediction are studied. For RRM measurement prediction, the UE may predict measurement results of future time instances or measurement results of another cell based on historical measurements and include the predicted measurements in a measurement report. For RLF/HOF prediction, the UE may predict the chances of RLF/HOF happening within a time window (or period) before RLF/HoF actually happens. For measurement event prediction, the UE may predict the chances of a measurement event (e.g., Event A3) happening (or triggering a report, fulfilling the entering and/or leaving condition) within a time window (or period), and send a measurement report to the NW. With the assistance of AI/ML models, the UE may proactively react to potential radio problems and enhance the handover performance. Redundant measurements may also be reduced to save resources (e.g., measurement gaps, UE power).

The general framework for AI/ML procedure has been agreed in Report for RAN2 #127bis and/or Report for RAN1 #119. The procedure comprises at least one or more of the following steps: In the first 2 steps, the NW inquires and receives the UE capability. In step 3, the NW may provide one or more inference configurations (e.g., CSI report configuration for inference). In step 3, the NW may provide one set or multiple sets of inference related parameters. In step 4, the UE may report whether the provided configuration(s) and/or set(s) of inference related parameters is applicable to the NW. The NW may reconfigure the UE in step 5 in response to step 4.

In the study of AI/ML for beam management, multiple use cases and variants are identified. For example, an inference configuration may be used for spatial and/or temporal prediction. For example, the prediction of a set of beams may be based on various number of beams and/or beam pattern. These multiple use cases contribute to a large number of combinations, leading to excessive potential configurations and/or sets of inference related parameters signalled to the UE, while often times most configurations may not be needed.

For example, the NW may be willing to configure the UE for reporting a (specific) set of beams. In release 18, this can be achieved by a legacy CSI report configuration (e.g., CSI report configuration before release 19). With the introduction of AI/ML, there may be multiple variants of inference configuration (e.g., CSI report configuration for inference) that can serve this purpose (e.g., inference configuration(s) for predicting the set of beams based on different number of beams and/or different beam patterns). Each variant may be associated with one or more inference configurations (e.g., signalled in step 3). Each variant may be associated with one set or multiple sets of inference related parameters (e.g., signalled in step 3). Eventually, there may be only one variant configured and/or applied.

Furthermore, multiple AI/ML features/functionalities may be supported by the UE. For example, the AI/ML features/functionalities may comprise AI/ML for beam management and/or AI/ML for mobility. This creates multiple potential configurations across different uses cases and AI/ML feature/functionalities. With more AI/ML features/functionalities introduced, the management and signalling can become complex to handle.

To at least solve the issue(s) described above, at least some method(s) described below could be used or considered. At least one or more of the methods (or examples, concepts) described below may be used or considered. At least one or more of the methods (or examples, concepts) may be combined.

In the following, a “legacy configuration” may be (replaced by) a “configuration before release 19”, “configuration without AI/ML enhancements”, and/or “configuration without release 19 (AI/ML) enhancements”. An “inference configuration” may be (replaced by) a “configuration for inference” or “configuration related to AI/ML” or “(inference) configuration”. A “functionality” may be (replaced by) a “inference configuration”, “set of inference related parameters” and/or “group”. A functionality may be a feature (e.g., beam prediction, CSI prediction, CSI compression, AI mobility), a use case (e.g., temporal, spatial), and/or a variant (e.g., 4 beam to 8 beam prediction, 8 beam to 16 beam prediction). A “configuration” may be (replaced by) a “legacy configuration” and/or “inference configuration”. The (inference) configuration(s) may be for CSI reporting (e.g., CSI-ReportConfig). The (inference) configuration(s) may be for mobility (e.g., measId, measObject, and/or reportConfig).

In the following, a “set of parameters” may be a “set of inference related parameters”. The set(s) of parameters may be for CSI reporting based on AI/ML.

A UE may receive a first configuration related to AI/ML (e.g., in Radio Resource Control (RRC) reconfiguration, as step 3 of the AI/ML procedure) from NW. The configuration may be provided in step 3 of the AI/ML procedure. The configuration may be (or comprise) a configuration for inference. The configuration may be (or comprise) a configuration for applicability report (e.g., step 4 of the AI/ML procedure). The UE may perform the applicability report (e.g., step 4 of the AI/ML procedure) based on the configuration.

For example, in the first configuration, the NW may provide one or more (inference) configurations and/or one set or multiple sets of inference related parameters to the UE.

For example, inference related parameters may comprise at least one or more of the following: an associated Identifier (ID), a CSI resource config ID for measurement, a CSI resource config ID for prediction, information related to reporting (e.g., report quantity, PUCCH resource, etc.), time related information for measurements (e.g., (maximum) measurement window (in slots, ms, time, duration, etc.), (maximum) number of instances to measure, offset(s) for measurement(s) and/or measurement window(s)), time related information for prediction (e.g., (maximum) prediction window (in slots, ms, time, duration, etc.), (maximum) number of instances to predict, offset(s) for prediction(s) and/or prediction window(s)), information for BM-Case 1, information for Beam Management (BM)-Case 2, relation between the beams for measurement (e.g., number of beams to measure, number of beams to predict, etc.), etc.

For example, inference related parameters may be included in one or more (inference) configurations.

For example, inference related parameters may be included in a report to the NW (e.g., report of applicable functionalities and/or non-applicable functionalities)

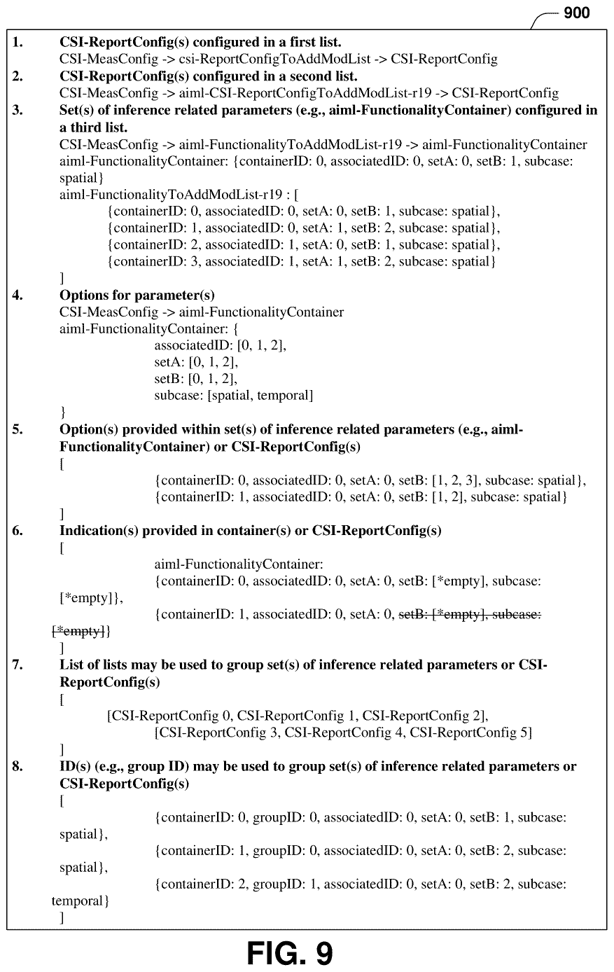

FIG. 9 illustrates an example representation 900 of the first configuration (received from the NW in step 3 of the AI/ML procedure, for example), in accordance with some embodiments. For example, in the first configuration, the NW may provide (inference) configuration(s) in a first list. The first list may be for legacy configurations and (inference) configurations (e.g., csi-ReportConfig ToAddModList). In the example representation 900 of the first configuration, the first list may be provided following “1. CSI-ReportConfig(s) configured in a first list.”

For example, in the first configuration, the NW may provide (inference) configuration(s) in a second list. The second list may be for (inference) configurations. For example, the (inference) configuration(s) may be identified by an ID (e.g., functionality ID). In the example representation 900 of the first configuration, the second list may be provided following “2. CSI-ReportConfig(s) configured in a second list.”

For example, in the first configuration, the NW may provide set(s) of inference related parameters in a third list. The third list may be (and/or comprise) sets of inference related parameters. For example, each set of inference related parameters may be encapsulated in a container (e.g., a new Information Element (IE)). For example, the container may comprise multiple parameters. For example, the container may comprise multiple fields, wherein each field may be associated with a parameter. For example, the container may be identified by an ID (e.g., container ID). The ID may be apart from CSI-ReportConfigId, associated ID and/or model ID. In the example representation 900 of the first configuration, the third list may be provided following “3. Set(s) of inference related parameters (e.g., aiml-FunctionalityContainer) configured in a third list.”

For example, in the first configuration, the NW may provide options for one or more inference related parameters. In the example representation 900 of the first configuration, the options may be provided following “4. Options for parameter(s)”. For example, in an (inference) configuration, the NW may provide one or more options for one or more parameters, in one or more fields (e.g., in a list). For example, in a set of inference related parameters, the NW may provide one or more options for one or more parameters, in one or more fields (e.g., in a list). In the example representation 900 of the first configuration, the one or more options may be provided following “5. Option(s) provided within set(s) of inference related parameters (e.g., aiml-FunctionalityContainer) or CSI-ReportConfig(s)”. For example, in a set of inference related parameters, the NW may provide one or more options for all parameters, in all fields (e.g., in a list). For example, the UE may apply (and/or report) a configuration and/or set of inference related parameters (being applicable and/or non-applicable) based on the provided options. For example, the UE may select one or more options to apply and/or report.

For example, in the first configuration, the NW may not provide (or provide no options for) one or more inference related parameters. For example, in an (inference) configuration, the NW may indicate (e.g., implicitly indicate) one or more parameters not specified by the NW. For example, the NW may indicate the one or more parameters by not providing one or more fields and/or one or more parameters. For example, the NW may indicate the one or more parameters by providing no options for one or more fields and/or one or more parameters (e.g., provide an empty list). In the example representation 900 of the first configuration, indication fields that are empty to indicate (e.g., implicitly indicate) one or more parameters are provided following “6. Indication(s) provided in container(s) or CSI-ReportConfig(s)”. For example, in a set of inference related parameters, the NW may indicate (e.g., implicitly indicate) one or more parameters not specified by the NW. For example, the NW may indicate the one or more parameters by not providing one or more fields and/or one or more parameters. For example, the NW may indicate by providing no options for one or more fields and/or one or more parameters (e.g., provide an empty list). For example, the UE may apply (and/or report) a configuration and/or set of inference related parameters (being applicable and/or non-applicable) based on the UE internal conditions (e.g., AI/ML model capability, power level, memory usage, computational resource, etc.). For example, the UE may apply and/or report its preferred value for a field and/or parameter not provided or indicated to be not specified by the NW.

For example, in the first configuration, the NW may group one or more configurations and/or one or more sets of inference related parameters. In some examples, the NW may group one or more configurations and/or one or more sets of inference related parameters using one or more nested lists. In the example representation 900 of the first configuration, one or more lists (e.g., nested lists) of groups of sets of inference related parameters and/or CSI-ReportConfigs are provided following “7. List of lists may be used to group set(s) of inference related parameters or CSI-ReportConfig(s)”. For example, an ID (e.g., group ID) may be included in an inference configuration and/or in a set of inference related parameters. Configuration(s) and/or set(s) of inference related parameters with the same group ID may be considered grouped together. In the example representation 900 of the first configuration, group IDs 0 and 1 grouping configurations and/or sets of inference related parameters are provided following “8. ID(s) (e.g., group ID) may be used to group set(s) of inference related parameters or CSI-ReportConfig(s)”. For example, an IE (e.g., a list) may comprise one or more configurations and/or one or more sets of inference related parameters. The NW may provide one or more of the IEs to the UE. The one or more configurations and/or one or more sets of inference related parameters within the same IE may be considered grouped together. For example, the UE may apply (and/or report) a configuration and/or set of inference related parameters (being applicable and/or non-applicable) based on the grouping of configuration(s) and/or set(s) of inference related parameters. For example, the UE may select one or more inference configurations and/or one or more sets of inference related parameters to apply and/or report for each group.

For example, in the first configuration, the NW may indicate whether one or more configurations may be activated/triggered. For example, a field (or an indication) may be included in one or more configurations and/or groups to indicate whether the configuration(s) and/or configuration(s) within the group(s) is activated/triggered, can be activated/triggered and/or may be activated/triggered. For example, the configuration(s) and/or configuration(s) within the group(s) may be activated/triggered after the report of applicable and/or non-applicable functionalities (for the configuration(s) and/or group(s)) (e.g., by the NW and/or UE). For example, a field (or an indication) may be included in one or more configurations and/or groups to indicate whether the configuration(s) and/or configuration(s) within the group(s) are not activated/triggered, can not be activated/triggered and/or may not be activated/triggered.

For example, for each configuration, set of parameters and/or group, a priority may be indicated (e.g., by the NW). The priority may apply within a group, field, parameter and/or throughout all configurations and/or sets of parameters. For example, a field (or an indication) may be included in a configuration, set of parameters and/or group to indicate the priority of the configuration, set of parameters and/or group. A lower value of the field may indicate a higher priority. For example, within a list of configurations, sets of parameters and/or groups, the entry with lower index may have higher priority. For example, the configuration, set of parameters and/or group identified by an ID with a lower number may have higher priority. For example, the UE may apply (and/or report) a configuration and/or set of inference related parameters (being applicable and/or non-applicable) based on the priority of group(s), field(s), parameter(s), option(s), configuration(s) and/or set(s) of inference related parameters. For example, the UE may select the one or more inference configurations and/or one or more sets of inference related parameters with higher priority to apply and/or report. For example, the UE may select the one or more fields, parameters and/or options with higher priority to apply and/or report.

The UE may perform/transmit/initiate an applicability report (for AI/ML) to NW (e.g., as step 4 of the AI/ML procedure, after (or in response to) receiving the configuration mentioned above). In step 4, the UE may report the applicable and/or non-applicable functionalities to the NW (e.g., by transmitting an applicability report). The report may be based on the provided one or more inference configurations and/or one set or multiple sets of inference related parameters in step 3. In the following, a functionality may be an inference configuration, set of inference related parameters and/or group.

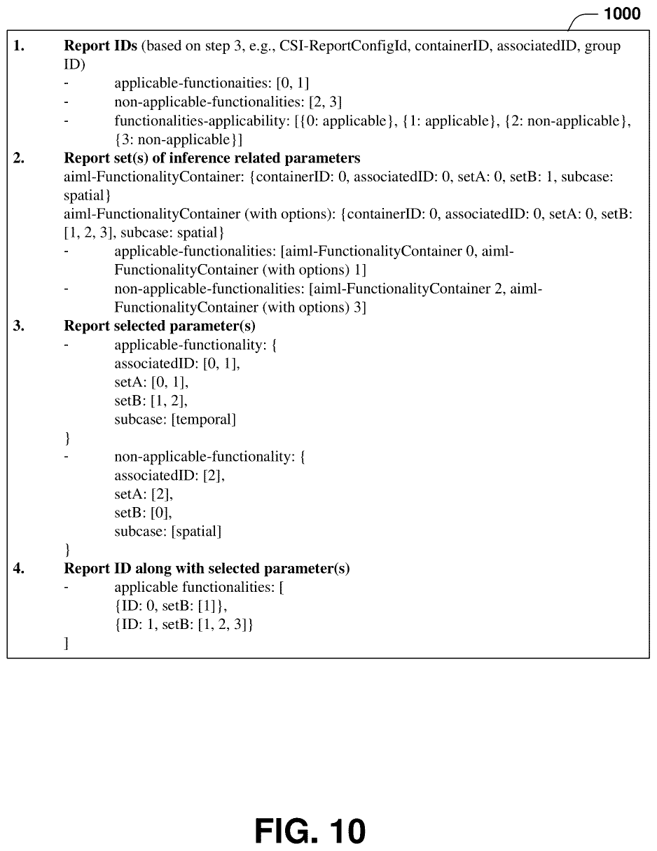

FIG. 10 illustrates an example representation 1000 of the applicability report (provided by the UE to the NW to indicate applicable functionalities and/or non-applicable functionalities, for example), in accordance with some embodiments. In some examples, a first section of the example representation 1000 of the applicability report (following “1. Report IDs (based on step 3, e.g., CSI-ReportConfigId, container ID, associated ID, group ID) may report applicability using IDs (e.g., applicability reporting is performed per ID). For example, functionalities associated with ID 0 and ID 1 may be indicated as being applicable functionalities, and/or functionalities associated with ID 2 and ID 3 may be indicated as being non-applicable functionalities. In some examples, a second section of the example representation 1000 of the applicability report (following “2. Report set(s) of inference-related parameters”) reports applicability with respect to one or more inference-related parameter sets (e.g., instances of an aiml-FunctionalityContainer). For example, functionalities associated with aiml-FunctionalityContainer 0 and aiml-FunctionalityContainer (with options) 1 may be indicated as being applicable functionalities, and/or functionalities associated with aiml-FunctionalityContainer 2 and aiml-FunctionalityContainer (with options) 3 may be indicated as being non-applicable functionalities. In some examples, a third section of the example representation 1000 of the applicability report (following “3. Report selected parameter(s)”) may report applicability for one or more selected parameters associated with a functionality. For example, a functionality having selected parameters such as {associatedID: [0,1], setA: [0,1], setB: [1,2], subcase: [temporal]} may be indicated as being an applicable functionality, and/or a functionality having selected parameters such as {associatedID: [2], setA: [2], setB: [0], subcase: [spatial]} may be indicated as being a non-applicable functionality. In some examples, a fourth section of the example representation 1000 of the applicability report (following “4. Report ID along with selected parameter(s)”) may allow applicability to be reported for a combination of an ID and one or more selected parameters. For example, an entry such as {ID: 0, setB: [1]} and an entry such as {ID: 1, setB: [1, 2, 3]} may each be indicated as being applicable functionalities.

For example, the UE may report the applicable and/or non-applicable functionalities to the NW based on ID(s) (e.g., CSI-ReportConfigId, associated ID, functionality ID, container ID, group ID). For example, the UE may indicate whether the functionality associated with an ID is applicable or non-applicable. For example, one or more flags (or indications/parameters) may be included (e.g., within a single list) in the report. A flag (or indication/parameter) may be associated with an ID. When (or in response to) a functionality is (or being) applicable, the associated flag (or indication/parameter) may be set to a first value (e.g., true). When (or in response to) a functionality is (or being) non-applicable, the associated flag (or indication/parameter) may be set to a second value (e.g., false). The flag (or indication/parameter) may be (the existence of) an IE, number, integer, enum, bit string or Boolean value. For example, the UE may include one or more IDs in a first report. Each ID may be associated with a functionality. More than one types of functionalities may be included in the applicability report (e.g., the applicability report may comprise the first report). The functionalities associated with the ID(s) included in the first report may be the applicable functionalities. For example, the UE may include one or more IDs in a second report (and/or the first report). Each ID may be associated with a functionality. More than one types of functionalities may be included in the applicability report (e.g., the applicability report may comprise the second report). The functionalities associated with the ID(s) included in the second report may be the non-applicable functionalities. The applicability report may comprise the first report and/or the second report. The first report may be indicative of one or more applicable functionalities and/or the second report may be indicative of one or more non-applicable functionalities. For example, the first and second report may be included in one same message and/or IE to the NW. For example, the first and second report may be included in different messages and/or IE to the NW. For example, more than one types of ID may be included in the report (e.g., each ID may correspond to one of one or more types of ID). The types of ID may comprise: CSI-ReportConfigId, associated ID, functionality ID, container ID, and/or group ID. For example, a functionality ID may indicate and/or be associated with an inference configuration for a functionality. For example, a container ID may indicate and/or be associated with a set of inference related parameters for a functionality.

For example, the UE may report the applicable and/or non-applicable functionalities to the NW based on inference configuration(s) and/or set(s) of inference related parameters. For example, ID(s) (e.g., container ID, functionality ID, associated ID) may be included in the report (e.g., within a single list). Each ID may be associated with a functionality. The ID(s) may or may not be (based on) the ID(s), configuration(s) and/or set(s) of inference related parameters provided by the NW. For example, the UE may indicate whether a functionality is applicable (or non-applicable). For example, one or more flags/indications/parameters may be included in the report. A flag/indication/parameter may be associated with a functionality. When (or in response to) a functionality is (or being) applicable, the associated flag/indication/parameter may be set to a first value (e.g., true). When (or in response to) a functionality is (or being) non-applicable, the associated flag/indication/parameter may be set to a second value (e.g., false). The flag/indication/parameter may be (the existence of) an IE, number, integer, enum, bit string or Boolean value. For example, the UE may indicate one or more inference configurations and/or one or more sets of inference related parameters in a third report. The inference configurations and/or sets of inference related parameters included in the third report may be (or comprise) the applicable functionalities. For example, the UE may indicate one or more inference configurations and/or one or more sets of inference related parameters in a fourth report (and/or the third report). The inference configurations and/or sets of inference related parameters included in the fourth report (and/or the third report) may be (or comprise) the non-applicable functionalities. For example, the third and fourth report may be included in one same message and/or IE to the NW. For example, the third and fourth report may be included in different messages and/or IE to the NW.

For example, the UE may report one or more (selected options for) inference related parameters. The UE may report the applicable and/or non-applicable functionalities to the NW (e.g., based on ID(s) or not based on ID(s)), along with one or more (selected options for) inference related parameters (for one or more fields and/or parameters). For example, one or more (selected) inference related parameters may be included in the report. One or more inference related parameters may be associated with an ID and/or functionality. For example, the (selected) inference related parameter(s) included may be the same set or a subset of the parameter(s) provided by the NW (in a previous message, e.g., step 3). For example, the (selected) inference related parameter(s) included may be one or more of the options of a functionality provided by the NW (in a previous message, e.g., step 3). The included inference related parameter(s) may be the value(s) of the option(s) and/or the ind(ices) of the option(s). For example, the (selected) inference related parameter(s) included may not be included in the parameter(s) and/or option(s) provided by the NW. For example, the (selected) inference related parameter(s) included may indicate the UE is applicable or non-applicable of a functionality, when (or in response to) a functionality is configured and/or applied based on the included parameter(s). For example, no (selected) inference related parameter(s) may be included when (or in response to) no options are selected, provided and/or the UE is applicable of all options provided. For example, the UE may include one or more (selected) inference related parameters and/or one or more ID(s) (e.g., CSI-ReportConfigId, functionality ID, associated ID, container ID, group ID) in a fifth report. The parameter(s) included in the fifth report may indicate the UE is applicable of a functionality, when (or in response to) a functionality is configured and/or applied based on the included parameter(s). For example, the UE may include one or more (selected) inference related parameters and/or one or more ID(s) (e.g., CSI-ReportConfigId, functionality ID, associated ID, container ID, group ID) in a sixth report (and/or the fifth report). The parameter(s) included in the sixth report (and/or the fifth report) may indicate the UE is non-applicable of a functionality, when (or in response to) a functionality is configured and/or applied based on the included parameter(s). For example, the fifth and sixth report may be included in one same message and/or IE to the NW. For example, the fifth and sixth report may be included in different messages and/or IE to the NW.

For example, for each report, preferences may be indicated (e.g., to the NW). The UE may indicate the preferences of functionalities, parameters and/or options. For example, one or more fields may be included. A field may be associated with an ID, functionality, set of parameters and/or option. A lower value of the field may indicate a higher preference of the functionality, parameter and/or option. For example, within a list of ID(s), functionalit(ies), parameter(s) and/or option(s), the entry with lower index may be more preferred by the UE. For example, the functionality identified by an ID with a lower number may be more preferred by the UE.

The UE may receive a (second) configuration related to AI/ML (e.g., in RRC reconfiguration, as step 5 of the AI/ML procedure) from NW. The configuration may be provided in step 5 of the AI/ML procedure. The configuration may be (or comprise) a configuration for inference. The configuration may be provided after the UE transmits the applicability report (e.g., step 4 of the AI/ML procedure). The second configuration (e.g., provided in step 5) may be different from the first configuration (e.g., provided in step 3). In step 5, the NW may provide inference configurations to the UE.

For example, in the (second) configuration, the NW may (re) configure the UE when (or in response to) receiving the report of applicable and/or non-applicable functionalities. For example, the NW may provide and/or configure (inference) configuration(s) in the first list and/or the second list.

For example, the NW may activate/trigger one or more configurations when (or in response to) receiving the report of applicable and/or non-applicable functionalities. For example, the NW may send L1/L2/L3 signalling (e.g., RRC message, Medium Access Control (MAC) Control Element (CE), Downlink Control Information (DCI)) to the UE for the activation/triggering. For example, the signalling may be to activate/trigger one or more configurations until the NW acknowledges the one or more functionalities (e.g., configurations) are applicable. For example, the NW may send L1/L2/L3 signalling (e.g., RRC message, MAC CE, DCI) to the UE for the deactivation.

For example, in the (second) configuration, the NW may provide one or more (inference) configurations complement to one or more sets of parameters. For example, an ID associated with a set of parameters (e.g., container ID) may be included in the (inference) configuration(s). The (inference) configuration(s) may be associated with the set(s) of inference related parameters. For example, the (inference) configuration(s) may comprise content that is not in the set(s) of inference related parameters associated with the (inference) configuration(s) (e.g., provided in step 3 and/or included in step 4). The (inference) configuration(s) may not comprise content that is in the set(s) of inference related parameters associated with the (inference) configuration(s) (e.g., provided in step 3 and/or included in step 4). For example, the UE may apply the configuration based on the (inference) configuration and the set of inference related parameters associated with the (inference) configuration. For example, the UE may apply the field(s) and/or parameter(s) in the (inference) configuration. The UE may apply the field(s) and/or parameter(s) from the set of inference related parameters associated with the (inference) configuration when indicated (or in response to an indication) by the NW. For example, one or more fields and/or parameters may be left empty and/or not provided by the NW (for indication). For example, one or more fields and/or parameters may be set to a value (for indication).

The steps 3, 4 and/or 5 may not be required to be in sequence. The steps 3, 4 and/or 5 may not imply steps 1 and/or 2 must exist. The steps 3, 4, and/or 5 may not imply the previous step must exist. The steps 3, 4 and/or 5 may not imply there is no other signalling in between.

In some examples, the UE may receive one or more inference configurations (related to AI/ML), e.g., in step 3. Afterward, the UE may report the applicable and/or non-applicable functionalit (ies) (related to AI/ML), e.g., in step 4. For example, the inference configuration(s) may be provided in the first list. For example, the inference configuration(s) may be provided in the second list. For example, the UE may report the applicable and/or non-applicable functionalities based on ID(s).

Before the UE performs the (initial) applicability report (e.g., step 4), the UE may consider the configuration related to AI/ML (e.g., provided in step 3) as not activated/triggered. The UE may consider the configuration related to AI/ML (e.g., provided in step 3) as not activated/triggered upon receiving the configuration (e.g., step 3). The UE may evaluate the applicability for an inference configuration (or a functionality) after receiving the configuration (e.g., step 3).

For the applicable functionalities, the inference configuration(s) may be activated/triggered after (and/or in response to) the UE reports the applicable and/or non-applicable functionalit (ies). The UE may report that the functionality or the inference configuration (e.g., to be activated/triggered) is (or becomes) applicable in the report. The inference configuration(s) may be activated/triggered upon the UE reporting that the inference configuration(s) and/or the corresponding functionalit (ies) is (or becomes) applicable. For example, the inference configuration(s) may be activated/triggered after (and/or in response to) the UE reports the applicable and/or non-applicable functionalities in RRCRecomfigurationComplete. For example, the inference configuration(s) may be activated/triggered after (and/or in response to) the UE reports the applicable and/or non-applicable functionalities in UAI. For example, the inference configuration(s) may be for periodic report(s), semi-persistent report(s) and/or aperiodic report(s). For example, the inference configuration(s) may not be activated/triggered until the functionality (e.g., configuration) becomes applicable. For example, the inference configuration(s) may not be activated/triggered until the UE reports the functionality (e.g., configuration) to be applicable. For example, the inference configuration(s) may not be activated/triggered until the UE receives lower layer Acknowledgment (ACK) for the report of applicable and/or non-applicable functionalities through UAI and/or RRCReconfigurationComplete (for the functionality (e.g., configuration)). For example, the UE may not consider a functionality to be applicable and/or non-applicable until the UE receives lower layer ACK for the report of applicable and/or non-applicable functionalities through UAI and/or RRCReconfigurationComplete.

For the non-applicable functionalities, the inference configuration(s) may not be activated/triggered, e.g., in response to the UE reports the applicable and/or non-applicable functionalit (ies). The UE may not report that the functionality or the inference configuration (e.g., remained not activated/triggered) is (or becomes) applicable in the report. The UE may report that the functionality or the inference configuration (e.g., remained not activated/triggered) is not applicable in the report. For example, the UE may keep the configuration. The UE may consider the configuration not activated and/or may not be activated/triggered by the NW. For example, the UE may keep the configuration. The UE may consider the configuration activated and/or may be activated/triggered by the NW. The UE may drop one or more reports (e.g., when the UE can not (or in response to the UE not able to) perform inference and/or produce report(s)). For example, the UE may not keep the configuration (e.g., from the first and/or second list). The UE may (autonomously) discard (or remove, or release) the configuration (e.g., from the first and/or second list).

A non-applicable functionality (e.g., configuration) kept and previously not considered activated and/or may not be activated/triggered by the NW may become applicable (e.g., after a report of applicable and/or non-applicable functionalities). For example, the UE may report the functionality (e.g., configuration) being applicable (e.g., through UAI), and consider the configuration activated and/or may be activated/triggered. For example, the UE may report the functionality (e.g., configuration) being applicable (e.g., through UAI), but consider the configuration not activated and/or may not be activated/triggered, unless the functionality (e.g., configuration) is reconfigured by the NW.

In some examples, the UE may receive a configuration related to AI/ML (e.g., in step 3, in RRC reconfiguration message). The UE may perform an applicability report (e.g., in step 4, after step 3, based on the configuration, in RRC reconfiguration complete message). The UE may determine whether to keep (or remove/release/discard, or apply) the configuration after (or in response to) transmitting the applicability report based on whether the configuration (or the functionality associated with the configuration) is applicable (or not). The UE may determine whether to keep (or remove/release/discard, or apply) the configuration after (or in response to) transmitting the applicability report based on whether the report indicates (explicitly or implicitly) that the configuration (or the functionality associated with the configuration) is applicable or not.

For example, if (at least) the UE indicates that a configuration (or a functionality) is applicable (e.g., in the applicability report, in step 4), the UE may keep and/or apply the configuration (e.g., after or in response to transmitting the report or step 4). If (at least) the UE indicates that a configuration (or a functionality) is not applicable (e.g., in the applicability report, in step 4), the UE may discard (or release, or remove) the configuration (e.g., after or in response to transmitting the report or step 4). If (at least) the UE does not indicate that a configuration (or a functionality) is applicable (e.g., in the applicability report, in step 4), the UE may discard (or release, or remove) the configuration (e.g., after or in response to transmitting the report or step 4). The applicability report may be included in a response message of the configuration (e.g., RRC reconfiguration complete message).

In some examples, the UE may receive a configuration related to AI/ML (e.g., in step 3, in RRC reconfiguration message). The UE may perform an applicability report (e.g., in step 4, after step 3, based on the configuration, in RRC reconfiguration complete message). The UE may keep the configuration (and/or may not discard/release/remove the configuration autonomously) after (or in response to) transmitting the applicability report (e.g., in RRC reconfiguration complete message). The UE may apply the configuration if (at least) the configuration (or the associated functionality) is applicable (and/or the reports indicates that the configuration or the associated functionality is applicable) after (or in response to) transmitting the applicability report (e.g., in RRC reconfiguration complete message). The UE may not apply the configuration if (at least) the configuration (or the associated functionality) is not applicable (and/or the report indicates that the configuration or the associated functionality is not applicable, and/or the report does not indicate that the configuration or the associated functionality is applicable) after (or in response to) transmitting the applicability report (e.g., in RRC reconfiguration complete message). The UE may store the configuration if (at least) the configuration (or the associated functionality) is not applicable (and/or the report indicates that the configuration or the associated functionality is not applicable, and/or the report does not indicate that the configuration or the associated functionality is applicable) after (or in response to) transmitting the applicability report (e.g., in RRC reconfiguration complete message). When the configuration (or the associated functionality) becomes applicable (e.g., from not applicable), the UE may perform applicability report (or initiate UE assistance information) to indicate that the configuration (or the associated functionality) is (or becomes) applicable. The UE may apply the configuration after (or in response to) transmitting the applicability report (e.g., in UE assistance information).

In some examples, the UE may receive one or more inference configurations (related to AI/ML), e.g., in step 3. The UE may report the applicable and/or non-applicable functionalit (ies) (related to AI/ML), e.g., in step 4, after step 3, based on the configuration(s). The NW may activate one or more of the configurations, e.g., in step 5, after step 4. The UE may activate one or more of the configurations indicated by the NW, e.g., in step 5, after step 4. For example, the inference configuration(s) may be provided in the first list. For example, the inference configuration(s) may be provided in the second list. For example, the UE may report the applicable and/or non-applicable functionalities based on ID(s). For example, the inference configuration(s) are not activated/triggered, can not be activated/triggered and/or may not be activated/triggered when (or in response to) being provided in step 3 and/or after the report of applicable and/or non-applicable functionalities in step 4. For example, the inference configuration(s) may be activated/triggered when the UE receives (or in response to receiving) a signalling in step 5.

In some examples, the UE may receive one or more inference configurations (related to AI/ML) in the second list, e.g., in step 3. The UE may report the applicable and/or non-applicable functionalit (ies) (related to AI/ML), e.g., in step 4, after step 3, based on the configuration(s). The NW may provide (to the UE) one or more inference configurations in the first list, e.g., in step 5, after step 4. For example, the UE may report the applicable and/or non-applicable functionalities based on ID(s). For example, the inference configuration(s) may be activated/triggered when (or in response to being) provided in the first list.

In some examples, the UE may receive one or more inference configurations and/or one or more sets of inference related parameters (related to AI/ML), e.g., in step 3. The UE may report the applicable and/or non-applicable functionalit (ies) based on inference configuration(s) and/or set(s) of inference related parameters (related to AI/ML), e.g., in step 4, after step 3. The NW may provide (to the UE) inference configuration(s) based on the reported applicable and/or non-applicable functionalities. For example, the inference configuration(s) may be provided in the first and/or second list. For example, the set(s) of inference related parameters may be provided in the third list. For example, one or more options may be provided for one or more fields and/or parameters in the inference configuration(s) and/or set(s) of inference related parameters. For example, one or more options may be provided for all fields and/or parameters in the inference configuration(s) and/or set(s) of inference related parameters. For example, one or more fields and/or parameters may be missing and/or not provided by the NW. For example, ID(s) (e.g., container ID, functionality ID, associated ID) may be included in the report. Each ID may be associated with a functionality. The ID(s) may or may not be (based on) the ID(s), configuration(s) and/or set(s) of inference related parameters provided by the NW. For example, the reported functionalit (ies) may be inference configuration(s) and/or set(s) of inference related parameters. For example, the reported functionalit (ies) may be inference configuration(s) and/or set(s) of inference related parameters, wherein one or more of the fields and/or parameters comprise (at least) one value (selected/provided to the UE). For example, the reported functionalit (ies) may be inference configuration(s) and/or set(s) of inference related parameters, wherein all of the fields and/or parameters comprise (at least) one value (selected/provided to the UE).

In some examples, the UE may receive one or more inference configurations and/or one or more sets of inference related parameters (related to AI/ML), e.g., in step 3. The UE may report the applicable and/or non-applicable functionalit (ies) (related to AI/ML), e.g., in step 4, after step 3. The NW may provide one or more inference configurations complement to one or more sets of parameters (related to AI/ML), e.g., in step 5, after step 4. For example, the inference configuration(s) in step 3 may be provided in the first and/or second list. For example, the set(s) of inference related parameters may be provided in the third list. For example, the UE may report the applicable and/or non-applicable functionalities based on ID(s). For example, the UE may report the applicable and/or non-applicable functionalities based on inference configuration(s) and/or set(s) of inference related parameters. For example, ID(s) (e.g., container ID, functionality ID, associated ID) may be included in the report. For example, one or more inference configurations in step 5 may be complement to one or more configurations and/or sets of inference related parameters in step 3. For example, the one or more inference configurations in step 5 may be complement to one or more configurations and/or sets of inference related parameters in step 4.

In some examples, the UE may receive one or more inference configurations and/or one or more sets of inference related parameters (related to AI/ML), e.g., in step 3. The UE may report the applicable and/or non-applicable functionalit (ies) along with one or more (selected options for) inference related parameters (for one or more fields and/or parameters) (related to AI/ML), e.g., in step 4, after step 3. The NW may provide (to the UE) inference configuration(s) based on the reported applicable and/or non-applicable functionalities. For example, the inference configuration(s) may be provided in the first and/or second list. For example, the set(s) of inference related parameters may be provided in the third list. For example, one or more options may be provided for one or more fields and/or parameters in the inference configuration(s) and/or set(s) of inference related parameters. For example, one or more options may be provided for all fields and/or parameters in the inference configuration(s) and/or set(s) of inference related parameters. For example, one or more fields and/or parameters may be missing and/or not provided by the NW. For example, the reported functionalit (ies) may be based on ID(s) associated with the functionalit (ies) (e.g., CSI-ReportConfigId, container ID, functionality ID, associated ID). For example, ID(s) (e.g., container ID, functionality ID, associated ID) may be included in the report. Each ID may be associated with a functionality. The ID(s) may or may not be (based on) the ID(s), configuration(s) and/or set(s) of inference related parameters provided by the NW. For example, the reported functionalit (ies) may be inference configuration(s) and/or set(s) of inference related parameters. For example, the reported functionalit (ies) may be inference configuration(s) and/or set(s) of inference related parameters, wherein one or more of the fields and/or parameters comprise (at least) one value (selected/provided to the UE). For example, the reported functionalit (ies) may be inference configuration(s) and/or set(s) of inference related parameters, wherein all of the fields and/or parameters comprise (at least) one value (selected/provided to the UE). For example, the reported functionalit (ies) may be inference configuration(s) and/or set(s) of inference related parameters, wherein one or more of the fields and/or parameters comprise one or more options (selected/provided to the UE). For example, the reported functionalit (ies) may be inference configuration(s) and/or set(s) of inference related parameters, wherein all of the fields and/or parameters comprise one or more options (selected/provided to the UE). For example, the reported option(s)/value(s) may or may not be based on the provided options (e.g., in step 3). The UE may report option(s)/value(s) for one or more fields and/or parameters which NW did not provide (with options).

In some examples, one or more configurations may be grouped together. For example, a group may comprise one or more inference configurations. For example, a group may comprise one or more inference configurations and/or legacy configurations. For example, at least one of the configurations within a group may be activated/triggered (e.g., after the UE reports the applicable and/or non-applicable functionalities). For example, at least one of the configurations within a group may be reported to be applicable. The configurations that may be activated/triggered may not comprise the configurations reported to be applicable and/or non-applicable. The configurations that may not be activated/triggered may be reported to be applicable. One or more configurations within a group may not be included in the report of applicable and/or non-applicable functionalities. Reporting a configuration within a group to be non-applicable may imply all configurations within the group (except legacy configuration) being non-applicable, when (or in response to) no other configurations (except the configuration reported non-applicable) are reported applicable. For example, the UE may indicate whether a configuration may be activated/triggered in the report of applicable and/or non-applicable functionalities. For example, one or more flags may be included in the report. A flag may be associated with a configuration. When a configuration may be (or in response to a configuration able to be) activated/triggered, the associated flag may be set to a first value (e.g., true). When a configuration may not be (or in response to a configuration not able to be) activated/triggered, the associated flag may be set to a second value (e.g., false). The flag may be (the existence of) an IE, number, integer, enum, bit string or Boolean value. For example, when no configuration is reported applicable (or one or more configuration is reported non-applicable), the legacy configuration may be activated/triggered.

In some examples, one or more configurations (e.g., provided in step 3) may be assigned a priority. For example, the provided configurations may be inference configurations. For example, the provided configurations may be inference configurations and/or legacy configurations. For example, the provided configurations may be within a group of configurations. For example, a first configuration may be activated/triggered, wherein the first configuration it is the most prioritized applicable configuration. For example, a second configuration may be kept but consider it not activated and/or may not be activated/triggered, wherein the second configuration is not the most prioritized applicable configuration (e.g., the second prioritized). The configuration may be activated/triggered when it becomes the most prioritized applicable configuration (e.g., the first configuration becomes non-applicable and/or removed/deactivated by the NW). For example, the configuration may not be kept (e.g., discard) when it is not the most prioritized applicable configuration. For example, the UE may report applicable configuration(s) that is the most prioritized as applicable functionalities to the NW (e.g., the first configuration). For example, the UE may report applicable configuration(s) that is the least prioritized as non-applicable functionalities to the NW. This may imply all related configurations (e.g., within a group) is non-applicable. For example, the UE may report applicable configuration(s) that is not the most prioritized as applicable functionalities to the NW (e.g., the second configuration). For example, the UE may not report applicable configuration(s) that is not the most prioritized as applicable functionalities to the NW (e.g., the second configuration).

In some examples, one or more sets of inference related parameters may be grouped together. For example, a group may comprise one or more sets of inference related parameters. For example, at least one of the sets of inference related parameters within a group may be reported to be applicable and/or non-applicable. One or more of the sets of inference related parameters within a group may not be included in the report of applicable and/or non-applicable functionalities. Reporting a set of inference related parameters within a group to be non-applicable may imply all sets of inference related parameters within the group being non-applicable, when (or in response to) no other sets of inference related parameters (except the set of inference related parameters reported non-applicable) are reported applicable.

In some examples, one or more sets of inference related parameters (e.g., provided in step 3) may be assigned a priority. For example, the provided sets of inference related parameters may be within a group of sets of inference related parameters. For example, the UE may report applicable set(s) of inference related parameters that is the most prioritized as applicable functionalities to the NW. For example, the UE may report applicable set(s) of inference related parameters that is the least prioritized as non-applicable functionalities to the NW. This may imply all related sets of inference related parameters (e.g., within a group) is non-applicable. For example, the UE may report applicable set(s) of inference related parameters that is not the most prioritized as applicable functionalities to the NW. For example, the UE may not report applicable set(s) of inference related parameters that is not the most prioritized as applicable functionalities to the NW (e.g., the second configuration).

In some examples, the UE may provide preferences for one or more inference related parameters. For example, the UE may provide preferences for one or more sets of inference related parameters (e.g., included in step 4). For example, the UE may provide preferences for one or more sets of inference related parameters within a group (e.g., included in step 4). For example, the UE may provide preferences for one or more options/values for one or more fields and/or parameters within a set of inference related parameters (e.g., included in step 4). For example, the UE may provide preferences for one or more inference configurations (e.g., included in step 4). For example, the UE may provide preferences for one or more inference configurations within a group (e.g., included in step 4). For example, the UE may provide preferences for one or more options/values for one or more fields and/or parameters within an inference configuration (e.g., included in step 4).

One, some and/or all of the foregoing examples, concepts, techniques and/or embodiments can be formed and/or combined to a new embodiment.

In some examples, embodiments disclosed herein may be implemented independently and/or separately. Alternatively and/or additionally, a combination of embodiments described herein may be implemented. Alternatively and/or additionally, a combination of embodiments described herein may be implemented concurrently and/or simultaneously.

Various techniques, embodiments, methods and/or alternatives of the present disclosure may be performed independently and/or separately from one another. Alternatively and/or additionally, various techniques, embodiments, methods and/or alternatives of the present disclosure may be combined and/or implemented using a single system. Alternatively and/or additionally, various techniques, embodiments, methods and/or alternatives of the present disclosure may be implemented concurrently and/or simultaneously.

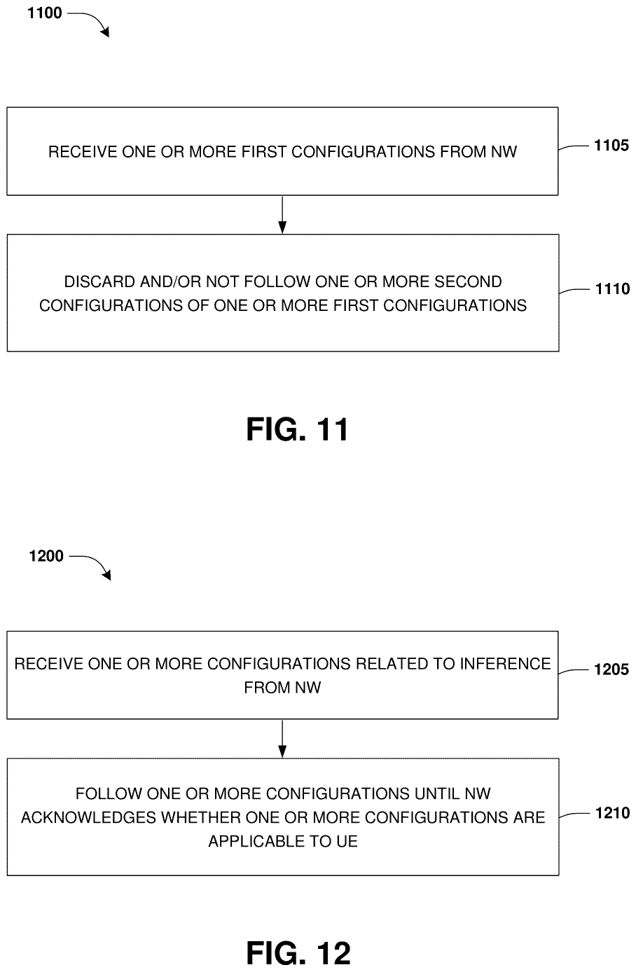

FIG. 11 is a flow chart 1100 according to one exemplary embodiment from the perspective of a UE. In step 1105, the UE receives one or more first configurations from an NW. In step 1110, the UE discards and/or does not follow one or more second configurations of the one or more configurations.

In one embodiment, the one or more first configurations may be related to the inference of an AI/ML functionality.

In one embodiment, the one or more second configurations discarded and/or not followed by the UE are non-applicable. For example, the one or more second configurations may be discarded and/or not followed by the UE (e.g., the UE may not execute an inference operation according to the one or more second configurations) based upon a determination that the one or more second configurations are non-applicable.

In one embodiment, the UE not following the configuration comprises the UE not activating (and/or not being able to activate) a periodic report (associated with the configuration, for example), the UE not activating (and/or not being able to activate) a semi-persistent report (associated with the configuration, for example), the UE not triggering (and/or not being able to trigger) an aperiodic report (associated with the configuration, for example), and/or the UE dropping a report (associated with the configuration, for example).

Referring back to FIGS. 3 and 4, in one exemplary embodiment of a UE, the device 300 includes a program code 312 stored in the memory 310. The CPU 308 may execute program code 312 to enable UE (i) to receive one or more first configurations from the NW, and (ii) to discard and/or not follow one or more second configurations of the one or more configurations. Furthermore, the CPU 308 can execute the program code 312 to perform one, some and/or all of the above-described actions and steps and/or others described herein.

FIG. 12 is a flow chart 1200 according to one exemplary embodiment from the perspective of a UE. In step 1205, the UE receives one or more configurations related to inference from an NW. In step 1210, the UE follows the one or more configurations until the NW acknowledges whether the one or more configurations are applicable to the UE. For example, the UE may execute one or more inference operations in accordance with the one or more configurations at least until the NW acknowledges whether the one or more configurations are applicable to the UE.

In some examples, the UE may continue following a configuration of the one or more configurations (e.g., the UE may execute one or more inference operations in accordance with the configuration) in response to the NW acknowledging that the configuration is applicable to the UE (e.g., the NW may acknowledge that the configuration is applicable to the UE by transmitting, to the UE, an indication that the configuration is applicable to the UE). In some examples, the UE may cease following a configuration of the one or more configurations (e.g., the UE may not execute one or more inference operations in accordance with the configuration) in response to the NW acknowledging that the configuration is not applicable to the UE (e.g., the NW may acknowledge that the configuration is not applicable to the UE by transmitting, to the UE, an indication that the configuration is not applicable to the UE).

In one embodiment, the UE follows the one or more configurations (and/or continues following the one or more configurations) based on the reception of ACK (from the NW, for example).

In one embodiment, the UE reports one or more applicable functionalities and/or one or more non-applicable functionalities through UAI.

In one embodiment, the UE reports one or more applicable functionalities and/or one or more non-applicable functionalities through RRCReconfigurationComplete.

In one embodiment, the UE following a configuration of the one or more configurations comprises the UE activating (and/or being able to activate) a periodic report (associated with the configuration, for example), the UE activating (and/or being able to activate) a semi-persistent report (associated with the configuration, for example), the UE triggering (and/or being able to trigger) an aperiodic report (associated with the configuration, for example), and/or the UE sending a report (associated with the configuration, for example).

Referring back to FIGS. 3 and 4, in one exemplary embodiment of a UE, the device 300 includes a program code 312 stored in the memory 310. The CPU 308 may execute program code 312 to enable UE (i) to receive one or more configurations related to inference from the NW, and (ii) to follow the one or more configurations until the NW acknowledges whether the one or more configurations are applicable to the UE. Furthermore, the CPU 308 can execute the program code 312 to perform one, some and/or all of the above-described actions and steps and/or others described herein.

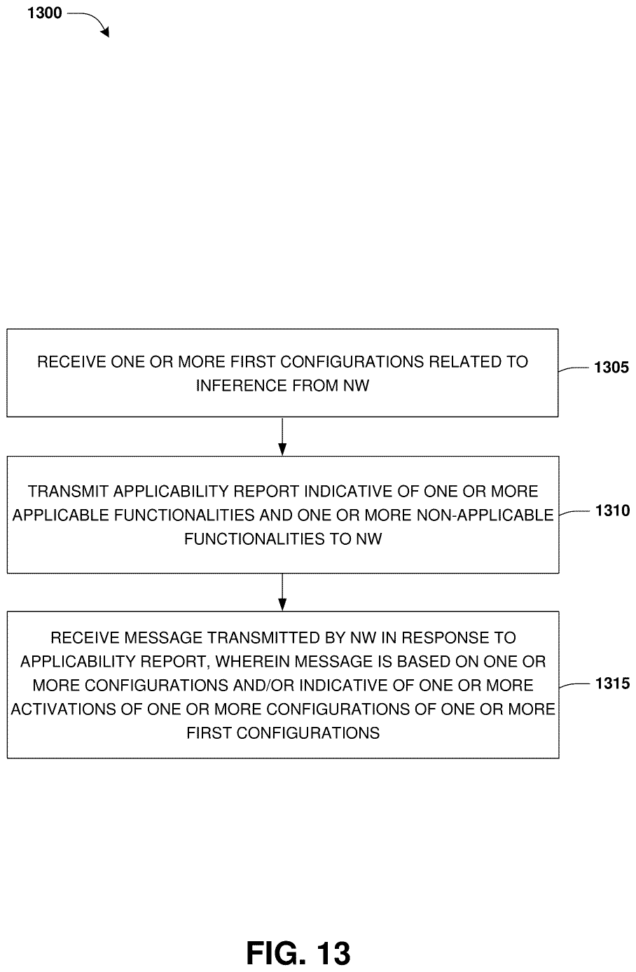

FIG. 13 is a flow chart 1300 according to one exemplary embodiment from the perspective of a UE. In step 1305, the UE receives one or more first configurations, related to inference, from an NW. In step 1310, the UE transmits an applicability report indicative of one or more applicable functionalities and/or one or more non-applicable functionalities to the NW (to report the one or more applicable functionalities and/or the one or more non-applicable functionalities to the NW, for example). For example, the one or more applicable functionalities may be indicative of (and/or usable to determine) one or more second configurations, of the one or more first configurations, that are applicable to the UE. The one or more non-applicable functionalities may be indicative of (and/or usable to determine) one or more third configurations, of the one or more first configurations, that are not applicable to the UE. In step 1315, the UE receives a message transmitted by the NW in response to the applicability report, wherein the message is based on the one or more configurations and/or indicative of one or more activations of (and/or one or more allowances for triggering) one or more fourth configurations of the one or more first configurations. In some examples, the one or more fourth configurations may comprise one, some, or all of the one or more second configurations that the UE reports are applicable to the UE.

Referring back to FIGS. 3 and 4, in one exemplary embodiment of a UE, the device 300 includes a program code 312 stored in the memory 310. The CPU 308 may execute program code 312 to enable UE (i) to receive one or more first configurations related to inference from an NW, (ii) to transmit an applicability report indicative of one or more applicable functionalities and/or one or more non-applicable functionalities to the NW, and (iii) to receive a message transmitted by the NW in response to the applicability report, wherein the message is based on the one or more configurations and/or indicative of one or more activations of (and/or one or more allowances for triggering) one or more configurations of the one or more first configurations. Furthermore, the CPU 308 can execute the program code 312 to perform one, some and/or all of the above-described actions and steps and/or others described herein.

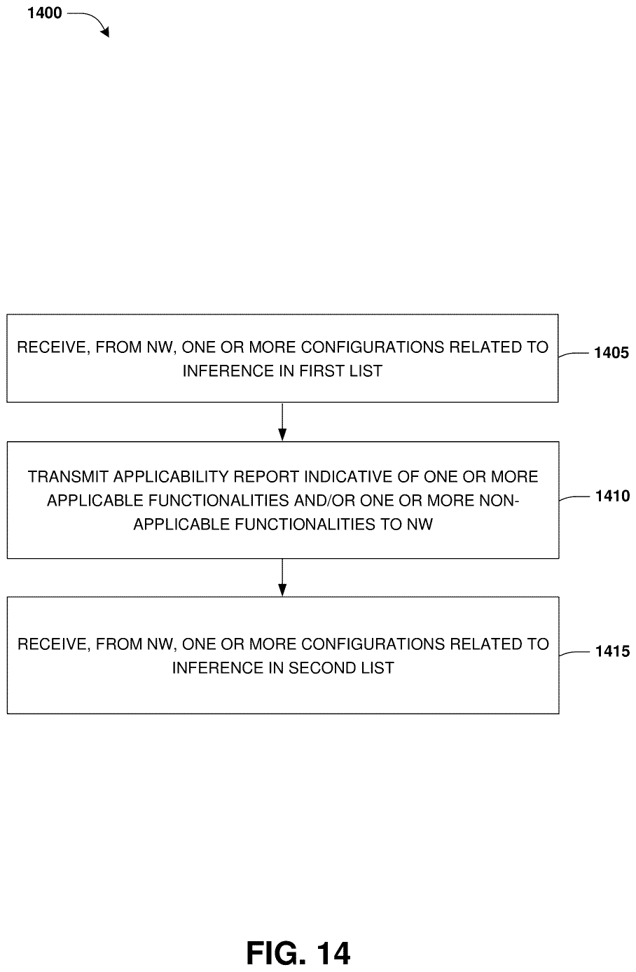

FIG. 14 is a flow chart 1400 according to one exemplary embodiment from the perspective of a UE. In step 1405, the UE receives, from an NW, one or more first configurations related to inference in a first list. In step 1410, the UE transmits an applicability report indicative of one or more applicable functionalities and/or one or more non-applicable functionalities to the NW (to report the one or more applicable functionalities and/or the one or more non-applicable functionalities to the NW, for example). For example, the one or more applicable functionalities may be indicative of (and/or usable to determine) one or more second configurations, of the one or more first configurations, that are applicable to the UE. The one or more non-applicable functionalities may be indicative of (and/or usable to determine) one or more third configurations, of the one or more first configurations, that are not applicable to the UE. In step 1415, the UE receives, from the NW, one or more fourth configurations related to inference in a second list.

Referring back to FIGS. 3 and 4, in one exemplary embodiment of a UE, the device 300 includes a program code 312 stored in the memory 310. The CPU 308 may execute program code 312 to enable UE (i) to receive, from an NW, one or more configurations related to inference in a first list, (ii) to transmit an applicability report indicative of one or more applicable functionalities and/or one or more non-applicable functionalities to the NW, and (iii) to receive, from the NW, one or more configurations related to inference in a second list. Furthermore, the CPU 308 can execute the program code 312 to perform one, some and/or all of the above-described actions and steps and/or others described herein.

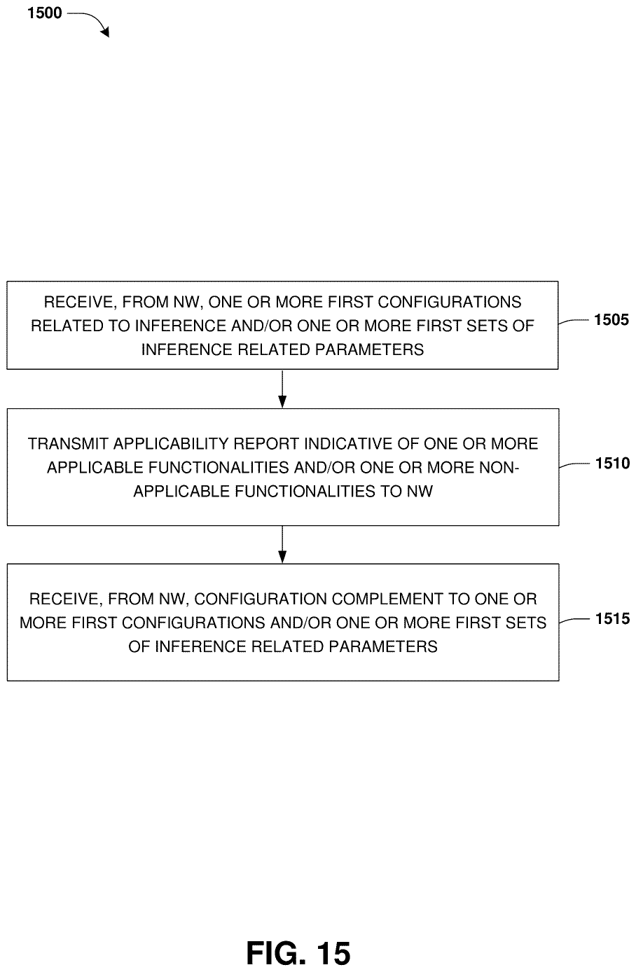

FIG. 15 is a flow chart 1500 according to one exemplary embodiment from the perspective of a UE. In step 1505, the UE receives, from an NW, one or more first configurations related to inference and/or one or more first sets of inference related parameters. In step 1510, the UE transmits an applicability report indicative of one or more applicable functionalities and/or one or more non-applicable functionalities to the NW (to report the one or more applicable functionalities and/or the one or more non-applicable functionalities to the NW, for example). For example, the one or more applicable functionalities may be indicative of (and/or usable to determine) one or more second configurations, of the one or more first configurations, that are applicable to the UE. Alternatively and/or additionally, the one or more applicable functionalities may be indicative of (and/or usable to determine) one or more second sets of inference related parameters, of the one or more first sets of inference related parameters, that are applicable to the UE. The one or more non-applicable functionalities may be indicative of (and/or usable to determine) one or more third configurations, of the one or more first configurations, that are not applicable to the UE. Alternatively and/or additionally, the one or more non-applicable functionalities may be indicative of (and/or usable to determine) one or more third sets of inference related parameters, of the one or more first sets of inference related parameters, that are not applicable to the UE. In step 1515, the UE receives, from the NW, a configuration complement to the one or more first configurations and/or the one or more first sets of inference related parameters.

Referring back to FIGS. 3 and 4, in one exemplary embodiment of a UE, the device 300 includes a program code 312 stored in the memory 310. The CPU 308 may execute program code 312 to enable UE (i) to receive, from an NW, one or more first configurations related to inference and/or one or more first sets of inference related parameters, (ii) to transmit an applicability report indicative of one or more applicable functionalities and/or one or more non-applicable functionalities to the NW, and (iii) to receive, from the NW, a configuration complement to the one or more first configurations and/or the one or more first sets of inference related parameters. Furthermore, the CPU 308 can execute the program code 312 to perform one, some and/or all of the above-described actions and steps and/or others described herein.

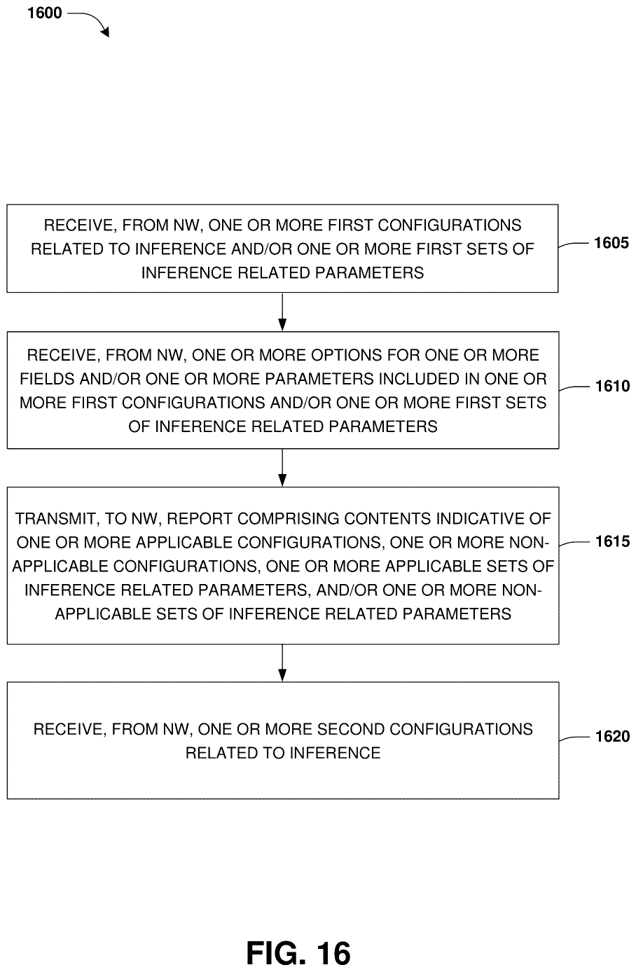

FIG. 16 is a flow chart 1600 according to one exemplary embodiment from the perspective of a UE. In step 1605, the UE, from an NW, receives one or more first configurations related to inference and/or one or more first sets of inference related parameters. In step 1610, the UE receives, from the NW, one or more options for one or more fields and/or one or more parameters included in the one or more first configurations and/or the one or more first sets of inference related parameters. For example, the one or more options may comprise potential values (e.g., beam counts, prediction windows, etc.) for the one or more fields and/or the one or more parameters included in the one or more first configurations and/or the one or more first sets of inference related parameters. In step 1615, the UE transmits, to the NW, a report comprising contents indicative of one or more applicable configurations (of the one or more first configurations, for example), one or more non-applicable configurations (of the one or more first configurations, for example), one or more applicable sets of inference related parameters (of the one or more first sets of inference related parameters, for example), and/or one or more non-applicable sets of inference related parameters (of the one or more first sets of inference related parameters, for example). In some examples, the UE may generate the report (and/or determine which configurations and/or sets of inference related parameters are applicable and/or non-applicable) based upon the one or more options, the one or more first configurations, and/or the one or more first sets of inference related parameters. In step 1620, the UE receives, from the NW, one or more second configurations related to inference. For example, the NW may determine the one or more second configurations based upon the report. The one or more second configurations may comprise one or more updated inference configurations for the UE to use for performing inference. Alternatively and/or additionally, the NW may instruct the UE to activate the one or more second configurations (of the one or more first configurations, for example) based upon the report.

In one embodiment, the one or more options are explicitly or implicitly provided to the UE. For example, the NW may explicitly provide a first option of the one or more options to the UE by directly including an indication of the first option in a field of a message transmitted to the UE. The NW may implicitly provide a second option of the one or more options to the UE by at least one of omitting a field, providing an empty entry in a field, setting a field to “not specified”, etc. in a message transmitted to the UE, which may be interpretable by the UE (based upon one or more predefined rules, for example) as being indicative of the second option.

In one embodiment, the UE reports one or more configurations (of the one or more first configurations, for example) and/or one or more sets of inference related parameters (of the one or more first sets of inference related parameters, for example) to the NW.

In one embodiment, the UE reports one or more second options for one or more fields in one or more configurations and/or for one or more fields in one or more sets of inference parameters to the NW. For example, the one or more second options may be included in the report. In some examples, the UE may select the one or more second options from the one or more options provided by the NW.

Referring back to FIGS. 3 and 4, in one exemplary embodiment of a UE, the device 300 includes a program code 312 stored in the memory 310. The CPU 308 may execute program code 312 to enable UE (i) to receive, from an NW, one or more first configurations related to inference and/or one or more first sets of inference related parameters, (ii) to receive, from the NW, one or more options for one or more fields and/or one or more parameters included in the one or more first configurations and/or the one or more first sets of inference related parameters, (iii) to transmit, to the NW, a report comprising contents indicative of one or more applicable configurations, one or more non-applicable configurations, one or more applicable sets of inference related parameters, and/or one or more non-applicable sets of inference related parameters, and (iv) to receive, from the NW, one or more second configurations related to inference. Furthermore, the CPU 308 can execute the program code 312 to perform one, some and/or all of the above-described actions and steps and/or others described herein.

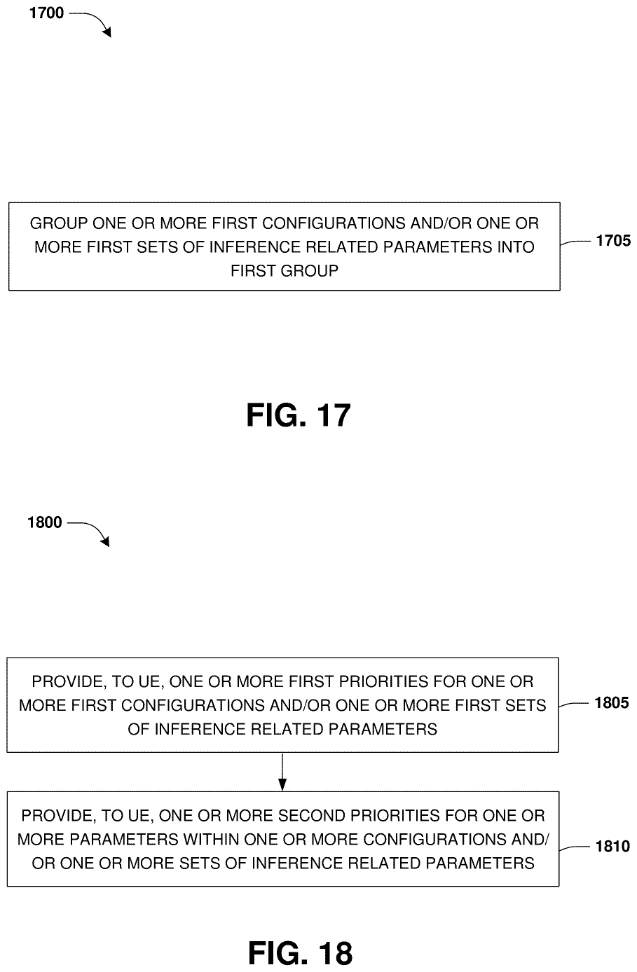

FIG. 17 is a flow chart 1700 according to one exemplary embodiment from the perspective of a UE. In step 1705, the UE groups one or more first configurations and/or one or more first sets of inference related parameters into a first group. In some examples, the UE groups the one or more first configurations and/or the one or more first sets of inference related parameters into the first group based upon grouping information received from a NW. Alternatively and/or additionally, the NW may group the one or more first configurations and/or the one or more first sets of inference related parameters into the first group and/or transmit an indication of the first group to the UE. In some examples, the one or more first configurations and/or the one or more first sets of inference related parameters may be grouped into the first group (by the UE and/or the NW, for example) based upon the one or more first configurations and/or the one or more first sets of inference related parameters sharing a first functionality and/or sharing a first inference model.

In some examples, the UE groups one or more second configurations and/or one or more second sets of inference related parameters into a second group. In some examples, the UE groups the one or more second configurations and/or the one or more second sets of inference related parameters into the second group based upon grouping information received from the NW. Alternatively and/or additionally, the NW may group the one or more second configurations and/or the one or more second sets of inference related parameters into the second group and/or transmit an indication of the second group to the UE. In some examples, the one or more second configurations and/or the one or more second sets of inference related parameters may be grouped into the second group (by the UE and/or the NW, for example) based upon the one or more second configurations and/or the one or more second sets of inference related parameters sharing a second functionality and/or sharing a second inference model.

In one embodiment, the UE selects one or more configurations within a group (e.g., the first group and/or the second group) to apply and/or follow. For example, the UE may execute one or more inference operations according to the one or more configurations.

In one embodiment, the UE selects one or more sets of inference related parameters within a group (e.g., the first group and/or the second group) to report (to the NW, for example). For example, the UE may transmit a report indicative of the one or more sets of inference related parameters (to the NW, for example).

Referring back to FIGS. 3 and 4, in one exemplary embodiment of a UE, the device 300 includes a program code 312 stored in the memory 310. The CPU 308 may execute program code 312 to enable UE to group one or more first configurations and/or one or more first sets of inference related parameters into a first group. Furthermore, the CPU 308 can execute the program code 312 to perform one, some and/or all of the above-described actions and steps and/or others described herein.

FIG. 18 is a flow chart 1800 according to one exemplary embodiment from the perspective of an NW. In step 1805, the NW provides, to the UE, one or more first priorities for one or more first configurations and/or one or more first sets of inference related parameters. In step 1810, the NW provides, to the UE, one or more second priorities for one or more parameters within one or more configurations (of the one or more first configurations, for example) and/or one or more sets of inference related parameters (of the one or more first sets of inference related parameters, for example).

In one embodiment, the UE applies one or more most prioritized configurations of the one or more first configurations (e.g., one or more configurations, of the one or more first configurations, associated with one or more highest priorities of the one or more first priorities).

In one embodiment, the UE includes one or more least prioritized configurations (e.g., one or more configurations, of the one or more first configurations, associated with one or more lowest priorities of the one or more first priorities) and/or least prioritized sets of inference related parameters (e.g., one or more sets of inference related parameters, of the one or more first sets of inference related parameters, associated with one or more lowest priorities of the one or more first priorities) in a report of non-applicable functionalities. The UE may transmit the report of non-applicable functionalities to the NW.

In one embodiment, the UE includes one or more most prioritized applicable configurations (e.g., one or more configurations, of the one or more first configurations, that are applicable to the UE and/or associated with one or more highest priorities of the one or more first priorities) and/or most prioritized applicable sets of inference related parameters (e.g., one or more sets of inference related parameters, of the one or more first sets of inference related parameters, that are applicable to the UE and/or associated with one or more highest priorities of the one or more first priorities) in a report of applicable functionalities. The UE may transmit the report of applicable functionalities to the NW.

In one embodiment, the UE applies a configuration, of the one or more first configurations, based on one or more most prioritized parameters (e.g., one or more parameters associated with one or more highest priorities among a set of priorities of the one or more second priorities) among (i) parameters associated with one or more configurations (of the one or more first configurations) that are applicable to (e.g., implementable by and/or compatible with) the UE and/or (ii) parameters associated with one or more sets of inference related parameters (of the one or more first sets of inference related parameters) that are applicable to (e.g., implementable by and/or compatible with) the UE.

In one embodiment, the UE includes, in the report of applicable functionalities, a configuration and/or a set of inference related parameters that includes one or more most prioritized parameters (e.g., one or more parameters associated with one or more highest priorities among a set of priorities of the one or more second priorities) among (i) parameters associated with one or more configurations (of the one or more first configurations) that are applicable to (e.g., implementable by and/or compatible with) the UE and/or (ii) parameters associated with one or more sets of inference related parameters (of the one or more first sets of inference related parameters) that are applicable to (e.g., implementable by and/or compatible with) the UE.

In one embodiment, the UE includes, in the report of non-applicable functionalities, a configuration and/or a set of inference related parameters that includes one or more least prioritized parameters (e.g., one or more parameters associated with one or more lowest priorities among a set of priorities of the one or more second priorities) among (i) parameters associated with one or more configurations (of the one or more first configurations) and/or (ii) parameters associated with one or more sets of inference related parameters (of the one or more first sets of inference related parameters).

In one embodiment, the one or more first configurations and/or the one or more first sets of inference related parameters are within a group. The one or more first configurations and/or the one or more first sets of inference related parameters may be grouped into the group by the NW and/or the UE.

Referring back to FIGS. 3 and 4, in one exemplary embodiment of a NW, the device 300 includes a program code 312 stored in the memory 310. The CPU 308 may execute program code 312 to enable NW (i) to provide, to the UE, one or more first priorities for one or more first configurations and/or one or more first sets of inference related parameters, and (ii) to provide, to the UE, one or more second priorities for one or more parameters within one or more configurations and/or one or more sets of inference related parameters. Furthermore, the CPU 308 can execute the program code 312 to perform one, some and/or all of the above-described actions and steps and/or others described herein.

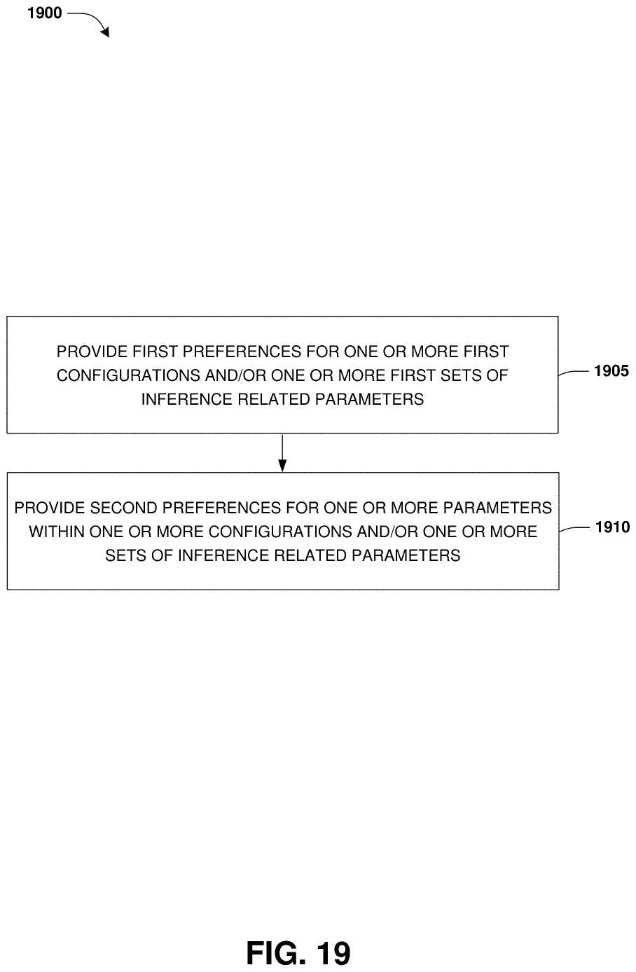

FIG. 19 is a flow chart 1900 according to one exemplary embodiment from the perspective of a UE. In step 1905, the UE provides first preferences for one or more first configurations and/or one or more first sets of inference related parameters. For example, the UE may transmit the first preferences to a NW. In step 1910, the UE provides preferences for one or more parameters within one or more configurations (of the one or more first configurations, for example) and/or one or more sets of inference related parameters (of the one or more first sets of inference related parameters, for example). For example, the UE may transmit the second preferences to the NW.

In one embodiment, the UE provides the first preferences and/or the second preferences in a report of applicable functionalities and/or in a report of non-applicable functionalities (and/or in a report of applicable functionalities and non-applicable functionalities). For example, the UE may include the first preferences and/or the second preferences in the report of applicable functionalities and/or in the report of non-applicable functionalities (and/or in the report of applicable functionalities and non-applicable functionalities) and/or may transmit, to the NW, the report of applicable functionalities and/or the report of non-applicable functionalities (and/or the report of applicable functionalities and non-applicable functionalities).

In one embodiment, the one or more parameters comprise values and/or options within a field and/or a parameter in a configuration (of the one or more first configurations, for example) and/or a set of inference related parameters (of the one or more first sets of inference related parameters, for example).

In one embodiment, the one or more first configurations and/or the one or more first sets of inference related parameters are within a group. The one or more first configurations and/or the one or more first sets of inference related parameters may be grouped into the group by the NW and/or the UE.

Referring back to FIGS. 3 and 4, in one exemplary embodiment of a UE, the device 300 includes a program code 312 stored in the memory 310. The CPU 308 may execute program code 312 to enable UE (i) to provide first preferences for one or more first configurations and/or one or more first sets of inference related parameters, and (ii) to provide second preferences for one or more parameters within one or more configurations and/or one or more sets of inference related parameters. Furthermore, the CPU 308 can execute the program code 312 to perform one, some and/or all of the above-described actions and steps and/or others described herein.

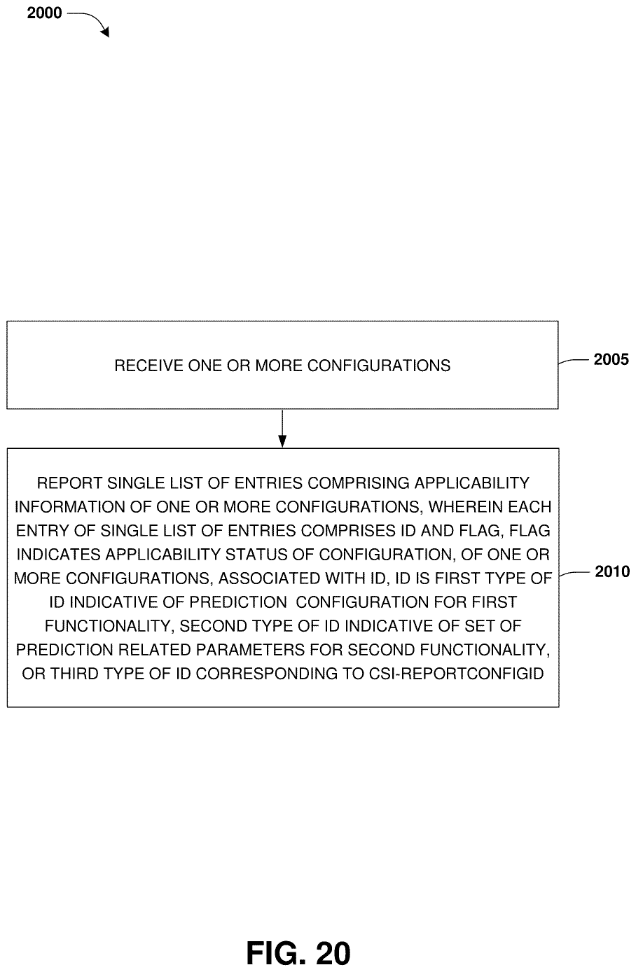

FIG. 20 is a flow chart 2000 according to one exemplary embodiment from the perspective of a UE. In step 2005, the UE receives one or more configurations (e.g., one or more configurations based on which the UE performs applicability reporting). For example, the UE may receive the one or more configurations from a network. In step 2010, the UE reports a single list of entries comprising applicability information (e.g., an applicability report) of the one or more configurations. For example, the UE may transmit the single list of entries to the network (to report the applicability information of the one or more configurations to the network, for example). Each entry of the single list of entries may comprise an identifier (ID) and a flag (and/or other information in addition to the ID and the flag). The flag may indicate an applicability status of a configuration, of the one or more configurations, associated with the ID. The ID is a first type of ID indicative of a prediction configuration for a first functionality, a second type of ID indicative of a set of prediction related parameters for a second functionality, and/or a third type of ID corresponding to CSI-ReportConfigId (e.g., a CSI Report Configuration ID).

In some examples, the set of prediction related parameters for the second functionality may comprise an associated ID, a CSI resource config ID for measurement, a CSI resource config ID for prediction, information related to reporting (e.g., report quantity, PUCCH resource, etc.), time related information for measurements (e.g., a measurement window, such as a maximum measurement window, which may be in units of at least one of slots, ms, time, duration, etc., a number of instances to measure, such as a maximum number of instances to measure, one or more offsets for one or more measurements and/or one or more measurement windows), time related information for prediction (e.g., a prediction window, such as a maximum prediction window, which may be in units of at least one of slots, ms, time, duration, etc., a number of instances to predict, such as a maximum number of instances to predict, one or more offsets for one or more predictions and/or one or more prediction windows), information for beam management, one or more relations between beams for measurement (e.g., number of beams to measure, number of beams to predict, etc.), and/or one or more other parameters.

In one embodiment, the UE performs a prediction operation after (e.g., in response to) reporting the single list of entries. In some examples, the prediction operation may comprise determining one or more inputs (e.g., a measurement, CSI, beam data, mobility information), generating a prediction using an AI and/or ML model, and/or using (and/or reporting) the prediction. In some examples, the AI and/or ML model may be stored and/or executed on the UE and/or on a node (e.g., the network, a server, a network edge, etc.) to generate the prediction.

For example, the prediction operation may comprise a beam management prediction operation. The one or more inputs may comprise one or more measurements associated with a set of beams (e.g., measurements of one or more resources corresponding to the set of beams) and/or the prediction may be indicative of one or more selected beams, of the set of beams, that are expected to provide improved communication performance relative to one or more other beams of the set of beams. Based upon the prediction, the UE may report the one or more selected beams to the network and/or may utilize a beam of the one or more selected beams for communication.

Alternatively and/or additionally, the prediction operation may comprise a CSI prediction operation. The one or more inputs may comprise one or more channel measurements (e.g., CSI-RS measurements) and/or the prediction may be indicative of one or more CSI predictions comprising one or more future CSI values. Based upon the prediction, the UE may perform local channel selection (based upon the one or more future CSI values, for example). Alternatively and/or additionally, the UE may report the one or more future CSI values to the network.

Alternatively and/or additionally, the prediction operation may comprise a CSI compression operation. The one or more inputs may comprise one or more channel measurements (e.g., CSI-RS measurements) and/or the AI and/or ML model may generate a compressed CSI representation (e.g., the prediction) based upon the one or more inputs (e.g., the one or more channel measurements). Alternatively and/or additionally, the AI and/or ML model may generate a compressed CSI representation based upon the one or more inputs (e.g., the one or more channel measurements). The UE may report the compressed CSI representation to the network.

Alternatively and/or additionally, the prediction operation may comprise a mobility prediction operation. The one or more inputs may comprise one or more radio measurements associated with a serving cell and/or a neighbor cell and/or the prediction may be indicative of one or more mobility predictions comprising a probability of RLF, a probability of HoF, an expected target cell for handover, an expected serving cell degradation, and/or one or more future measurement results of one or more neighbor cells. Based upon the prediction, the UE may report the one or more mobility predictions to the network, may adjust one or more mobility parameters, and/or may trigger a handover before the expected serving cell degradation is expected to occur.

In one embodiment, the one or more configurations (received from the network, for example) comprise a prediction configuration for a functionality, CSI-ReportConfig (e.g., a CSI report configuration) for prediction, and/or one or more sets of prediction related parameters for a functionality.

In one embodiment, the one or more configurations (received from the network, for example) are received by receiving one or more lists indicative of the one or more configurations (e.g., the one or more lists comprise the one or more configurations).

In one embodiments, one or more first configurations, of the one or more configurations, that are associated with the same type of ID (e.g., the first type of ID, the second type of ID, or the third type of ID) are included in a list (e.g., a single list) of the one or more lists (received from the network, for example). For example, one, some, and/or all configurations, of the one or more configurations, that are associated with the first type of ID may be included in a first list (e.g., a single list) of the one or more lists (received from the network, for example). For example, one, some, and/or all configurations, of the one or more configurations, that are associated with the second type of ID may be included in a second list (e.g., a single list) of the one or more lists (received from the network, for example). For example, one, some, and/or all configurations, of the one or more configurations, that are associated with the third type of ID may be included in a third list (e.g., a single list) of the one or more lists (received from the network, for example).

In one embodiment, each ID indicated by the single list of entries is associated with a configuration (e.g., a single configuration) of the one or more configurations (received from the network, for example).

In one embodiment, the single list of entries (e.g., the applicability report) comprises a plurality of types of IDs. For example, a first entry of the single list of entries may comprise the first type of ID, a second entry of the single list of entries may comprise the second type of ID, and/or a third entry of the single list of entries may comprise the third type of ID.

In one embodiment, the single list of entries is included in RRCReconfigurationComplete (e.g., a RRC Reconfiguration Complete message) or UAI. For example, the UE may transmit the RRCReconfigurationComplete comprising the single list of entries (to the network, for example). Alternatively and/or additionally, the UE may transmit the UAI comprising the single list of entries (to the network, for example).

In one embodiment, the first functionality comprises a prediction configuration and/or a set of prediction related parameters.

In one embodiment, the second functionality comprises a prediction configuration and/or a set of prediction related parameters.

In one embodiment, the applicability status (indicated by the flag) indicates whether the configuration is applicable (e.g., applicable to and/or implementable by the UE) or the configuration is non-applicable (e.g., non-applicable to and/or non-implementable by the UE). For example, the applicability status may be set to indicate the configuration is applicable based upon a determination that the UE has sufficient processing resources, sufficient memory, sufficient power availability, one or more required measurement resources, hardware compatible with the configuration, software compatible with the configuration, an operating system compatible with the configuration, and/or a required model (e.g., AI and/or ML model) for performing an AI and/or ML functionality (e.g., collecting inputs, running the AI and/or ML model, activating and/or transmitting a periodic report, a semi-persistent report, and/or an aperiodic report based upon an output of the AI and/or ML model, etc.) associated with the configuration. Alternatively and/or additionally, the applicability status may be set to indicate the configuration is non-applicable based upon a determination that the UE has insufficient processing resources, insufficient memory, and/or insufficient power availability for performing an AI and/or ML functionality (e.g., collecting inputs, running the AI and/or ML model, activating and/or transmitting a periodic report, a semi-persistent report, and/or an aperiodic report based upon an output of the AI and/or ML model, etc.) associated with the configuration and/or that the UE does not have one or more required measurement resources, hardware compatible with the configuration, software compatible with the configuration, an operating system compatible with the configuration, and/or a required model (e.g., AI and/or ML model) for performing the AI and/or ML functionality associated with the configuration.

In some examples, the first entry of the single list of entries (e.g., the applicability report) may comprise the first type of ID indicative of the prediction configuration for the first functionality and a flag indicating that the applicability status of the prediction configuration is applicable, which may indicate that the prediction configuration for the first functionality is applicable (e.g., applicable to and/or implementable by the UE). For example, after (e.g., in response to) reporting the single list of entries, the UE may perform one or more prediction operations according to the prediction configuration for the first functionality. The one or more prediction operations may comprise a beam management prediction operation when the prediction configuration and/or the first functionality correspond to beam management prediction operation. The one or more prediction operations may comprise a CSI prediction operation when the prediction configuration and/or the first functionality correspond to CSI prediction operation. The one or more prediction operations may comprise a CSI compression operation when the prediction configuration and/or the first functionality correspond to CSI compression operation. The one or more prediction operations may comprise a mobility prediction operation when the prediction configuration and/or the first functionality correspond to mobility prediction operation. In some examples, the first entry comprising a flag indicating that the applicability status of the prediction configuration is non-applicable may indicate that the prediction configuration for the first functionality is non-applicable (e.g., non-applicable to and/or non-implementable by the UE). For example, after (e.g., in response to) reporting the single list of entries, the UE may not perform one or more prediction operations (e.g., a beam management prediction operation, a CSI prediction operation, a CSI compression operation, a mobility prediction operation, etc.) according to the prediction configuration for the first functionality.

In some examples, the second entry of the single list of entries (e.g., the applicability report) may comprise the second type of ID indicative of the set of prediction related parameters for the second functionality and a flag indicating that the applicability status of the set of prediction related parameters is applicable, which may indicate that the set of prediction related parameters for the second functionality is applicable (e.g., applicable to and/or implementable by the UE). For example, after (e.g., in response to) reporting the single list of entries, the UE may perform one or more prediction operations according to the set of prediction related parameters for the second functionality. The one or more prediction operations may comprise a beam management prediction operation when the set of prediction related parameters and/or the second functionality correspond to beam management prediction operation. The one or more prediction operations may comprise a CSI prediction operation when the set of prediction related parameters and/or the second functionality correspond to CSI prediction operation. The one or more prediction operations may comprise a CSI compression operation when the set of prediction related parameters and/or the second functionality correspond to CSI compression operation. The one or more prediction operations may comprise a mobility prediction operation when the set of prediction related parameters and/or the second functionality correspond to mobility prediction operation. In some examples, the first entry comprising a flag indicating that the applicability status of the set of prediction related parameters is non-applicable may indicate that the set of prediction related parameters for the second functionality is non-applicable (e.g., non-applicable to and/or non-implementable by the UE). For example, after (e.g., in response to) reporting the single list of entries, the UE may not perform one or more prediction operations (e.g., a beam management prediction operation, a CSI prediction operation, a CSI compression operation, a mobility prediction operation, etc.) according to the set of prediction related parameters for the second functionality.

Referring back to FIGS. 3 and 4, in one exemplary embodiment of a UE, the device 300 includes a program code 312 stored in the memory 310. The CPU 308 may execute program code 312 to enable UE (i) to receive one or more configurations, and (ii) to report a single list of entries comprising applicability information of the one or more configurations, wherein each entry of the single list of entries comprises an ID and a flag, the flag indicates an applicability status of a configuration, of the one or more configurations, associated with the ID, and the ID is a first type of ID indicative of a prediction configuration for a first functionality, a second type of ID indicative of a set of prediction related parameters for a second functionality, and/or a third type of ID corresponding to CSI-ReportConfigId. Furthermore, the CPU 308 can execute the program code 312 to perform one, some and/or all of the above-described actions and steps and/or others described herein.

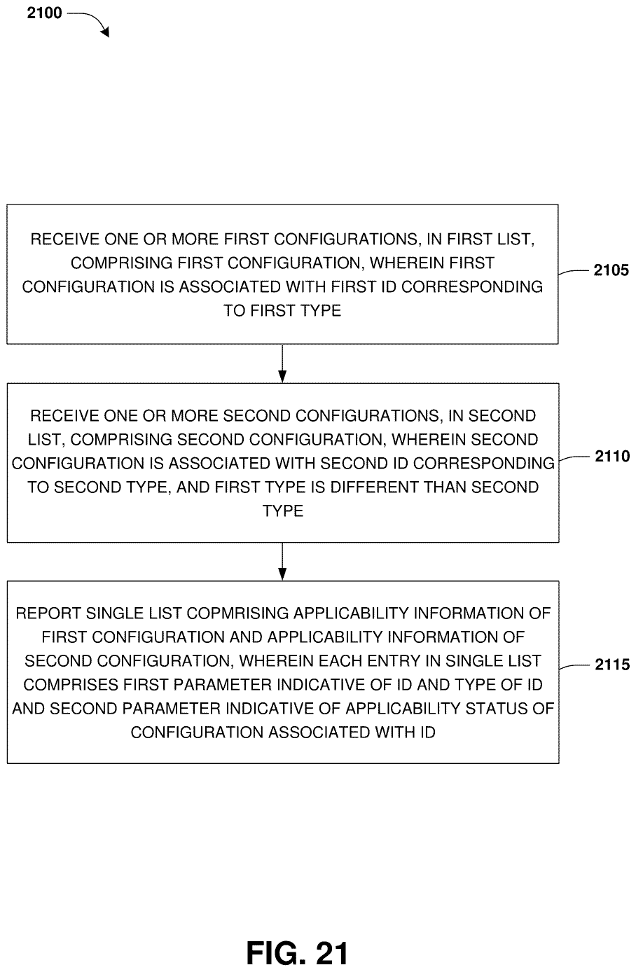

FIG. 21 is a flow chart 2100 according to one exemplary embodiment from the perspective of a UE. In step 2105, the UE receives one or more first configurations, in a first list, comprising a first configuration, wherein the first configuration is associated with a first ID corresponding to a first type. In step 2110, the UE receives one or more second configurations, in a second list, comprising a second configuration, wherein the second configuration is associated with a second ID corresponding to a second type, and the first type is different than the second type. In step 2115, the UE reports a single list comprising applicability information of the first configuration and applicability information of the second configuration, wherein each entry in the single list comprises a first parameter and a second parameter (and/or other information in addition to the first parameter and the second parameter). The first parameter is indicative of an ID and/or a type of the ID. The second parameter is indicative of an applicability status of a configuration associated with the ID.

In one embodiment, the UE performs a first prediction operation according to the first configuration after (e.g., in response to) reporting the applicability information of the first configuration (by transmitting the single list comprising the applicability information of the first configuration, for example). For example, the UE may perform the first prediction operation according to the first configuration based upon the UE determining that the first configuration is applicable (e.g., applicable to and/or implementable by the UE), wherein the single list may comprise an applicability status indicating that the first configuration is applicable. In some examples, the first prediction operation may comprise determining one or more inputs (e.g., a measurement, CSI, beam data, mobility information), generating a prediction using an AI and/or ML model, and/or using (and/or reporting) the prediction. In some examples, the AI and/or ML model may be stored and/or executed on the UE and/or on a node (e.g., the network, a server, a network edge, etc.) to generate the prediction.

For example, the first prediction operation may comprise a beam management prediction operation. The one or more inputs may comprise one or more measurements associated with a set of beams (e.g., measurements of one or more resources corresponding to the set of beams) and/or the prediction may be indicative of one or more selected beams, of the set of beams, that are expected to provide improved communication performance relative to one or more other beams of the set of beams. Based upon the prediction, the UE may report the one or more selected beams to the network and/or may utilize a beam of the one or more selected beams for communication.

Alternatively and/or additionally, the first prediction operation may comprise a CSI prediction operation. The one or more inputs may comprise one or more channel measurements (e.g., CSI-RS measurements) and/or the prediction may be indicative of one or more CSI predictions comprising one or more future CSI values. Based upon the prediction, the UE may perform local channel selection (based upon the one or more future CSI values, for example). Alternatively and/or additionally, the UE may report the one or more future CSI values to the network.

Alternatively and/or additionally, the first prediction operation may comprise a CSI compression operation. The one or more inputs may comprise one or more channel measurements (e.g., CSI-RS measurements) and/or the AI and/or ML model may generate a compressed CSI representation (e.g., the prediction) based upon the one or more inputs (e.g., the one or more channel measurements). Alternatively and/or additionally, the AI and/or ML model may generate a compressed CSI representation based upon the one or more inputs (e.g., the one or more channel measurements). The UE may report the compressed CSI representation to the network.

Alternatively and/or additionally, the first prediction operation may comprise a mobility prediction operation. The one or more inputs may comprise one or more radio measurements associated with a serving cell and/or a neighbor cell and/or the prediction may be indicative of one or more mobility predictions comprising a probability of RLF, a probability of HoF, an expected target cell for handover, an expected serving cell degradation, and/or one or more future measurement results of one or more neighbor cells. Based upon the prediction, the UE may report the one or more mobility predictions to the network, may adjust one or more mobility parameters, and/or may trigger a handover before the expected serving cell degradation is expected to occur.

In one embodiment, the UE does not perform a second prediction operation (e.g., a beam management prediction operation, a CSI prediction operation, a CSI compression operation, a mobility prediction operation, etc.) according to the second configuration after (e.g., in response to) reporting the applicability information of the second configuration (by transmitting the single list comprising the applicability information of the second configuration, for example). For example, the UE may not perform the second prediction operation according to the second configuration based upon the UE determining that the second configuration is non-applicable (e.g., non-applicable to and/or non-implementable by the UE), wherein the single list may comprise an applicability status indicating that the second configuration is non-applicable.

In one embodiment, the UE generates and/or transmits a report according to the first prediction operation associated with the first configuration (in response to reporting the applicability information of the first configuration and/or the applicability information of the first configuration indicating that the first configuration and/or the first prediction is applicable, for example). For example, the report may be generated based upon an output of the first prediction operation (e.g., the report may comprise and/or may be based upon one or more predictions generated by performing the first prediction operation). The report is, or comprises, a periodic report.

In one embodiment, the UE does not generate or transmit (and/or does not directly generate or transmit) a report associated with the second configuration (in response to reporting the applicability information of the second configuration and/or the applicability information of the second configuration indicating that the second configuration is non-applicable).

In one embodiment, a value of the first ID is the same as a value of the second ID.

In one embodiment, a value of the first ID is different than a value of the second ID.

In one embodiment, the first ID (corresponding to the first type) is indicative of a first prediction configuration for a first functionality or the first ID (corresponding to the first type) corresponds to a first CSI-ReportConfigId (e.g., a first CSI Report Configuration ID). The first CSI-ReportConfigId may be indicative of a first CSI report configuration for performing beam management prediction operation and/or a CSI prediction operation and/or a CSI compression operation.

In one embodiment, the second ID (corresponding to the second type) is indicative of a second prediction configuration for a second functionality, the second ID (corresponding to the second type) is indicative of a set of prediction related parameters for a third functionality, or the second ID (corresponding to the second type) corresponds to a second CSI-ReportConfigId (e.g., a second CSI Report Configuration ID). The second CSI-ReportConfigId may be indicative of a second CSI report configuration for performing beam management prediction operation and/or a CSI prediction operation and/or a CSI compression operation, for example).

In one embodiment, the first prediction configuration (for the first functionality) and/or the second prediction configuration (for the second functionality) are different than CSI-ReportConfig (e.g., CSI Report Configuration) associated with prediction (e.g., the first prediction configuration and/or the second prediction configuration are different than a CSI report configuration indicative of and/or usable for performing a CSI prediction operation and/or a CSI compression operation).

In one embodiment, the first prediction configuration (for the first functionality) corresponds to a prediction configuration for mobility (e.g., a mobility prediction configuration indicative of and/or usable for performing a mobility prediction operation).

In one embodiment, the second prediction configuration (for the second functionality) corresponds to a prediction configuration for mobility (e.g., a mobility prediction configuration indicative of and/or usable for performing a mobility prediction operation).

In one embodiment, the single list is included in RRCReconfigurationComplete (e.g., a RRC Reconfiguration Complete message) or UAI. For example, the UE may transmit the RRCReconfigurationComplete comprising the single list. Alternatively and/or additionally, the UE may transmit the UAI comprising the single list (to the network, for example).

In one embodiment, the applicability status (indicated by the flag) indicates whether the configuration is applicable (e.g., applicable to and/or implementable by the UE) or the configuration is non-applicable (e.g., non-applicable to and/or non-implementable by the UE). For example, the applicability status may be set to indicate the configuration is applicable based upon a determination that the UE has sufficient processing resources, sufficient memory, sufficient power availability, one or more required measurement resources, hardware compatible with the configuration, software compatible with the configuration, an operating system compatible with the configuration, and/or a required model (e.g., AI and/or ML model) for performing an AI and/or ML functionality (e.g., collecting inputs, running the AI and/or ML model, activating and/or transmitting a periodic report, a semi-persistent report, and/or an aperiodic report based upon an output of the AI and/or ML model, etc.) associated with the configuration. Alternatively and/or additionally, the applicability status may be set to indicate the configuration is non-applicable based upon a determination that the UE has insufficient processing resources, insufficient memory, and/or insufficient power availability for performing an AI and/or ML functionality (e.g., collecting inputs, running the AI and/or ML model, activating and/or transmitting a periodic report, a semi-persistent report, and/or an aperiodic report based upon an output of the AI and/or ML model, etc.) associated with the configuration and/or that the UE does not have one or more required measurement resources, hardware compatible with the configuration, software compatible with the configuration, an operating system compatible with the configuration, and/or a required model (e.g., AI and/or ML model) for performing the AI and/or ML associated with the configuration.

In one embodiment, the single list is reported (to the network, for example) in response to receiving the one or more first configurations and the one or more second configurations.

In one embodiment, the single list comprises applicability information (e.g., an applicability status) of each configuration of the one or more first configurations and the one or more second configurations. For example, the single list may comprise a plurality of entries comprising one or more first entries for the one or more first configurations and one or more second entries for the one or more second configurations. Each entry of the one or more first entries may comprise the first parameter (indicative of an ID and/or type of ID of a corresponding configuration of the one or more first configurations, for example) and/or the second parameter (indicative of an applicability status of the corresponding configuration of the one or more first configurations, for example). Each entry of the one or more second entries may comprise the first parameter (indicative of an ID and/or type of ID of a corresponding configuration of the one or more second configurations, for example) and/or the second parameter (indicative of an applicability status of the corresponding configuration of the one or more second configurations, for example).

In one embodiment, a first entry of the single list comprises the first parameter indicative of the first ID (corresponding to the first type) and the second parameter indicative of a first applicability status of the first configuration (associated with the first ID). Alternatively and/or additionally, the first parameter of the first entry may be indicative of the first type (of ID) of the first ID. In some examples, the first ID and/or the first type indicated by the first parameter of the first entry are usable to determine the first configuration. Accordingly, the first parameter and the second parameter of the first entry may be usable to determine the first applicability status of the first configuration for the UE. In some examples, the network may determine, based upon the first entry, whether or not to expect the UE to perform a prediction operation according to the first configuration. In some examples, in response to determining that the first configuration is applicable (e.g., applicable to and/or implementable by the UE) based upon the first entry, the network allocates one or more resources for receiving, from the UE, a prediction report (e.g., one or more selected beams, a compressed CSI representation, one or more future CSI values, one or more mobility predictions, etc.) determined via a prediction operation performed by the UE according to the first configuration.

In one embodiment, a second entry of the single list comprises the first parameter indicative of the second ID (corresponding to the second type) and the second parameter indicative of a second applicability status of the second configuration (associated with the second ID). Alternatively and/or additionally, the first parameter of the second entry may be indicative of the second type (of ID) of the second ID. In some examples, the second ID and/or the second type indicated by the first parameter of the second entry are usable to determine the second configuration. Accordingly, the first parameter and the second parameter of the second entry may be usable to determine the second applicability status of the second configuration for the UE. In some examples, the network may determine, based upon the second entry, whether or not to expect the UE to perform a prediction operation according to the second configuration. In some examples, in response to determining that the second configuration is applicable (e.g., applicable to and/or implementable by the UE) based upon the second entry, the network allocates one or more resources for receiving, from the UE, a prediction report (e.g., one or more selected beams, a compressed CSI representation, one or more future CSI values, one or more mobility predictions, etc.) determined via a prediction operation performed by the UE according to the second configuration.

In one embodiment, the single list comprises a plurality of IDs corresponding to a plurality of types of IDs (e.g., the first type, the second type, a third type of ID, etc.).

Referring back to FIGS. 3 and 4, in one exemplary embodiment of a UE, the device 300 includes a program code 312 stored in the memory 310. The CPU 308 may execute program code 312 to enable UE (i) to receive one or more first configurations, in a first list, comprising a first configuration, wherein the first configuration is associated with a first ID corresponding to a first type, (ii) to receive one or more second configurations, in a second list, comprising a second configuration, wherein the second configuration is associated with a second ID corresponding to a second type, and the first type is different than the second type, and (iii) to report, a single list comprising applicability information of the first configuration and applicability information of the second configuration, wherein each entry in the single list comprises a first parameter indicative of an ID and/or a type of the ID and a second parameter indicative of an applicability status of a configuration associated with the ID. Furthermore, the CPU 308 can execute the program code 312 to perform one, some and/or all of the above-described actions and steps and/or others described herein.

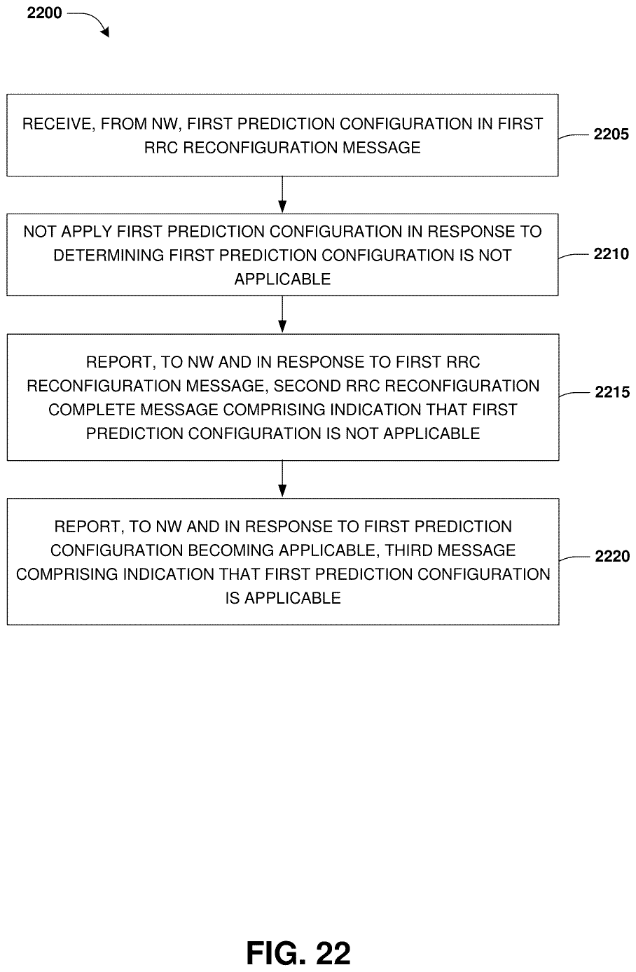

FIG. 22 is a flow chart 2200 according to one exemplary embodiment from the perspective of a UE. In step 2205, the UE receives, from a NW, a first prediction configuration in a first RRC reconfiguration message. In step 2210, the UE does not apply the first prediction configuration in response to determining the first prediction configuration is not applicable. In some examples, the UE determines the first prediction configuration is not applicable (e.g., not ready to apply for inference by the UE) based upon a determination that the UE has insufficient processing resources, insufficient memory, and/or insufficient power availability for performing an AI and/or ML functionality (e.g., collecting inputs, running the AI and/or ML model, activating and/or transmitting a periodic report, a semi-persistent report, and/or an aperiodic report based upon an output of the AI and/or ML model, etc.) associated with the first prediction configuration and/or that the UE does not have one or more required measurement resources, hardware compatible with the first prediction configuration, software compatible with the first prediction configuration, an operating system compatible with the first prediction configuration, and/or a required model (e.g., AI and/or ML model) for performing the AI and/or ML associated with the first prediction configuration. In some examples, the UE not applying the first prediction configuration includes the UE not performing one or more prediction operations according to the first prediction configuration, the UE not activating and/or transmitting a periodic report, a semi-persistent report, and/or an aperiodic report associated with the first prediction configuration, and/or the UE not using the AI and/or ML model associated with the first prediction configuration. In step 2215, the UE reports, to the NW and in response to the first RRC reconfiguration message, a second RRC reconfiguration complete message comprising an indication that the first prediction configuration is not applicable. In step 2220, the UE reports, to the NW and in response to the first prediction configuration becoming applicable, a third message comprising an indication that the first prediction configuration is applicable.

In some examples, in response to determining that the first prediction configuration is applicable and/or reporting the third message (comprising the indication that the first prediction configuration is applicable) to the NW, the UE may not perform a first prediction operation according to the first prediction configuration (e.g., unless the first prediction configuration is reconfigured by the NW). In some examples, the first prediction operation may comprise determining one or more inputs (e.g., a measurement, CSI, beam data, mobility information), generating a prediction using an AI and/or ML model, and/or using (and/or reporting) the prediction (in a periodic and/or aperiodic report, for example). In some examples, the AI and/or ML model may be stored and/or executed on the UE and/or on a node (e.g., the network, a server, a network edge, etc.) to generate the prediction.

For example, the first prediction operation may comprise a beam management prediction operation. The one or more inputs may comprise one or more measurements associated with a set of beams (e.g., measurements of one or more resources corresponding to the set of beams) and/or the prediction may be indicative of one or more selected beams, of the set of beams, that are expected to provide improved communication performance relative to one or more other beams of the set of beams. Based upon the prediction, the UE may report the one or more selected beams to the network and/or may utilize a beam of the one or more selected beams for communication.

Alternatively and/or additionally, the first prediction operation may comprise a CSI prediction operation. The one or more inputs may comprise one or more channel measurements (e.g., CSI-RS measurements) and/or the prediction may be indicative of one or more CSI predictions comprising one or more future CSI values. Based upon the prediction, the UE may perform local channel selection (based upon the one or more future CSI values, for example). Alternatively and/or additionally, the UE may report the one or more future CSI values to the network.

Alternatively and/or additionally, the first prediction operation may comprise a CSI compression operation. The one or more inputs may comprise one or more channel measurements (e.g., CSI-RS measurements) and/or the AI and/or ML model may generate a compressed CSI representation (e.g., the prediction) based upon the one or more inputs (e.g., the one or more channel measurements). Alternatively and/or additionally, the AI and/or ML model may generate a compressed CSI representation based upon the one or more inputs (e.g., the one or more channel measurements). The UE may report the compressed CSI representation to the network.

Alternatively and/or additionally, the first prediction operation may comprise a mobility prediction operation. The one or more inputs may comprise one or more radio measurements associated with a serving cell and/or a neighbor cell and/or the prediction may be indicative of one or more mobility predictions comprising a probability of RLF, a probability of HoF, an expected target cell for handover, an expected serving cell degradation, and/or one or more future measurement results of one or more neighbor cells. Based upon the prediction, the UE may report the one or more mobility predictions to the network, may adjust one or more mobility parameters, and/or may trigger a handover before the expected serving cell degradation is expected to occur.

In one embodiment, the UE does not apply the first prediction configuration in response to reporting the third message to the NW. For example, the UE may not perform one or more prediction operations according to the first prediction configuration, may not activate and/or transmit a periodic report, a semi-persistent report, and/or an aperiodic report associated with the first prediction configuration, and/or may not use the AI and/or ML model associated with the first prediction configuration.

In one embodiment, the UE receives a fourth RRC reconfiguration message from the NW.

In one embodiment, the first prediction configuration is added, modified, and/or released in the fourth RRC reconfiguration message.

In one embodiment, the UE determines that the first prediction configuration is applicable (e.g., ready to apply for inference by the UE) in response to receiving the fourth RRC reconfiguration message. For example, the UE may determine that the first prediction configuration is applicable based upon an indication of the first prediction configuration in the fourth RRC reconfiguration message and/or based upon a determination that the UE has sufficient processing resources, sufficient memory, sufficient power availability, one or more required measurement resources, hardware compatible with the first prediction configuration, software compatible with the first prediction configuration, an operating system compatible with the first prediction configuration, and/or a required model (e.g., AI and/or ML model) for performing an AI and/or ML functionality (e.g., collecting inputs, running the AI and/or ML model, activating and/or transmitting a periodic report, a semi-persistent report, and/or an aperiodic report based upon an output of the AI and/or ML model, etc.) associated with the first prediction configuration.

In one embodiment, the UE reports, to the NW, an indication that the first prediction configuration is applicable in response to receiving the fourth RRC reconfiguration message.

In one embodiment, the UE applies the first prediction configuration in response to determining that the first prediction configuration is applicable and/or reporting, to the NW, the indication that the first prediction configuration is applicable. For example, the UE may perform one or more prediction operations (e.g., the first prediction operation and/or one or more other prediction operations) according to the first prediction configuration.

In one embodiment, a second prediction configuration is added, modified, and/or released in the fourth RRC reconfiguration message.

In one embodiment, the UE determines that the second prediction configuration is applicable (e.g., ready to apply for inference by the UE) (in response to receiving the fourth RRC reconfiguration message, for example). For example, the UE may determine that the second prediction configuration is applicable based upon an indication of the second prediction configuration in the fourth RRC reconfiguration message and/or based upon a determination that the UE has sufficient processing resources, sufficient memory, sufficient power availability, one or more required measurement resources, hardware compatible with the second prediction configuration, software compatible with the second prediction configuration, an operating system compatible with the second prediction configuration, and/or a required model (e.g., AI and/or ML model) for performing an AI and/or ML functionality (e.g., collecting inputs, running the AI and/or ML model, activating and/or transmitting a periodic report, a semi-persistent report, and/or an aperiodic report based upon an output of the AI and/or ML model, etc.) associated with the second prediction configuration.

In one embodiment, the UE reports, to the NW, an indication that the second prediction configuration is applicable.

In one embodiment, the UE applies the second prediction configuration in response to determining that the second prediction configuration is applicable and/or reporting, to the NW, the indication that the second prediction configuration is applicable. For example, the UE may perform one or more prediction operations according to the second prediction configuration.

In one embodiment, the second prediction configuration comprises a CSI-ReportConfig (e.g., CSI Report Configuration) for prediction.

In one embodiment, the third message is, or comprises, a RRC reconfiguration complete message or UAI.

In one embodiment, the first prediction configuration is a periodic CSI-ReportConfig (e.g., CSI Report Configuration) for prediction.

In one embodiment, the UE stores (and/or keeps) the first prediction configuration (in memory, for example) in response to determining that the first prediction configuration is not applicable and/or reporting, to the NW, the second RRC reconfiguration complete message comprising the indication that the first prediction configuration is not applicable. In some examples, the UE may store (in the memory, for example) an indication that the first prediction configuration is not applicable (e.g., not ready to apply for inference by the UE).

In one embodiment, the UE does not autonomously release the first prediction configuration (e.g., does not delete the first prediction configuration from memory) in response to determining that the first prediction configuration is not applicable and/or reporting, to the NW, the second RRC reconfiguration complete message comprising the indication that the first prediction configuration is not applicable.

In one embodiment, the first RRC reconfiguration message comprises a third prediction configuration. In some examples, the third prediction configuration corresponds to an aperiodic configuration and/or a semi-persistent configuration. In some examples, the UE stores the third prediction configuration (in memory, for example). In some examples, the UE applies the third prediction configuration. For example, the UE may perform one or more prediction operations according to the third prediction configuration. In some examples, the UE receives an activation message, comprising a MAC CE and/or DCI, indicative of activating the third prediction configuration. In some examples, the UE may activate a periodic and/or aperiodic report based upon the activation message. For example, the UE may generate periodic and/or aperiodic reports using an AI and/or ML model associated with the third prediction configuration, and/or transmit the periodic and/or aperiodic reports to the NW.

Referring back to FIGS. 3 and 4, in one exemplary embodiment of a UE, the device 300 includes a program code 312 stored in the memory 310. The CPU 308 may execute program code 312 to enable UE (i) to receive, from a NW, a first prediction configuration in a first RRC reconfiguration message, (ii) to not apply the first prediction configuration in response to determining the first prediction configuration is not applicable, (iii) to report, to the NW and in response to the first RRC reconfiguration message, a second RRC reconfiguration complete message comprising an indication that the first prediction configuration is not applicable, and (iv) to report, to the NW and in response to the first prediction configuration becoming applicable, a third message comprising an indication that the first prediction configuration is applicable. Furthermore, the CPU 308 can execute the program code 312 to perform one, some and/or all of the above-described actions and steps and/or others described herein.

Throughout the present disclosure, the terms “inference” and “prediction” may be used interchangeably.

A communication device (e.g., a UE, a base station, a network node, etc.) may be provided, wherein the communication device may comprise a control circuit, a processor installed in the control circuit and/or a memory installed in the control circuit and coupled to the processor. The processor may be configured to execute a program code stored in the memory to perform method steps illustrated in FIGS. 11-22. Furthermore, the processor may execute the program code to perform one, some and/or all of the above-described actions and steps and/or others described herein.

A computer-readable medium may be provided. The computer-readable medium may be a non-transitory computer-readable medium. The computer-readable medium may comprise a flash memory device, a hard disk drive, a disc (e.g., a magnetic disc and/or an optical disc, such as at least one of a digital versatile disc (DVD), a compact disc (CD), etc.), and/or a memory semiconductor, such as at least one of static random access memory (SRAM), dynamic random access memory (DRAM), synchronous dynamic random access memory (SDRAM), etc. The computer-readable medium may comprise processor-executable instructions, that when executed cause performance of one, some and/or all method steps illustrated in FIGS. 11-22, and/or one, some and/or all of the above-described actions and steps and/or others described herein.

It may be appreciated that applying one or more of the techniques presented herein may result in one or more benefits including, but not limited to, increased efficiency of communication between devices and/or increased efficiency with which a network may configure AI/ML functionalities for a UE.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects concurrent channels may be established based on pulse repetition frequencies. In some aspects concurrent channels may be established based on pulse position or offsets. In some aspects concurrent channels may be established based on time hopping sequences. In some aspects concurrent channels may be established based on pulse repetition frequencies, pulse positions or offsets, and time hopping sequences.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based on design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Alternatively and/or additionally, in some aspects any suitable computer-program product may comprise a computer-readable medium comprising codes relating to one or more of the aspects of the disclosure. In some aspects a computer program product may comprise packaging materials.

While the disclosed subject matter has been described in connection with various aspects, it will be understood that the disclosed subject matter is capable of further modifications. This application is intended to cover any variations, uses or adaptation of the disclosed subject matter following, in general, the principles of the disclosed subject matter, and including such departures from the present disclosure as come within the known and customary practice within the art to which the disclosed subject matter pertains.

1. A method of a User Equipment (UE), comprising:
receiving, from a Network (NW), a first prediction configuration in a first Radio Resource Control (RRC) reconfiguration message;
not applying the first prediction configuration in response to determining the first prediction configuration is not applicable;
reporting, to the NW and in response to the first RRC reconfiguration message, a second RRC reconfiguration complete message comprising an indication that the first prediction configuration is not applicable; and
reporting, to the NW and in response to the first prediction configuration becoming applicable, a third message comprising an indication that the first prediction configuration is applicable.

2. The method of claim 1, comprising:
not applying the first prediction configuration in response to reporting the third message to the NW.

3. The method of claim 1, comprising:
receiving a fourth RRC reconfiguration message from the NW.

4. The method of claim 3, wherein at least one of:
the first prediction configuration is at least one of added, modified, or released in the fourth RRC reconfiguration message;
the method comprises determining that the first prediction configuration is applicable in response to receiving the fourth RRC reconfiguration message;
the method comprises reporting, to the NW, an indication that the first prediction configuration is applicable in response to receiving the fourth RRC reconfiguration message; or
the method comprises applying the first prediction configuration in response to at least one of determining that the first prediction configuration is applicable or reporting, to the NW, the indication that the first prediction configuration is applicable.

5. The method of claim 3, wherein at least one of:
a second prediction configuration is at least one of added, modified, or released in the fourth RRC reconfiguration message;
the method comprises determining that the second prediction configuration is applicable;
the method comprises reporting, to the NW, an indication that the second prediction configuration is applicable;
the method comprises applying the second prediction configuration in response to at least one of determining that the second prediction configuration is applicable or reporting, to the NW, the indication that the second prediction configuration is applicable; or
the second prediction configuration comprises a CSI-ReportConfig for prediction.

6. The method of claim 1, wherein:
the third message is, or comprises, a RRC reconfiguration complete message or UE Assistance Information (UAI) message.

7. The method of claim 1, wherein:
the first prediction configuration is a periodic CSI-ReportConfig for prediction.

8. The method of claim 1, comprising:
storing the first prediction configuration in response to at least one of determining that the first prediction configuration is not applicable or reporting, to the NW, the second RRC reconfiguration complete message comprising the indication that the first prediction configuration is not applicable.

9. The method of claim 1, comprising:
not autonomously releasing the first prediction configuration in response to at least one of determining that the first prediction configuration is not applicable or reporting, to the NW, the second RRC reconfiguration complete message comprising the indication that the first prediction configuration is not applicable.

10. The method of claim 1, wherein the first RRC reconfiguration message comprises a third prediction configuration, and at least one of:
the third prediction configuration is, or comprises, at least one of an aperiodic configuration or a semi-persistent configuration;
the method comprises storing the third prediction configuration;
the method comprises applying the third prediction configuration; or
the method comprises receiving an activation message, comprising at least one of a Medium Access Control (MAC) Control Element (CE) or Downlink Control Information (DCI), indicative of activating the third prediction configuration.

11. A non-transitory machine-readable medium having stored thereon processor-executable instructions, that when executed by a User Equipment (UE), cause performance of operations, the operations comprising:
receiving, from a Network (NW), a first prediction configuration in a first Radio Resource Control (RRC) reconfiguration message;
not applying the first prediction configuration in response to determining the first prediction configuration is not applicable;
reporting, to the NW and in response to the first RRC reconfiguration message, a second RRC reconfiguration complete message comprising an indication that the first prediction configuration is not applicable; and
reporting, to the NW and in response to the first prediction configuration becoming applicable, a third message comprising an indication that the first prediction configuration is applicable.

12. The non-transitory machine-readable medium of claim 11, the operations comprising:
not applying the first prediction configuration in response to reporting the third message to the NW.

13. The non-transitory machine-readable medium of claim 11, the operations comprising:
receiving a fourth RRC reconfiguration message from the NW.

14. The non-transitory machine-readable medium of claim 13, wherein at least one of:
the first prediction configuration is at least one of added, modified, or released in the fourth RRC reconfiguration message;
the operations comprise determining that the first prediction configuration is applicable in response to receiving the fourth RRC reconfiguration message;
the operations comprise reporting, to the NW, an indication that the first prediction configuration is applicable in response to receiving the fourth RRC reconfiguration message; or
the operations comprise applying the first prediction configuration in response to at least one of determining that the first prediction configuration is applicable or reporting, to the NW, the indication that the first prediction configuration is applicable.

15. The non-transitory machine-readable medium of claim 13, wherein at least one of:
a second prediction configuration is at least one of added, modified, or released in the fourth RRC reconfiguration message;
the operations comprise determining that the second prediction configuration is applicable;
the operations comprise reporting, to the NW, an indication that the second prediction configuration is applicable;
the operations comprise applying the second prediction configuration in response to at least one of determining that the second prediction configuration is applicable or reporting, to the NW, the indication that the second prediction configuration is applicable; or
the second prediction configuration comprises a CSI-ReportConfig for prediction.

16. The non-transitory machine-readable medium of claim 11, wherein:
the third message is, or comprises, a RRC reconfiguration complete message or UE Assistance Information (UAI) message.

17. The non-transitory machine-readable medium of claim 11, wherein:
the first prediction configuration is a periodic CSI-ReportConfig for prediction.

18. The non-transitory machine-readable medium of claim 11, the operations comprising:
storing the first prediction configuration in response to at least one of determining that the first prediction configuration is not applicable or reporting, to the NW, the second RRC reconfiguration complete message comprising the indication that the first prediction configuration is not applicable.

19. A User Equipment (UE) comprising:
a control circuit;
a processor installed in the control circuit; and
a memory installed in the control circuit and operatively coupled to the processor, wherein the processor is configured to execute a program code stored in the memory to perform operations, the operations comprising:
receiving, from a Network (NW), a first prediction configuration in a first Radio Resource Control (RRC) reconfiguration message;
not applying the first prediction configuration in response to determining the first prediction configuration is not applicable;
reporting, to the NW and in response to the first RRC reconfiguration message, a second RRC reconfiguration complete message comprising an indication that the first prediction configuration is not applicable; and
reporting, to the NW and in response to the first prediction configuration becoming applicable, a third message comprising an indication that the first prediction configuration is applicable.

20. The UE of claim 19, the operations comprising:
not applying the first prediction configuration in response to reporting the third message to the NW.
